(19) United States
(12) Patent Application Publication
(10) Pub. No.: US 2007/0190284 A1
(43) Pub. Date: Aug. 16, 2007

(54) Melt-processable adhesives for bonding pervious fluoropolymeric layers in multilayer composites

(75) Inventor: Edward Hosung Park, Saline, MI (US)

Correspondence Address: FREUDENBERG-NOK GENERAL PARTNERSHIP;LEGAL DEPARTMENT, 47690 EAST ANCHOR COURT, PLYMOUTH, MI, 48170-2455, US

(73) Assignee: Freudenberg-NOK General Partnership, Plymouth, MI (US)

(21) Appl. No.: 11/352,062

(22) Filed: Feb. 10, 2006

(51) Int. Cl. B32B 3/02; B32B 27/08

(52) U.S. Cl. 428/66.4; 428/421; 428/422; 428/457; 428/413

(57) ABSTRACT

A homogenous fluoropolymeric melt-bonded layer in a multilayer composite coheres to a pervious fluoropolymer layer of fluoroelastomeric thermoplastic and/or etched polytetrafluoroethylene. Before curing, the homogenous fluoropolymer has a stoichiometrically identical monomer unit with the pervious fluoropolymer, the homogenous fluoropolymer liquefaction range supra-point temperature is not greater than that of the pervious fluoropolymer, the homogenous fluoropolymer liquefaction range supra-point temperature is not less than the pervious fluoropolymer liquefaction range sub-point temperature, and the homogenous fluoropolymer liquefaction range supra-point viscosity is less than that of the pervious fluoropolymer. In some multilayer composites, the homogenous fluoropolymeric melt-bonded layer coheres to a third layer of plastic, metal, ceramic, rubber, wood, and/or leather. In such 3+ layer composites, the homogenous fluoropolymeric contains an epoxy compound, a phenoxy compound, silane, and/or a heat-polymerizable thermoplastic oligomer. Various composites according to the technology are adapted for use as gaskets, dynamic seals, compression seals, or o-rings.

### INTRODUCTION

The present disclosure relates to multilayer composites having a pervious fluoropolymeric layer and to articles formed of such multilayer composites. In particular, the present disclosure relates to adhesives for bonding a pervious fluoropolymeric layer to other layers in multilayer composites.

The statements in this section merely provide background information related to the present disclosure and may not constitute prior art.

Fluoropolymers are well-known materials providing excellent resistance to heat, fuels, and chemicals. Fluoroelastomer thermoplastic vulcanizates (FKM-TPV materials) and polytetrafluoroethylene (PTFE materials) are two particular fluoropolymers that are very useful in providing these resistive properties. PTFE provides exceptionally low surface friction, very good chemical resistance, high temperature stablilty, low temperature toughness, and useful electrical insulation properties. PTFE is also essentially imperious to biological agents and has therefore traditionally been valued for use in medical components. A partial list of uses for PTFE includes non-stick coatings, gaskets and packings, bearings, electrical components, medical components, laboratory equipment, pump parts, and thread seal tape.

Fluoroelastomer thermoplastic vulcanizates provide a continuous thermoplastic fluorocarbon resin phase and a dispersed amorphous vulcanized fluoroelastomer phase. FKM-TPVs are melt-formable materials which provide rubber-like elasticity. FKM-TPVs have structural, thermal, and chemical resistance properties that are very similar to the comparable properties of fluoroelastomers (FKM elastomers), but are more readily formed than FKM elastomers in processes such as injection molding. FKM-TPVs have particularly been beneficial as materials for seals and gaskets used in automotive or aerospace applications where elevated temperatures and harsh chemical exposure are routinely encountered.

Multilayer composites enable many of the benefits of modem life. Each layer or section of the composite contributes to the overall performance of the composite as viewed from the intended application. Composites benefiting from a fluoropolymer layer incorporate the benefits outlined earlier with respect to fluoropolymeric material performance, but such composites require a number of steps to manufacture because of the low surface friction, chemical resistance, and affiliated “non-stick” nature of fluoropolymers. These properties especially frustrate cohesive attachment of fluoropolymers to other materials, so some types of multilayer composites having a fluoropolymeric layer or fluoropolymeric section must either be mechanically adjoined to other layers or must be chemically joined through use of an approach that is effectively not practical in the mass production market.

### SUMMARY

The invention provides a layer material for a melt-bonded layer in a multilayer composite. The composite has a layer of pervious fluoropolymer in contact with the melt-bonded layer, and the layer of pervious fluoropolymer is made of fluoroelastomeric thermoplastic and/or etched polytetrafluoroethylene. If etched polytetrafluoroethylene is in the layer of pervious fluoropolymer, then the polytetrafluoroethylene is etched such that etched polytetrafluoroethylene molecules in the pervious fluoropolymer layer have a carbon to fluorine weight ratio from about 0.35 to about 10. The layer material for the melt-bonded layer comprises homogenous fluoropolymer of fluoroplastic and/or uncured fluoroelastomer; if uncured fluoroelastomer is present in the homogenous fluoropolymer, then the uncured fluoroelastomer is liquid at room temperature. Fluoroelastomer-curing agent is also blended into the homogenous fluoropolymer if the homogenous fluoropolymer comprises uncured fluoroelastomer or if the pervious fluoropolymer layer comprises fluoroelastomeric thermoplastic. The homogenous fluoropolymer has fluorinated molecules derived from at least one monomer unit that is stoichiometrically identical to a monomer unit from which the fluorinated molecules of the pervious fluoropolymer are derived, a liquefaction range supra-point temperature not greater than the liquefaction range supra-point temperature of the pervious fluoropolymer, a liquefaction range supra-point temperature not less than the liquefaction range sub-point temperature of the pervious fluoropolymer, and a viscosity at the liquefaction range supra-point temperature of the homogenous fluoropolymer that is less than the viscosity of the pervious fluoropolymer at the liquefaction range supra-point temperature of the pervious fluoropolymer.

In one embodiment of the layer material, the melt-bonded layer is a second layer of the composite and the composite has a third layer cohered to the melt-bonded layer. The third layer is made of any of thermoplastic, thermoset plastic, metal, ceramic, rubber, wood, and/or leather. Additionally, in this embodiment, the layer material of the melt-bonded layer further comprises a third-layer bonding ingredient of any of an epoxy compound, a phenoxy compound, and/or a heat polymerizable thermoplastic oligomer. If the third layer is metal, then the layer material of the melt-bonded layer also comprises silane as a bonding ingredient.

The invention also provides a multilayer composite having a layer of pervious fluoropolymer melt bonded to a second layer of homogenous fluoropolymer where the homogenous fluoropolymer of the second layer is compositionally different from the pervious fluoropolymer of the pervious fluoropolymer layer. The pervious fluoropolymer is fluoroelastomeric thermoplastic vulcanizate and/or etched polytetrafluoroethylene. If used, etched polytetrafluoroethylene of the layer of pervious fluoropolymer is derived from polytetrafluoroethylene in a layer of pervious fluoropolymer precursor component etched such that etched polytetrafluoroethylene molecules in the precursor component have a carbon to fluorine weight ratio from about 0.35 to about 10. The homogenous fluoropolymer comprises fluoroelastomer and/or fluoroplastic.

Alternative multi-layer composite embodiments also have a third layer cohered to the second layer; the third layer consisting of thermoplastic, thermoset plastic, metal, ceramic, rubber, wood, and/or leather. In these embodiments, the layer material of the second layer further comprises cured epoxy compound, a cured phenoxy compound, and/or a thermoplastic other than the other than the fluoroplastic. If the third layer is metal, then the second layer also comprises silane as a bonding ingredient. The multilayer composite is further adapted, in alternative exemplary embodiments of both 2-layer and 3-layer composites as previously described, to be any of a gasket, a dynamic torsion seal, a static compression seal, and an o-ring. In one exemplary embodiment, a 3-layer multilayer composite provides a clip-in torsion seal assembly featuring a pervious fluoropolymer torsion seal and a steel clipping flange, with both the seal and the flange being cohered in the composite through an interfacing melt-bonded layer.

In another example, an exemplary non-planar 3-layer multilayer composite embodiment for a (first) assembly component provides a (first) layer of pervious fluoropolymer as a seal for interfacing to a surface of a second component of the assembly; the third layer of the 3-layer multilayer composite component is the structural body of the first assembly component, with both the pervious fluoropolymer seal and the structural body being cohered in the composite through an interfacing melt-bonded layer (the second layer of the multilayer composite). In one embodiment of such an assembly, the layer of pervious fluoropolymer comprises fluoroelastomeric thermoplastic vulcanizate and the third layer comprises cured phenolic resin.

The invention also includes pre-cured multilayer composites (multilayer composite precursors) that, upon curing, provide multilayer composite embodiments as previously described.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The present disclosure will become more fully understood from the detailed description and the accompanying drawings of FIGS. 1 to 11. The drawings described herein are for illustration purposes only and are not intended to limit the scope of the present disclosure in any way.

FIG. 1 shows a ternary composition diagram for fluoropolymers derived from tetrafluoroethylene (TFE), hexfluoropropylene (HFP), and vinylidene fluoride;

FIG. 2A provides a cross-section view of a basic 2-layer multilayer composite having one melt-bonded layer bonded to a porous layer;

FIG. 2B provides a cross-section view of pore detail in the porous layer of the composite of FIG. 2A;

FIG. 2C provides a cross-section view of polymer micro-region detail in the vicinity of one pore of the porous layer of the composite of FIG. 2B;

FIG. 2D provides a cross-section view of polymer micro-region detail in the vicinity of one pore wall of the pore of FIG. 2C;

FIG. 3 provides a cross-section view of a 3-layer multilayer composite having laminar layers;

FIG. 4 provides a cross-section view of a 3-layer multilayer composite having a layer that is not laminar;

FIGS. 5A, 5B, and 5C present circular cross-section end views in perspective reference views of three alternative embodiments of multilayer composite tubes or hoses incorporating a pervious fluoropolymeric layer and a melt-bonded layer;

FIG. 6 shows a cross-section view of a general sealed assembly model;

FIG. 7 presents a cross-section view of an assembly profile of a compressible seal between two moveable rigid surfaces;

FIG. 8 presents a cross-section view of an assembly profile of a compressible seal statically deployed between two non-moveable rigid surfaces;

FIG. 9 presents a cross-section view of an assembly profile of a dynamic torsion seal protecting a rotating component;

FIGS. 10A to 10F depict a number of circular cross-section end views in perspective reference views of alternative multilayer composite o-ring seal configurations with each configuration having a pervious fluoropolymeric layer and a melt-bonded layer; and

FIG. 11 presents a cross-section view of seal detail for a clip-in dynamic torsion seal.

It should be noted that the figures set forth herein are intended to exemplify the general characteristics of an apparatus, materials, and methods among those of this description, for the purpose of the description of such embodiments herein. The figures may not precisely reflect the characteristics of any given embodiment, and are not necessarily intended to define or limit specific embodiments within the scope of this description.

### DESCRIPTION

The following description is merely exemplary in nature and is not intended to limit the present disclosure, application, or uses. It should be understood that throughout the drawings, corresponding reference numerals indicate like or corresponding parts and features.

The following definitions and non-limiting guidelines must be considered in reviewing the disclosure set forth herein.

The headings (such as “Introduction” and “Summary”) and sub-headings used herein are intended only for general organization of topics within this description, and are not intended to limit this description or any aspect thereof. In particular, subject matter disclosed in the “Introduction” may include aspects of technology within the scope of this description, and may not constitute a recitation of prior art. Subject matter disclosed in the “Summary” is not an exhaustive or complete disclosure of the entire scope of this description or any embodiments thereof.

The citation of references herein does not constitute an admission that those references are prior art or have any relevance to the patentability of this description disclosed herein. All references cited in the Description section of this specification are hereby incorporated by reference in their entirety.

The description and specific examples, while indicating embodiments of this description, are intended for purposes of illustration only and are not intended to limit the scope of this description. Moreover, recitation of multiple embodiments having stated features is not intended to exclude other embodiments having additional features, or other embodiments incorporating different combinations of the stated of features.

As used herein, the words “preferred” and “preferably” refer to embodiments of this description that afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of this description.

As used herein, the “word include,” and its variants, is intended to be non-limiting, such that recitation of items in a list is not to the exclusion of other like items that may also be useful in the materials, compositions, devices, and methods of this description.

Most items of manufacture represent an intersection of considerations in both mechanical design and in materials design. In this regard, improvements in materials frequently are intertwined with improvements in mechanical design. The embodiments describe compounds, ingredients (functional constituents in a mixture where a constituent, prior to being mixed into the mixture, can contain more than one chemical compound), compositions, materials, assemblies, and manufactured items that enable improvements in designed adhesives for fluoropolymer cohesion to be fully exploited.

The examples and other embodiments described herein are exemplary and not intended to be limiting in describing the full scope of compositions, materials, assemblies, methods, and manufactured items methods of this description. Equivalent changes, modifications and variations of specific embodiments, materials, compositions and methods may be made within the scope of the present disclosure, with substantially similar results.

The invention provides a layer material for a melt-bonded layer in a multilayer composite. The composite has a layer of pervious fluoropolymer in contact with the melt-bonded layer, and the layer of pervious fluoropolymer is made of fluoroelastomeric thermoplastic and/or etched polytetrafluoroethylene. In various embodiments, the composite comprises two, three, or more layers, including the melt-bonded layer. The layer material for the melt-bonded layer fundamentally comprises homogenous fluoropolymer of fluoroplastic and/or uncured fluoroelastomer; if uncured fluoroelastomer is present in the homogenous fluoropolymer the uncured fluoroelastomer is liquid at room temperature prior to blending into the homogenous fluoropolymer. Fluoroelastomer-curing agent is also blended into the homogenous fluoropolymer if the homogenous fluoropolymer comprises uncured fluoroelastomer or if the pervious fluoropolymer layer comprises fluoroelastomeric thermoplastic. The homogenous fluoropolymer has fluorinated molecules derived from at least one monomer unit that is stoichiometrically identical to a monomer unit from which the fluorinated molecules of the pervious fluoropolymer are derived, a liquefaction range supra-point temperature not greater than the liquefaction range supra-point temperature of the pervious fluoropolymer, a liquefaction range supra-point temperature not less than the liquefaction range sub-point temperature of the pervious fluoropolymer, and a viscosity at the liquefaction range supra-point temperature of the homogenous fluoropolymer that is less than the viscosity of the pervious fluoropolymer at the liquefaction range supra-point temperature of the pervious fluoropolymer.

Two-layer composites of the present invention may be exemplified by four basic, non-limiting, multilayer composites. Commensurately, four basic, non-limiting, layer material (homogenous fluoropolymer) embodiments are provided for these composite types. Each homogenous fluoropolymer layer material embodiment has fundamental compositional aspects as described above. In a first embodiment, the layer of pervious fluoropolymer comprises etched polytetrafluoroethylene and the homogenous fluoropolymer layer material is any of tetrafluoroethylene/hexafluoropropylene copolymer, ethylene-tetrafluoroethylene copolymer, ethylene chlorotrifluoroethylene copolymer, tetrafluoroethylene/hexafluoropropylene/vinylidene fluoride terpolymer, poly(vinylidene fluoride), tetrafluoroethylene/perfluoromethylvinylether copolymer, tetrafluoroethylene/perfluorovinylether copolymer, perfluoroalkoxy/tetrafluoroethylene copolymer, hexafluoropropylene/vinylidene fluoride copolymer, and/or chlorotrifluoroethylene/vinylidene fluoride copolymer.

In a second embodiment for an exemplary 2-layer composite, the layer of pervious fluoropolymer comprises etched polytetrafluoroethylene and the homogenous fluoropolymer layer material has at least five weight percent fluorine or more and comprises a fluorinated ingredient and an un-fluorinated ingredient in a weight ratio of from about 1:9 to about 9:1. The un-fluorinated ingredient is any of thermoplastic, thermoplastic vulcanizate, thermoplastic elastomer, elastomer, and/or thermoset resin; and the fluorinated ingredient is any of tetrafluoroethylene/hexafluoropropylene copolymer, ethylene-tetrafluoroethylene copolymer, ethylene chlorotrifluoroethylene copolymer, tetrafluoroethylene/hexafluoropropylene/vinylidene fluoride terpolymer, poly(vinylidene fluoride), tetrafluoroethylene/perfluoromethylvinylether copolymer, tetrafluoroethylene/perfluorovinylether copolymer, perfluoroalkoxy/tetrafluoroethylene copolymer, hexafluoropropylene/vinylidene fluoride copolymer, and/or chlorotrifluoroethylene/vinylidene fluoride copolymer.

In a third embodiment for an exemplary 2-layer composite, the layer of pervious fluoropolymer comprises fluoroelastomeric thermoplastic vulcanizate and the homogenous fluoropolymer layer material has at least five weight percent fluorine or more and comprises a fluorinated ingredient and an un-fluorinated ingredient in a weight ratio of from about 1:9 to about 9:1. The un-fluorinated ingredient is any of thermoplastic, thermoplastic vulcanizate, thermoplastic elastomer, elastomer, and/or thermoset resin; and the fluorinated ingredient is any of tetrafluoroethylene/hexafluoropropylene copolymer, ethylene-tetrafluoroethylene copolymer, ethylene chlorotrifluoroethylene copolymer, tetrafluoroethylene/hexafluoropropylene/vinylidene fluoride terpolymer, poly(vinylidene fluoride), tetrafluoroethylene/perfluoromethylvinylether copolymer, tetrafluoroethylene/perfluorovinylether copolymer, perfluoroalkoxy/tetrafluoroethylene copolymer, hexafluoropropylene/vinylidene fluoride copolymer, and/or chlorotrifluoroethylene/vinylidene fluoride copolymer. This embodiment also includes a fluoroelastomer-curing agent of bisphenol, peroxide, polyol, phenol, and/or amine (per the fluoroelastomer in the vulcanizate).

In a fourth embodiment for an exemplary 2-layer composite, the layer of pervious fluoropolymer comprises fluoroelastomeric thermoplastic vulcanizate and the homogenous fluoropolymer layer material has at least five weight percent fluorine or more and comprises any of thermoplastic, thermoplastic vulcanizate, thermoplastic elastomer, elastomer, and/or thermoset resin. This embodiment also includes a fluoroelastomer-curing agent of bisphenol, peroxide, polyol, phenol, and/or amine.

Three-layer composites of the present invention may be exemplified by eight basic, non-limiting, multilayer composites. Commensurately, eight basic, non-limiting, layer material (homogenous fluoropolymer) embodiments are provided for these composite types. Each homogenous fluoropolymer layer material embodiment has fundamental compositional aspects as described above. In each of these eight exemplary multilayer composites, the homogenous fluoropolymer layer material embodiment is the basis for the melt-bonded layer of homogeneous fluoropolymer in the second layer of the composite and functions in the finished composite as an adhesive layer bonding a third layer and the first (pervious fluoropolymer) layer in the finished (cured) composite. In the first embodiment, the layer of pervious fluoropolymer comprises etched polytetrafluoroethylene and the third layer of the composite comprises any of thermoplastic, thermoplastic vulcanizate, thermoplastic elastomer, elastomer, and/or thermoset plastic. The homogenous fluoropolymer layer material has at least five weight percent fluorine or more and comprises a fluorinated ingredient, a third-layer bonding ingredient, and a conditional third-layer curing agent. The fluorinated ingredient is any of uncured fluoroelastomer and/or emulsion fluoroplastic; and the third-layer bonding ingredient is any of an epoxy compound, a phenoxy compound, and/or a heat polymerizable thermoplastic oligomer. This embodiment also includes a fluoroelastomer-curing agent of bisphenol, peroxide, polyol, phenol, and/or amine; and (if the third layer comprises any of thermoplastic elastomer, elastomer, or thermoset plastic) the third-layer curing agent is any of amine or sulfur.

In a second embodiment for an exemplary 3-layer composite, the layer of pervious fluoropolymer comprises etched polytetrafluoroethylene and the third layer of the composite comprises metal. The homogenous fluoropolymer layer material has at least five weight percent fluorine or more and comprises a fluorinated ingredient, a third-layer bonding ingredient, and silane. The fluorinated ingredient is any of uncured fluoroelastomer and/or emulsion fluoroplastic; and the third-layer bonding ingredient is any of an epoxy compound, a phenoxy compound, and/or a heat polymerizable thermoplastic oligomer. This embodiment also includes a fluoroelastomer-curing agent of bisphenol, peroxide, polyol, phenol, and/or amine.

In a third embodiment for an exemplary 3-layer composite, the layer of pervious fluoropolymer comprises etched polytetrafluoroethylene and the third layer of the composite comprises metal. The homogenous fluoropolymer layer material has at least five weight percent fluorine or more and comprises silane and a fluorinated ingredient of uncured fluoroelastomer and/or emulsion fluoroplastic.

In a fourth embodiment for an exemplary 3-layer composite, the layer of pervious fluoropolymer comprises etched polytetrafluoroethylene and the third layer of the composite comprises metal. The homogenous fluoropolymer layer material has at least five weight percent fluorine or more and comprises silane and a fluorinated ingredient of any of tetrafluoroethylene/hexafluoropropylene copolymer, ethylene-tetrafluoroethylene copolymer, ethylene chlorotrifluoroethylene copolymer, tetrafluoroethylene/hexafluoropropylene/vinylidene fluoride terpolymer, poly(vinylidene fluoride), tetrafluoroethylene/perfluoromethylvinylether copolymer, tetrafluoroethylene/perfluorovinylether copolymer, perfluoroalkoxy/tetrafluoroethylene copolymer, hexafluoropropylene/vinylidene fluoride copolymer, and/or chlorotrifluoroethylene/vinylidene fluoride copolymer.

In a fifth embodiment for an exemplary 3-layer composite, the layer of pervious fluoropolymer comprises fluoroelastomeric thermoplastic vulcanizate, and the third layer comprises material selected from the group consisting of thermoplastic, thermoplastic vulcanizate, thermoplastic elastomer, elastomer, and/or thermoset plastic. The homogenous fluoropolymer layer material has at least five weight percent fluorine or more and comprises a fluorinated ingredient, a third-layer bonding ingredient, and a conditional third-layer curing agent. The fluorinated ingredient is any of uncured fluoroelastomer and/or emulsion fluoroplastic; and the third-layer bonding ingredient is any of an epoxy compound, a phenoxy compound, and/or a heat polymerizable thermoplastic oligomer. This embodiment also includes a fluoroelastomer-curing agent of bisphenol, peroxide, polyol, phenol, and/or amine; and (if the third layer comprises any of thermoplastic elastomer, elastomer, or thermoset plastic) the third-layer curing agent is any of amine or sulfur.

In a sixth embodiment for an exemplary 3-layer composite, the layer of pervious fluoropolymer comprises fluoroelastomeric thermoplastic vulcanizate, and the third layer comprises metal. The homogenous fluoropolymer layer material has at least five weight percent fluorine or more and comprises a fluorinated ingredient, a third-layer bonding ingredient, and silane. The fluorinated ingredient is any of uncured fluoroelastomer and/or emulsion fluoroplastic; and the third-layer bonding ingredient is any of an epoxy compound, a phenoxy compound, and/or a heat polymerizable thermoplastic oligomer. This embodiment also includes a fluoroelastomer-curing agent of bisphenol, peroxide, polyol, phenol, and/or amine.

In a seventh embodiment for an exemplary 3-layer composite, the layer of pervious fluoropolymer comprises fluoroelastomeric thermoplastic vulcanizate, and the third layer comprises metal. The homogenous fluoropolymer layer material has at least five weight percent fluorine or more and comprises a fluorinated ingredient and silane. The fluorinated ingredient is any of uncured fluoroelastomer and/or emulsion fluoroplastic. This embodiment also includes a fluoroelastomer-curing agent of bisphenol, peroxide, polyol, phenol, and/or amine.

In an eighth embodiment for an exemplary 3-layer composite, the layer of pervious fluoropolymer comprises fluoroelastomeric thermoplastic vulcanizate, and the third layer comprises metal. The homogenous fluoropolymer layer material has at least five weight percent fluorine or more and comprises comprises silane and a fluorinated ingredient of tetrafluoroethylene/hexafluoropropylene copolymer, ethylene-tetrafluoroethylene copolymer, ethylene chlorotrifluoroethylene copolymer, tetrafluoroethylene/hexafluoropropylene/vinylidene fluoride terpolymer, poly(vinylidene fluoride), tetrafluoroethylene/perfluoromethylvinylether copolymer, tetrafluoroethylene/perfluorovinylether copolymer, perfluoroalkoxy/tetrafluoroethylene copolymer, hexafluoropropylene/vinylidene fluoride copolymer, and/or chlorotrifluoroethylene/vinylidene fluoride copolymer. This embodiment also includes a fluoroelastomer-curing agent of bisphenol, peroxide, polyol, phenol, and/or amine.

The invention also provides a multilayer composite having a layer of pervious fluoropolymer melt bonded to a second layer of homogenous fluoropolymer where the homogenous fluoropolymer of the second layer is compositionally different from the pervious fluoropolymer of the pervious fluoropolymer layer. The pervious fluoropolymer is fluoroelastomeric thermoplastic vulcanizate and/or etched polytetrafluoroethylene. If used, etched polytetrafluoroethylene of the layer of pervious fluoropolymer is derived from polytetrafluoroethylene in a layer of pervious fluoropolymer precursor component etched such that etched polytetrafluoroethylene in the precursor component has a carbon to fluorine weight ratio from about 0.35 to about 10. The homogenous fluoropolymer layer material comprises fluoroelastomer and/or fluoroplastic.

Alternative multi-layer composite embodiments also have a third layer cohered to the second layer; the third layer consisting of thermoplastic, thermoset plastic, metal, ceramic, rubber, wood, and/or leather. In these embodiments, the layer material of the second layer further comprises cured epoxy compound, a cured phenoxy compound, and/or a thermoplastic other than the other than the fluoroplastic. If the third layer is metal, then the second layer also comprises silane as a bonding ingredient. The multilayer composite is further adapted, in alternative exemplary embodiments of both 2-layer and 3-layer composites as previously described, to be any of a gasket, a dynamic torsion seal, a static compression seal, and an o-ring. In one exemplary embodiment, a 3-layer multilayer composite provides a clip-in torsion seal assembly featuring a pervious fluoropolymer torsion seal and a steel clipping flange, with both the seal and the flange being cohered in the composite through an interfacing melt-bonded layer.

In another example, an exemplary non-planar 3-layer multilayer composite embodiment for a (first) assembly component provides a (first) layer of pervious fluoropolymer as a seal for interfacing to a surface of a second component of the assembly; the third layer of the 3-layer multilayer composite component is the structural body of the first assembly component, with both the pervious fluoropolymer seal and the structural body being cohered in the composite through an interfacing melt-bonded layer (the second layer of the multilayer composite). In one embodiment of such an assembly, the layer of pervious fluoropolymer comprises fluoroelastomeric thermoplastic vulcanizate and the third layer comprises cured phenolic resin.

The embodiments relate to multilayer composites having a layer (or section) made of pervious fluoropolymer (porous fluoropolymer that enables capillary-flow imbibing of liquid homogenous fluoropolymer) selected from the group consisting of fluoroelastomeric thermoplastic or of etched polytetrafluoroethylene (and including combinations of fluoroelastomeric thermoplastic and etched polytetrafluoroethylene); more specifically, the embodiments relate especially to a composition (an adhesive composition) for a melt-bonded layer cohered to the pervious fluoropolymer layer in such multilayer composites. In one embodiment, the cured adhesive composition does “double duty” in adhering to the pervious fluoropolymer layer or pervious fluoropolymer section while also functioning as a structural layer or other super-additive (to the adhesive functionality) functional section in the multilayer composite.

Carbon-chain-based polymeric materials (polymers) are usefully defined as falling into one of three traditionally separate generic primary categories: thermoset materials (one type of plastic), thermoplastic materials (a second type of plastic), and elastomeric (or rubber-like) materials (elastomeric materials are not generally referenced as being “plastic” insofar as elastomers usually do not provide the property of a relatively inflexible solid “finished” state). One important measurable consideration with respect to these three categories is the concept of a melting point (MP)—a point where a solid phase and a liquid phase of a material co-exist. A second important measurable consideration with respect to these three categories is the concept of a glass transition temperature (Tg). In this regard, a thermoset material essentially cannot be melted or liquefied after having been “set” or “cured” or “cross-linked”. Precursor component(s) to the thermoset plastic material are usually shaped in molten (or essentially liquid) form, but, once the setting process has executed, a melting point essentially does not exist for the material. A thermoplastic plastic material, in contrast, hardens into solid form, retains a melting point (or, for a few thermoplastic materials as further discussed below, a glass transition temperature of greater than 0 degrees Celsius) essentially indefinitely, and re-melts (albeit in some cases with a certain amount of degradation in general polymeric quality) after having been formed. An elastomeric (or rubber-like) material does not have a melting point; rather, the elastomer has a glass transition temperature of not greater than 0 degrees Celsius where the polymeric material demonstrates an ability to liquefy and usefully flow, but without co-existence of a solid phase and a liquid phase at a melting point.

In further consideration of melting points and glass transition temperatures, most thermoplastic materials have a melting (solidification) point associated with the presence of crystals in the thermoplastic polymer, but some thermoplastics (such as, without limitation, atactic polystyrene) are considered to be substantially amorphous with a characteristic glass transition temperature rather than a melting point. In this regard and as detailed above, elastomers and amorphous thermoplastics are differentiated by the ranges of their glass transition temperatures, with the glass transition temperature for an essentially amorphous thermoplastic being greater than 0 degrees Celsius and the glass transition temperature for an elastomer being not greater than 0 degrees Celsius.

In detailed consideration of microscopic aspects of melting points and glass transition temperatures, a large set of individual polymer molecules collectively form polymer materials or polymer masses having internal morphologies with independent aspects that emerge under microscopic examination of the particular polymeric material (polymer mass). In this regard, the term “polymer” in colloquial usage can reference either (a) a particular molecule derived from the linking together of a plurality of at least one monomer unit type, (b) a collection of such molecules in a polymeric material (polymer mass) as a region of the material, or (c) the polymer material as a collected and holistic polymer mass. Concepts such as melting point and glass transition temperature have commensurately differentiated relevance. In this regard, a melting point in one polymer material embodiment can reference (in one context) a generalized energy state in a polymer material where the entire mass of material becomes effectively liquid. However, the term of “melting point” for a micro-region of that polymer material embodiment can also reference (in a second context) localized behavior and status where the regional energy becomes too high to sustain crystalline morphology in the independent polymer molecules in the region, even though the overall macroscopic status of the material is still effectively solid. In this regard, a melting point for an isolated crystallizable polymeric chain is the energy state where it transitions between a crystalline morphology and a morphology which does not evidence the ordered structural aspects of a crystal; a melting point in a large group of polymer chains (a polymeric material) references a temperature (and implied pressure—usually standard pressure) such that a solid material exists at a temperature below the melting point for the group and an effectively liquid material exists at a temperature above the melting point for the group.

As indicated in the above, when a particular polymer material is microscopically examined, local morphological aspects of the polymer material emerge that redefine the polymeric material into sets of dispersed morphological regions; three such regions have especial relevance in appreciating the nature of this description: polymeric crystal regions, polymeric amorphous regions, and pores.

A polymeric material exhibiting a bulk melting point usually exhibits morphology having the structural features of polymer crystal particles (or polymeric crystal portions or polymeric crystal regions) dispersed in an amorphous polymer continuum (providing polymeric amorphous regions bordering small sets of polymer crystal portions—where one such amorphous region is somewhat akin to a small sea or sound inside of a group of islands, such as the New Georgia Sound within the Solomon Islands). In microscopic consideration of such a polymeric material, the crystalline regions have affiliated local melting points, and the amorphous regions have affiliated local glass transition temperatures. These regions have cross-sectional dimensions that are rather small: usually in the 5 to 1000 Angstrom (5×10⁻⁴ to 0.1 micron) range. When such a polymer material progressively undergoes a temperature increase from a fairly rigid solid material (at a temperature below its bulk melting point, below all of its localized melting points, and below all of its localized glass transition temperatures) to a liquid material (at a temperature at or above its bulk melting point), the amorphous regions individually progress through their glass transition temperatures and the polymer crystal regions individually progress through their melting points at different times. This can be observed through use of differential scanning calorimeter (DSC) systems. Usually, the localized glass transition temperatures are lower than the localized melting points. The general process of a solid becoming a liquid is termed liquefaction. Accordingly, in the overall process of the polymer material undergoing a temperature increase from the fairly rigid solid material of intermixed crystalline regions and non-flowable amorphous regions (at a temperature below all of the regionally localized melting points and all of the regionally localized glass transition temperatures) to the liquid material, the liquefaction occurs between a liquefaction range sub-point temperature and a liquefaction range supra-point temperature. In this regard, the liquefaction range sub-point temperature for a polymer mass or polymer material is defined herein as that temperature where any amorphous region of a polymer melt containing the amorphous region demonstrates liquefaction via measured micro-movement in the phase as determined through differential scanning calorimetry, and the liquefaction range supra-point temperature for a polymer mass or polymer material is defined herein as that temperature where the entire polymer mass or polymer material (all regions as previously existent in the solid or partially liquefied polymer material) demonstrates liquefaction as determined through differential scanning calorimetry.

Turning now to the process of cooling a polymer melt into a polymer material, a polymer material undergoes a temperature decrease from a completely liquid material (a material above its liquefaction range supra-point temperature) to a solid material. During this cooling process, polymer crystals individually form at different times during the solidification process as their respective local regions progress through their respective melting points at different times during the solidification process. Residual amorphous regions also individually progress through their individual regional glass transition temperatures at different times during the cooling and solidification process. Below its glass transition temperature, a material is considered to no longer be liquid and is considered to be a solid insofar as perceptible flow does will not readily occur; it is to be noted, however that solids, especially polymeric solids or solid micro-regions, may exist either as gelled solids (at temperatures near to the glass transition temperature) or as vitrified solids (at temperatures that are substantially below the glass transition temperature). In this regard, gelled solids are less rigid to deformation than vitrified solids, and gelled solids are potentially more chemically reactive and/or miscible with a contacting solvent than are vitrified solids.

As can be appreciated, many polymeric materials at room temperature have some regions that are crystalline, some regions that are individually amorphous and below the local glass transition temperature, and other regions that are individually amorphous as a local liquid region above the local glass transition temperatures. Such a material frequently has an essentially solid overall character, but an elongated component of such a material is macroscopically flexible to some degree.

Polymer masses are usually not internally deterministic in properties such as molecular weight of independent polymer chains within the polymer mass; in this regard, a polymer mass is made of polymer chains that collectively usually provide a distribution of molecular weights. The distribution usually may be characterized by variables relevant to a statistical distribution, so a mean molecular weight and a standard deviation of molecular weight can be characterized for the polymeric mass. Copolymers can also have polymer chains of differentiated character as monomer sequencing from chain to chain is usually somewhat differentiated during polymer chain development. Accordingly, in localized regions, “polymer” that is similar between regions both in chemical composition and amorphous morphology may not necessarily share regional physical-state similarity. In other words, parameters for a statistical distribution of regional polymer properties in a polymer mass may not reflect commensurate parameters for a statistical distribution of polymer properties for the polymer mass as a whole. Microscopically-localized amorphous regions in a polymer mass can therefore be somewhat differentiated in physical behavior near the glass transition temperature due to microscopically-localized differences in chemical and/or physical factors such as (for example) temperature, individual polymer chain molecular weights, additive concentration, and the like. Near the glass transition temperature for the mass as a whole, each micro-region of polymer therefore could be independently (at any moment in time) vitreous and rigid, gel-like, “slush-like” (like melting snow), or liquid in micro-consistency.

As the crystalline regions become established during cooling and/or as certain regions change in amorphous nature to independently become polymer regions below their localized glass transition temperatures (to a gelled amorphous solid region or a vitrified amorphous solid region), the various regions each acquire an independent density. The overall polymer mass commensurately acquires the aspect of regionally differentiated densities. These differentiated densities establish internal stresses between the regions. The polymer mass as a whole impedes movement of individual regions to relieve many of these internal stresses, and some of these internal stresses therefore progressively increase to exceed intra-molecular bonding forces (such as van der Waals forces) between some of the regions. When this occurs, a boundary is defined between two or more adjoining regions and the two regions separate at the boundary with commensurate definition of a void having a void volume or void space between the boundaries of the separated regions. Collectively, these voids eventually establish a distributed set of continuous passages and pathways in a random arrangement throughout the polymeric material, with some of the voids extending to “terminate” (or interface to the environment external to the polymer mass) at an open cross-sectional area (or hole) in the surface of the article made of the polymer mass. Pathways that directly or indirectly interface to the environment external to the polymer material provide pores in the polymer material (polymer mass). Typically, in a melt induced pore system, the cross-sectional area across a pore will be on the order of 15 microns or less. So, in one process, differential solidification within the polymeric melt occurs with crystallization of some polymer chains; regions intensive in crystallized chains progress to a higher density than the density of nearby amorphous regions, and pores are generated to relieve stresses between the regions of separate density as cooling occurs. In another process, differential solidification within the polymeric melt occurs with differentiated cooling of different regions of the polymeric melt to below their individual regional glass transition temperatures; regions cooled to glass transition at one time have a different density than nearly regions which cool to glass transition at another time, and pores are generated as stresses between the regions of separate density are relieved during the cooling process.

Pores can also be formed in some materials (such as PTFE) through a process of sintering, where a collection of polymeric particles is compacted together under appropriate temperature and pressure to effect inter-particle cohesion. Since the surfaces of the cohered particles don't perfectly abut, open spaces are residually present between particles after sintering; these open spaces provide a pore system. In some applications, an article made by such sintering is mechanically elongated after sintering to enhance pore size in the sintered polymer material.

Another method for pore formation is that gases (such as air, water vapor, and/or nitrogen) migrate and/or are mixed into a liquid polymer melt, and these gases create bubbles in the melt that evolve into pore locations within the melt during solidification.

Many pores created through these melt cooling processes or through sintering processes have a pore size sufficient to enable liquid capillary flow and also to provide a definable void volume within the polymeric melt. The pores and void volume are stable and thereby differentiated from inter-molecular free volume discontinuities within the melt which derive from unstable trapped volume generated between molecular chains as the polymer melt abruptly cools through its glass transition temperature.

Irrespective of the method of making pores, polymer masses having a system of pores is denoted herein as pervious polymer if the pores are of sufficient size to enable capillary flow into voids of the polymer material; in other words, pervious polymer is a mass of polymer capable of imbibing a liquid via capillary flow. By porous as used herein therefore is meant a random system of distributed pores (capillary voids) such that a distributed set of continuous passages and pathways are provided throughout a material. Individual pores in this regard exhibit an average pore size in the range of from about 0.05 micron to about 15.0 microns (micrometers). Of special interest in this description is pervious fluoropolymer having such a pore structure.

Fluoroelastomeric thermoplastic and polytetrafluoroethylene are two fluoropolymers for use in the pervious fluoropolymer layer. A preferred liquid for being imbibed via capillary flow into the pervious fluoropolymer in this regard is a homogenous fluoropolymer of any of fluoroplastic, uncured fluoroelastomer, or combinations thereof where the uncured fluoroelastomer is liquid at room temperature. The pervious fluoropolymer has a preferred porosity (void volume) range of from about 5 to about 30 volume percent when the pervious fluoropolymer primarily comprises fluoroelastomeric thermoplastic vulcanizate. The pervious fluoropolymer has a preferred porosity (void volume) range of from about 20 to about 50 volume percent when the pervious fluoropolymer primarily comprises polytetrafluoroethylene.

Elastomers are frequently derived from elastomer gums or partially cured elastomer gums through the process of vulcanization (curing, or cross-linking). Such elastomer gum or partially-cured-elastomer-gum forms of elastomer are denoted herein as uncured elastomers. Depending upon the degree of vulcanization in an elastomer, the glass transition temperature may increase to a value that is too high for any practical attempt at liquefaction of the vulcanizate. Vulcanization implements inter-bonding between elastomer chains to provide an elastomeric material more robust against deformation than a material made from the uncured or partially cured elastomers. In this regard, a measure of performance denoted as a “compression set value” is useful in measuring the degree of vulcanization (“curing”, “cross-linking”) in the elastomeric material. For the initial uncured elastomer form of the elastomer, when the elastomer material is in either a non-vulcanized state or in a state of vulcanization that is clearly preliminary to the final desired vulcanized state, a non-vulcanized compression set value is measured according to ASTM D395 Method B and establishes thereby an initial compressive set value for the particular elastomer that will be vulcanized (cured) to a desired compressive set value. Under extended vulcanization, the elastomer vulcanizes to a point where its compression set value achieves an essentially constant maximum respective to further vulcanization, and, in so doing, thereby defines a material where a fully vulcanized compression set value for the particular elastomer is measurable. In applications, the elastomer is vulcanized to a compression set value useful for the application.

Augmenting the above-mentioned three general primary categories of thermoset plastic materials, thermoplastic plastic materials, and elastomeric materials are two blended combinations of thermoplastic and elastomeric materials generally known as TPEs and TPVs. Thermoplastic elastomer (TPE) and thermoplastic vulcanizate (TPV) materials have been developed to partially combine the desired properties of thermoplastics with the desired properties of elastomers. As such, TPV materials are usually multi-phase mixtures of vulcanized elastomer in thermoplastic. Traditionally, the vulcanized elastomer (vulcanizate) phase and thermoplastic plastic phase co-exist in phase mixture after solidification of the thermoplastic phase; and the mixture is liquefied by heating the mixture above the melting point of the thermoplastic phase of the TPV. TPE materials are multi-phase mixtures, at the molecular level, of elastomer and thermoplastic and are derived by polymerizing together monomers and/or oligomer of elastomer and thermoplastic. TPVs and TPEs both have melting points enabled by their respective thermoplastic phase and/or molecular aspects.

The elastomeric phase in traditional TPV materials provides a compressive set value (as further discussed in the following paragraph) from about 50 to about 100 percent between a non-vulcanized compressive set value and a fully vulcanized compressive set value. In this regard, the non-vulcanized compressive set value is measured for elastomer gum in the initial combination of elastomeric gum (uncured elastomer) and thermoplastic used to make a thermoplastic vulcanizate; and the fully vulcanized compressive set value is measured for the vulcanizate (the cured material derived from the elastomeric gum) in the thermoplastic vulcanizate after it has been extensively vulcanized.

With respect to a difference between a non-vulcanized compressive set value for an elastomer (in the uncured elastomer or elastomer gum state) and a fully-vulcanized compressive set value for an elastomer, it is to be noted that percentage in the 0 to about 100 percent range (between a non-vulcanized compression set value respective to the uncured elastomer or elastomer gum and to a fully-vulcanized compression set value respective to the elastomer) applies to the degree of vulcanization in the elastomer or elastomer gum rather than to percentage recovery in a determination of a particular compression set value. As an example, an elastomer gum prior to vulcanization (uncured elastomer for the example) has a non-vulcanized compression set value of 72. After extended vulcanization, the vulcanized elastomer demonstrates a fully vulcanized compression set value of 10 (which could involve a 1000% recovery from a thickness measurement under compression to a thickness measurement after compression is released). A difference between the values of 72 and 10 indicate a range of 62 between the non-vulcanized compression set value respective to the uncured elastomer and a fully vulcanized compression set value respective to the cured elastomer. Since the compression set value decreased with vulcanization in the example, a compressive set value within the range of 50 to about 100 percent of a difference between a non-vulcanized compression set value respective to the uncured elastomer and a fully-vulcanized compression set value respective to the cured elastomer would therefore be achieved with a compressive set value between about 41 (50% between 72 and 10) and about 10 (the fully-vulcanized compression set value).

In various embodiments, uncured elastomers are characterized by a low level of vulcanization or cure as reflected or manifested in relatively low attainment of elastomeric properties. One of these properties is the compression set property. The compression set property of an uncured elastomer is less than 5 to 10 percent developed respective to the compression set value achieved during curing from the initially uncured to the fully-cured value as the elastomer is cured to achieve desired elastomeric properties for an application.

In one characterization of uncured elastomer, elastomer gum is effectively a relatively low molecular weight post-oligomer elastomeric precursor of a cured elastomeric material. More specifically, elastomer gum has a glass transition temperature, a decomposition temperature, and, at a temperature having a value that is not less than the glass transition temperature and not greater than the decomposition temperature, a compressive set value (as further described herein) from about 0 to about 5 percent of a difference between a non-vulcanized (non-cured) compressive set value for elastomer derived from the elastomer precursor gum and a fully-vulcanized (fully-cured) compressive set value for the derived elastomer. More specifically for fluoroelastomers, an elastomer gum has a Mooney viscosity of from about 0 to about 150 ML₁₊₁₀ at 121 degrees Celsius when the relative fully vulcanized (fully-cured) elastomer is fluoroelastomeric.

Another characterization of uncured elastomer is for solution elastomer or for elastomeric latex where the curing process concentrates the elastomer from its solvent and/or aqueous base until compression set properties are reasonably measurable. Yet another form of uncured elastomer is provided with liquid elastomer that does not effectively provide a measurable compression set value that is less than about 100 percent.

A multilayer composite according to this description (for clarity, hereinafter referred to as “composite”) is formed in the embodiments from at least one layer comprising pervious fluoropolymer selected from the group consisting of fluoroelastomeric thermoplastic, polytetrafluoroethylene etched such that etched polytetrafluoroethylene (those molecules of the pervious fluoropolymer layer that are etched when the pervious fluoropolymer layer comprises polytetrafluoroethylene) in the first layer has a carbon to fluorine weight ratio from about 0.35 to about 10, and combinations thereof.

When the pervious fluoropolymer layer comprises fluoroelastomeric thermoplastic (FKM-TPV), the pervious fluoropolymeric layer effectively is a multiphase composition having a continuous phase of a thermoplastic polymer material and an amorphous phase comprising a fluoroelastomer where the amorphous phase is dispersed in the continuous phase. The thermoplastic phase has at least one of either (a) a glass transition temperature of 0 degrees Celsius or above or (b) a melting point.

When the pervious fluoropolymer layer comprises polytetrafluoroethylene (PTFE), then the polytetrafluoroethylene is etched to provide a carbon to fluorine weight ratio from about 0.35 to about 10 (etched to provide between an average of from about 11 fluorine atoms for every 6 carbon atoms in etched PTFE to about an average of I fluorine atom for every sixteen carbons in etched PTFE) in the polyfluoroethylene free-radical-containing chains (etched polytetrafluoroethylene) that are generated from the original polytetrafluoroethylene after the etching process. The etching process can be achieved with a chemical etching agent or with radiation. The etching modifies the PTFE to provide free radical bonding sites on the remaining polyfluoroethylene chains (the etched polytetrafluoroethylene chains) for bonding to the homogenous fluoropolymer layer material. When a low level of etching is used, and essentially 11 fluorine atoms are left after etching for every 6 atoms of carbon in the chain, an average of one free radical site is provided for every 6 atoms of carbon in the etched PTFE chains. When a high level of etching is used, and essentially 1 fluorine atom is left after etching for every sixteen carbon atoms, an average of fifteen free radical sites are provided for every 6 carbon atoms in the etched PTFE chains.

Etching of PTFE is achieved in one embodiment with a chemical agent; in an alternative embodiment, etching is achieved with radiation. Agents for chemical etching include sodium-naphthalene aqueous solution and sodium-ammonia aqueous solution. Depending upon the desired carbon to fluorine ratio in the etched polytetrafluoroethylene, the sodium-naphthalene aqueous solution is applied at room temperature for from about 3 minutes to about 10 minutes, and the sodium-ammonia aqueous solution is applied at room temperature for from about 30 seconds to about 2 minutes.

Turning now to the melt-bonded layer in the multilayer composite, the layer material comprises homogenous fluoropolymer. In this regard, the homogenous fluoropolymer layer material in one embodiment comprises essentially one polymeric component; in an alternative embodiment it comprises a homogenous polymer blend. If the homogenous fluoropolymer layer material is a homogenous polymer blend, then it is blended so that any dispersed non-filamentary phase has a maximum particle or portion diameter not greater than 10 microns and so that any dispersed filamentary phase has a maximum cross-sectional diameter not greater than 10 microns. In this regard, the melt-bonded layer provides maximal bonding efficacy when it is imbibed as a holistic homogenous blend by capillary flow into the pores of the pervious fluoropolymer layer; therefore, homogeneity to provide a 10 micron maximum for dispersed phase portion sizes augments such holistic imbibing. Further aspects of the homogenous fluoropolymer layer material for the melt-bonded layer are defined with respect to the particular pervious fluoropolymer layer to which it will be melt-bonded so that the melt-bonded layer and the pervious fluoropolymer layer significantly cohere.

The homogenous fluoropolymer layer material functions therefore to provide an imbuement agent for the creating of a composite. In this regard, an imbuement agent is defined herein as an adhesive layer ingredient in an adhesive blend whose purpose is to imbibe within a porous layer and then to cure or otherwise modify so that the cured imbuement agent in the adhesive layer and the cured imbuement agent in the pores of the porous layer provide a robust material continuum bonding the adhesive layer to the porous layer. More particularly, an imbuement agent imbibes, via flow enabled by capillary effects, into pore spaces of a porous layer adjacent to the adhesive layer where the imbuement agent is in sufficient quantity in the adhesive blend so that, after capillary flow penetration (imbibing) of the imbuement agent into the adjacent layer, a portion of the imbuement agent has been retained in the adhesive layer and a portion of the imbuement agent has penetrated into the porous adjacent layer; the imbuement agent then cures, effectively solidifies, and/or cross-links, after penetration into the porous layer, so that chemical bonds are established between cured imbuement agent in the penetrated portion within the porous layer and cured imbuement agent in the retained portion of the adhesive layer. The cured imbuement agent in the porous layer and in the adhesive layer therefore mechanically and/or chemically coheres the adhesive layer to the porous layer in those pores effectively filled or penetrated with the cured or solidified imbuement agent. Such bonds tend to provide strength because a separating force is applied effectively tangentially to the axis of a “cylinder” of cured homogenous polymer in the pore wall interface and perpendicular to the layer-interface bonds (rather than perpendicularly to the surface interface and parallel to the layer-interface bonds as is the case with direct surface bonding on the exterior surface between two layers).

In a first aspect, the homogenous fluoropolymer of the melt-bonded layer in this description has fluorinated molecules derived from at least one monomer unit stoichiometrically identical to a monomer unit from which the fluorinated molecules of the pervious fluoropolymer are derived. In this regard, the homogenous fluoropolymer layer material for the melt-bonded layer is therefore formulated with respect to the particular pervious fluoropolymer layer to which it will be melt-bonded so that the melt-bonded layer and the pervious fluoropolymer layer have common monomer units (monomer units of identical stoichiometric formula) in the polymer chains of their respective polymers.

In a second aspect, the homogenous fluoropolymer layer material has a liquefaction range supra-point temperature not greater than the liquefaction range supra-point temperature of the pervious fluoropolymer. The homogenous fluoropolymer layer material for the melt-bonded layer is therefore formulated with respect to the particular pervious fluoropolymer layer to which it will be melt-bonded so that the melt-bonded layer has a liquefaction range supra-point temperature (that temperature where the entire polymer mass is liquid) that is “less than” or (at most) “equal to” the liquefaction range supra-point temperature of the polymer of the pervious fluoropolymer layer. This aspect assures that the melt-bonded layer will not initiate solidification prior to the initiation of solidification in the pervious fluoropolymer layer. In one embodiment, the melt-bonded layer initiates solidification (during a composite cooling process) after or simultaneously—with the pervious fluoropolymer layer if both layers are liquid at the time when cooling is initiated; in this scenario, however, the melt-bonded layer will not initiate solidification prior to the initiation of solidification in the pervious fluoropolymer layer. In an alternative embodiment, the melt-bonded layer definitely initiates solidification (during a composite cooling process) after the pervious fluoropolymer layer if the pervious fluoropolymer layer is already solid when the homogenous fluoropolymer layer material of the melt-bonded layer is applied as liquid and then cooling is subsequently initiated.

In a third aspect, the homogenous fluoropolymer layer material has a liquefaction range supra-point temperature not less than the liquefaction range sub-point temperature of the pervious fluoropolymer. The homogenous fluoropolymer layer material for the melt-bonded layer is therefore formulated with respect to the particular pervious fluoropolymer layer to which it will be melt-bonded so that the melt-bonded layer has a liquefaction range supra-point temperature (that temperature where the entire polymer mass is liquid) that is “greater than” or (at least) “equal to” the liquefaction range sub-point temperature (that temperature where any amorphous region of a polymer melt containing the amorphous region demonstrates liquefaction) of the polymer of the pervious fluoropolymer layer. This aspect assures that a temperature range will exist for the composite precursor (the composite prior to final curing of the melt-bonded layer to the pervious fluoropolymer layer) where the melt-bonded layer and the pervious fluoropolymer layer both have liquid micro-regions. In this regard, the homogenous fluoropolymer layer material of the melt-bonded layer is designed to fluidly blend (mix) via diffusion into at least some of the amorphous micro-regions of the pervious fluoropolymer of the pervious fluoropolymer layer.

In a fourth aspect, the homogenous fluoropolymer layer material has a viscosity at the liquefaction range supra-point temperature of the homogenous fluoropolymer layer material (the liquefaction supra-point viscosity for the homogenous fluoropolymer layer material) that is less than the viscosity of the pervious fluoropolymer at the liquefaction range supra-point temperature of the pervious fluoropolymer (the liquefaction supra-point viscosity for the pervious fluoropolymer). The homogenous fluoropolymer layer material for the melt-bonded layer is therefore formulated with respect to the particular pervious fluoropolymer layer to which it will be melt-bonded so that the melt-bonded layer has a viscosity at the liquefaction range supra-point temperature of the homogenous fluoropolymer layer material (that temperature where the entire polymer mass is liquid) that is less than the viscosity of the pervious fluoropolymer at the liquefaction range supra-point temperature of the pervious fluoropolymer. This relative viscosity aspect between the homogenous fluoropolymer layer material and the pervious fluoropolymer augments the melt-bonding process in several ways. Imbibing of the homogenous fluoropolymer layer material into developed (or developing) pores of the pervious fluoropolymer is enhanced by the homogenous fluoropolymer layer material having a viscosity that is effectively lower than the viscosity of the pervious fluoropolymer. Intermixing of the homogenous fluoropolymer layer material into non-vitrified amorphous regions of the pervious fluoropolymer (via diffusion) is also enhanced by the homogenous fluoropolymer having an effectively lower viscosity than the pervious fluoropolymer. The effective lower viscosity of the homogenous fluoropolymer also establishes a general flow “vector” for fluid migration of the homogenous fluoropolymer into the pervious fluoropolymer during the diffusion mixing rather than for fluid migration of the pervious fluoropolymer into the homogenous fluoropolymer as melt-bonding occurs.

In measuring the viscosity of the pervious fluoropolymer, the viscosity is determined through use of either a shear viscosity technique or an elongation viscosity technique. Shear viscosity is measured with any of a capillary rheometer, an oscillating rheometer, or a rotating rheometer (such as used for a Brookfield viscosity determination). Elongation viscosity is measured with an elongation rheometer.

In the context of the four constraining aspects described above, the homogenous fluoropolymer is selected from the group consisting of fluoroplastic, uncured fluoroelastomer, or combinations of fluoroplastic and uncured fluoroelastomer. If uncured fluoroelastomer is present in the homogenous fluoropolymer, the uncured fluoroelastomer has a molecular weight such that the uncured fluoroelastomer is liquid at room temperature prior to addition to the homogenous fluoropolymer. In this regard, if the homogenous fluoropolymer is blended with fluoroplastic to provide a combination of uncured fluoroelastomer and fluoroplastic, the uncured fluoroelastomer is liquid at room temperature prior to addition to the homogenous fluoropolymer. If uncured fluoroelastomer is the homogenous fluoropolymer, the uncured fluoroelastomer has a molecular weight such that the uncured fluoroelastomer is liquid at room temperature. The uncured fluoroelastomer is any of fluoroelastomer that is liquid at room temperature, solution fluoroelastomer (fluoroelastomeric polymer dissolved in an organic solvent), fluoroelastomer emulsion latex, or combinations of fluoroelastomer that is liquid at room temperature and of fluoroelastomer latex (either solution fluoroelastomer and/or fluoroelastomer emulsion latex). The fluoroplastic is provided in one embodiment in the form of non-aqueous fluoroplastic; in alternative embodiments, the fluoroplastic is provided either as solution fluoroplastic (fluoroplastic dissolved in an organic solvent) or as emulsion fluoroplastic (fluoroplastic in aqueous blend).

In many embodiments, the homogenous fluoropolymer layer material also comprises fluoroelastomer-curing agent (an agent or ingredient for cross-linking fluoroelastomer—usually a peroxide, bisphenol, polyol, phenol, amine, or combinations of these) at the time of application to the fluoropolymer of the pervious fluoropolymer layer if any one of three conditions exist. As a first condition, fluoroelastomer-curing agent is added to the homogenous fluoropolymer layer material in one embodiment if the pervious fluoropolymer of the pervious fluoropolymer layer contains fluoroelastomer. In this regard, the fluoroelastomer-curing agent is in the melt-bonded layer to promote conjoined curing of the pervious fluoropolymer material of the first layer and the homogenous fluoropolymer of the second melt-bonded layer in the regions proximate to the interface between the first and second layers and thereby promote cohesion between the third layer and the second (melt-bonded) layer. As a second condition, fluoroelastomer-curing agent is added to the homogenous fluoropolymer layer material if the homogenous fluoropolymer contains fluoroelastomer. As a third condition, fluoroelastomer-curing agent is added to the homogenous fluoropolymer layer material if both the homogenous fluoropolymer and the pervious fluoropolymer contain fluoroelastomer.

The homogenous fluoropolymer layer material is designed to provide a melt-bonded layer that coheres to the pervious fluoropolymer layer through a plurality of bonding factors.

In one factor, a type of mechanical inter-linkage is achieved between the melt-bonded layer and pervious fluoropolymer layer by imbibing (via capillary flow) liquid homogenous fluoropolymer into the pores of the pervious fluoropolymer layer in such a manner as to provide a fluid continuum of imbibed uncured homogenous fluoropolymer (in the pervious fluoropolymer layer) and uncured homogenous fluoropolymer in the “main” portion of the melt-bonded layer (that portion of homogenous fluoropolymer layer material that is not imbibed into the pervious fluoropolymer layer), and then by curing all homogenous fluoropolymer layer material in the multilayer composite so that “fingers” or “tendrils” of cured homogenous fluoropolymer residually extend snuggly into the pores of the pervious fluoropolymer from the main portion of the cured homogenous fluoropolymer melt-bonded layer. The effect of this first factor is that, after curing, the cured homogenous fluoropolymer is mechanically bound to the pervious fluoropolymer in a manner similar to the admittedly unfortunate situation of a bowling ball being tightly cohered to a human when the finger-holes of the bowling ball happen to unfortunately be too snug for the fingers of the human to be readily removed.

In a second factor, chemical inter-linkage is achieved between the melt-bonded layer and pervious fluoropolymer layer as liquid homogenous fluoropolymer fluidly diffuses and interblends into some amorphous regions of the pervious fluoropolymer layer in such a manner as to provide an essentially continuous compositional presence of uncured homogenous fluoropolymer across a fluid continuum of (a) the amorphous polymer of the amorphous polymer region in the pervious fluoropolymer layer, (b) the uncured homogenous fluoropolymer in the pores, and (c) the uncured homogenous fluoropolymer in the “main” portion of the melt-bonded layer. When the homogenous fluoropolymer layer material in the multilayer composite is subsequently cured, molecular chains of cured homogenous fluoropolymer effectively extend between and/or are closely-linked throughout some amorphous regions of the pervious fluoropolymer, the pores of the pervious fluoropolymer, and the main portion of the cured homogenous fluoropolymer melt-bonded layer. The effect of this second factor is that, after curing, the cured homogenous fluoropolymer is effectively intermixed into some amorphous micro-portions of the pervious fluoropolymer. This intermixing occurs both along and across the external surface of the pervious fluoropolymer layer that adjoins to the melt-bonded layer and also along all surfaces defining the pores where the homogenous fluoropolymer has been imbibed. This second factor is further augmented with the stoichiometrically common monomer unit of the fluoropolymer of the pervious fluoropolymer layer and the fluoropolymer of the homogenous fluoropolymer layer. In the situation where the homogenous fluoropolymer layer material comprises fluoroplastic and does not comprise curing agent, the stoichiometrically common monomer aspect for the homogenous fluoropolymer and the pervious fluoropolymer enhances miscibility of the homogenous fluoropolymer into liquid and gelled solid amorphous regions of the pervious fluoropolymer.

In a third factor, when the pervious fluoropolymer layer comprises etched PTFE, chemical inter-linkage is achieved between the melt-bonded layer and pervious fluoropolymer layer as liquid homogenous fluoropolymer fluidly diffuses and interblends to the free radical sites on the PTFE chains. As the fluoropolymer layer cures, the free radical sites bond to the polymeric chains of the homogenous fluoropolymer of the melt-bonded layer.

In various pervious fluoropolymer embodiments, it is observed that a multiphase composition having a continuous phase of a thermoplastic polymer material and a dispersed amorphous phase of fluoroelastomer (an FKM-TPV) can be extruded and/or molded to provide a very thin fluoroelastomeric layer having structural integrity and chemo-resistive properties traditionally associated with articles made entirely of the fluoroelastomer. In this regard, a very thin (0.5 mil) pervious fluoropolymeric layer having chemical resistance and high temperature properties comparable to chemical resistance and high temperature properties of thicker traditional FKM elastomer layers is one advantageous property and/or improvement that is beneficially observed in a composite when the pervious fluoropolymeric layer comprises a multiphase composition having a continuous phase of a thermoplastic polymer material and an amorphous phase (comprising a fluoroelastomer) dispersed in the continuous phase. Preferably, such FKM-TPVs have an amorphous phase as independent dispersed fluoroelastomer portions having independent diameters of from about 0.1 microns to about 100 microns.

In appreciating the ability to make very thin layers of fluoropolymer having chemical resistance and high temperature properties comparable to that of a traditional fluoroelastomer, traditional FKM elastomer (rubber) has been used for many years for items such as o-rings or gaskets. Such FKM rubber items have traditionally been compression molded to achieve minimum dimensions of not less than about 50 mils (about 3/64 of an inch). Items made of FKM rubber frequently undergo some additional dimensional adjustment during post-mold curing. While FKM-TPV (fluoroelastomer thermoplastic vulcanizate) materials were developed to, in part, provide a substantial degree of “FKM rubber functionality” in a material that could be readily injection molded and/or extruded, the injection molding and/or extrusion of layers of fluoroelastomer and thermoplastic blends at 0.01 of the thickness of traditional FKM rubber in some embodiments provides very beneficial precision in molding and/or extrusion; such functionality enables improvements in composites as will be further described herein.

In addition to the pervious fluoropolymer layer and melt-bonded layer, various composites of this description optionally contain another layer to which the pervious fluoropolymer layer is cohered through use of the cured homogenous fluoropolymer layer material functioning as an adhesive in the composite layer in the composite. In such composites, the pervious fluoropolymer layer is a first layer in the composite, the melt-bonded layer is a second layer (the adhesive layer) in the composite, and the third layer is made of any of a thermoplastic material, a thermoset plastic material, a metal, ceramic, rubber, wood, leather, or combinations of these materials. The second layer (the adhesive layer and the melt-bonded layer) therefore is cohered (bonded) to both the pervious fluoropolymer layer and also to the third layer in such a manner that the first and third layers independently cohere to the second layer. The homogenous fluoropolymer layer material of the second (melt-bonded) layer is also accordingly formulated in these embodiments to comprise a third-layer bonding ingredient. This third-layer bonding ingredient is any of an epoxy compound, a phenoxy compound, a heat polymerizable thermoplastic oligomer, or combinations of these candidate third-layer bonding ingredient materials. If the third layer is metal, the homogenous fluoropolymer layer material of the second (melt-bonded) layer is also formulated in these embodiments to comprise silane. While formulation of a particular homogenous fluoropolymer blend for a particular multilayer composite will be further described herein, it is anticipated that the weight ratio of the third-layer bonding ingredient to fluoropolymer in the homogenous fluoropolymer layer material will be from about 40:60 to about 60:40.

When an epoxy material is selected for use in the third-layer bonding ingredient, the epoxy is any of a heat-curable epoxy, an epoxy with a hardening (curing) agent blended-in just prior to applying the melt-bonded layer to the third layer, or combinations of these.

In further consideration of the third-layer bonding ingredient, curable epoxy can be applied at room temperature and will react to cohere to most surfaces; however, epoxy is a relatively brittle material and can therefore fracture under mechanical shock. Heat curable epoxy does not need a curing agent, but it does require a curing temperature of from about 80 degrees Celsius to about 100 degrees Celsius; it also is relatively brittle. Examples of epoxy curing agents include aliphatic amines, aromatic amines, polyamidoamines, polyamides, anhydrides, dicyanidiene, polycarboxcylic polyesters, isocyanates, phenol-formaldehyde novolacs, polysulfides, polymercaptans, melamine-formaldehyde, urea-formaldehyde, and phenolics.

Phenoxy materials provide a somewhat weaker bond to the third layer than epoxies, but such phenoxy bonds should be more robust under mechanical shock than the aforementioned epoxy bonds. In some embodiments, phenoxy materials are crosslinked with an epoxy. Thermoplastic oligomer should establish flexible bonds to the third layer that are very robust under mechanical shock, but the bonds to the third layer will probably not be as rigid as those achieved with either epoxy and/or phenoxy. Thermoplastic oligomer also is selected with a monomer type that is appropriate for bonding to a particular third-layer material. It is very likely that the third-layer bonding ingredient will be a blend of at least two and possibly all of the three candidate third-layer ingredient components. In this regard, for a specific multilayer composite situation, a preferable approach for determining an appropriate third-layer bonding ingredient in the designed adhesive embodiment involves designed empirical evaluating (as further described herein) of alternative test composites made with each of an epoxy, a phenoxy, an appropriate thermoplastic oligomer, and a set of blends of epoxy and phenoxy and thermoplastic oligomer where any independent blend has at least 10 weight percent of each of the three candidate third-layer bonding ingredient components.

In various embodiments, the third layer is made of a thermoplastic, a thermoset, or an elastomeric (rubber) material. Non-limiting examples of these materials include: acrylic acid ester rubber/polyacrylate rubber thermoplastic vulcanizate, acrylonitrile-butadiene-styrene, amorphous nylon, cellulosic plastic, ethylene chlorotrifluoroethylene copolymer, epoxy resin, ethylene tetrafluoroethylene copolymer, ethylene acrylic rubber, ethylene acrylic rubber thermoplastic vulcanizate, ethylene-propylene-diamine monomer rubber/polypropylene thermoplastic vulcanizate, tetrafluoroethylene/hexafluoropropylene copolymer, fluoroelastomer, fluoroplastic, hydrogenated nitrile rubber, melamine-formaldehyde resin, tetrafluoroethylene/perfluoromethylvinylether copolymer, natural rubber, nitrile butyl rubber, nylon, nylon 6, nylon 610, nylon 612, nylon 63, nylon 64, nylon 66, perfluoroalkoxy/tetrafluoroethylene copolymer, tetrafluoroethylene/perfluorovinylether copolymer, phenolic resin, polyacetal, polyacrylate, polyamide, polyamide thermoplastic, thermoplastic elastomer, polyamide-imide, polybutene, polybutylene, polycarbonate, polyester, polyester thermoset plastic, polyesteretherketone, polyethylene, polyethylene terephthalate, polyimide, polymethylmethacrylate, polyolefin, polyphenylene sulfide, polypropylene, polystyrene, polysulfone, polytetrafluoroethylene, polyurethane, polyurethane elastomer, polyvinyl chloride, polyvinylidene fluoride, ethylene-propylene-diene rubber/polypropylene thermoplastic vulcanizate, silicone, silicone-thermoplastic vulcanizate, thermoplastic polyurethane, polyurethane elastomer, thermoplastic silicone vulcanizate, tetrafluoroethylene/hexafluoropropylene/vinylidene-fluoride terpolymer, hexafluoropropylene/vinylidene fluoride copolymer, chlorotrifluoroethylene/vinylidene fluoride copolymer, polyamide/polyether thermoplastic block co-polymer elastomer (commercially available, for example, from Atofina under the Pebax® trade name), or polyester/polyether thermoplastic block co-polymer elastomer (commercially available, for example, from DuPont under the Hytrel® trade name). Polymers made of combinations of these are used in a third layer in yet other embodiments.

Examples of heat polymerizable thermoplastic oligomer in the third-layer bonding ingredient of the (homogenous fluoropolymer layer material) adhesive include: acrylonitrile-butadiene-styrene terpolymer, amorphous nylon, cellulosic plastic, ethylene chlorotrifluoroethylene copolymer, epoxy resin, ethylene tetrafluoroethylene copolymer, ethylene acrylic copolymer, ethylene-propylene-diamine terpolymer, tetrafluoroethylene/hexafluoropropylene copolymer, hydrogenated nitrile polymer, melamine-formaldehyde resin, tetrafluoroethylene/perfluoromethylvinylether copolymer, nitrile butyl copolymer, nylon, nylon 6, nylon 610, nylon 612, nylon 63, nylon 64, nylon 66, perfluoroalkoxy/tetrafluoroethylene copolymer, tetrafluoroethylene/perfluorovinylether copolymer, phenolic resin, polyacetal, polyacrylate, polyamide, polyamide thermoplastic, thermoplastic elastomer, polyamide-imide, polybutene, polybutylene, polycarbonate, polyester, polyester thermoset plastic, polyesteretherketone, polyethylene, polyethylene terephthalate, polyimide, polymethylmethacrylate, polyolefin, polyphenylene sulfide, polypropylene, polystyrene, polysulfone, polytetrafluoroethylene, polyurethane, polyurethane elastomer, polyvinyl chloride, polyvinylidene fluoride, ethylene-propylene-diene terpolymer, silicone, polyurethane, tetrafluoroethylene/hexafluoropropylene/vinylidene-fluoride terpolymer, hexafluoropropylene/vinylidene fluoride copolymer, chlorotrifluoroethylene/vinylidene fluoride copolymer, and polyamide/polyether block co-polymer. Selection of specific thermoplastic oligomer in view of the particular third-layer material of the multilayer composite should maximize inter-bonding with the third-layer material. In this regard, for example, a polyamide oligomer is probably best suited for bonding to a third layer made of polyamide, a silicone oligomer is probably best suited for bonding to a third layer made of silicone, and polyethylene oligomer is probably best suited for bonding to a third layer made of polyethylene.

Thermoplastic polymer material in the multiphase composition of the pervious fluoropolymeric layer when the pervious fluoropolymer comprises an FKM-TPV is selected from material with suitable flow characteristics, physical properties, chemical properties, and compatibility with the environment of use. Non-limiting examples include: polyamide, nylon 6, nylon 66, nylon 64, nylon 63, nylon 610, nylon 612, amorphous nylon, polyester, polyethylene terephthalate, polystyrene, polymethyl methacrylate, thermoplastic polyurethane, polybutylene, polyesteretherketone, polyimide, fluoroplastic, polyvinylidene fluoride, polysulfone, polycarbonate, polyphenylene sulfide, polyethylene, polypropylene, polyacetal polymer, polyacetal, perfluoroalkoxy/tetrafluoroethylene copolymer, tetrafluoroethylene/perfluorovinylether copolymer, tetrafluoroethylene/perfluoromethylvinylether copolymer, ethylene/tetrafluoroethylene copolymer, ethylene/chlorotrifluoroethylene copolymer, tetrafluoroethylene/hexafluoropropylene/vinylidene-fluoride terpolymer, tetrafluoroethylene/hexafluoropropylene copolymer, polyester thermoplastic ester, polyester ether copolymer, polyamide ether copolymer, polyamide thermoplastic ester, hexafluoropropylene/vinylidene fluoride copolymer, chlorotrifluoroethylene/vinylidene fluoride copolymer, polyamide/polyether thermoplastic block co-polymer elastomer (commercially available, as previously noted, from Atofina under the Pebax® trade name), polyester/polyether thermoplastic block co-polymer elastomer (commercially available, as previously noted, from DuPont under the Hytrel® trade name), and combinations thereof. Preferred thermoplastics for the multiphase compositions in composites adapted and/or designed for use as high temperature gasket and seals include thermoplastic elastomers with high temperature resistance. Examples of these include aforementioned Pebax® and Hytrel®.

Fluoroelastomer in the pervious fluoropolymeric layer (when the pervious fluoropolymer comprises an FKM-TPV) is selected from material with suitable flow characteristics, physical properties, chemical properties, and compatibility with the environment of use.

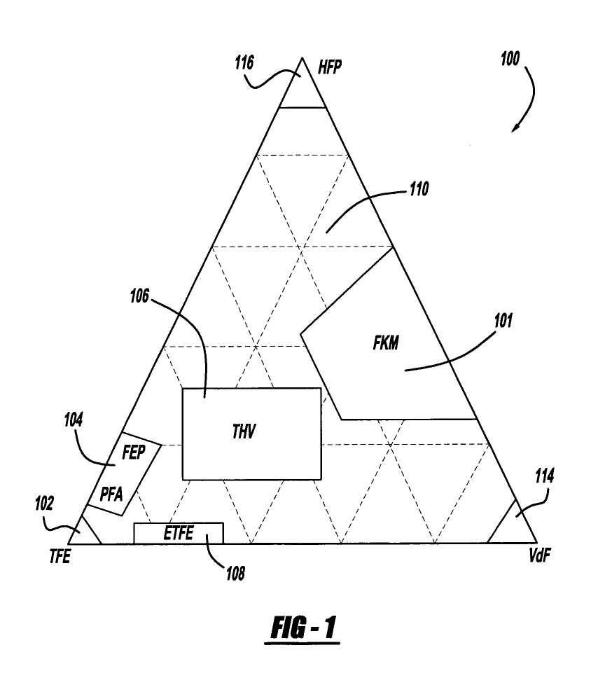

Further detail in the nature of the fluoroelastomer of the amorphous phase of the pervious fluoropolymer is appreciated from a consideration of FIG. 1, ternary composition diagram 100 showing tetrafluoroethylene (TFE), hexfluoropropylene (HFP), and vinylidene fluoride (VdF) weight percentage combinations for making various co-polymer elastomers. Region 101 defines blends of respective tetrafluoroethyl, hexfluoropropyl, and vinylidyl fluoride overall amounts that combine to form fluoroelastomer polymers of the type designated as FKM (for copolymer rubbers based on vinylidene fluoride). Region 104 defines blends of respective tetrafluoroethyl, hexfluoropropyl, and vinylidyl fluoride overall amounts that combine to form perfluoroalkoxy/tetrafluoroethylene copolymer, tetrafluoroethylene/perfluoromethylvinylether copolymer, tetrafluoroethylene/perfluorovinylether copolymer, and tetrafluoroethylene/hexafluoropropylene copolymer. Region 106 defines blends of respective tetrafluoroethyl, hexfluoropropyl, and vinylidyl fluoride overall amounts that combine to form tetrafluoroethylene/hexafluoropropylene/vinylidene fluoride polymers. Region 108 defines blends of respective tetrafluoroethyl, hexfluoropropyl, and vinylidyl fluoride overall amounts that combine to form ethylene tetrafluoroethylene polymers. Region 110 defines blends of respective tetrafluoroethyl, hexfluoropropyl, and vinylidyl fluoride overall amounts that traditionally have not generated useful co-polymers. Region 102 defines blends of respective tetrafluoroethyl, hexfluoropropyl, and vinylidyl fluoride overall amounts that combine to form polytetrafluoroethylene (PTFE) polymers. Region 114 defines blends of respective tetrafluoroethyl, hexfluoropropyl, and vinylidyl fluoride overall amounts that combine to form polyvinylidene fluoride (PVDF) polymers. Region 116 defines blends of respective tetrafluoroethyl, hexfluoropropyl, and vinylidyl fluoride overall amounts that combine to form polyhexfluoropropylene (PHFP) polymers.

Non-limiting examples of specific fluorocarbon elastomers for the amorphous phase of the pervious fluoropolymer when the pervious fluoropolymer layer comprises FKM-TPV include:
(i) vinylidene fluoride/hexafluoropropylene copolymer fluoroelastomer having from about 66 weight percent to about 69 weight percent fluorine and a Mooney viscosity of from about 0 to about 130 ML₁₊₁₀ at 121 degrees Celsius (commercially available, for example, from DuPont under the Viton® trade name in the Viton® A series or from 3M under the Dyneon® trade name in the Dyneon® FE series);
(ii) vinylidene fluoride/perfluorovinylether/tetrafluoroethylene terpolymer fluoroelastomer having at least one cure site monomer and from about 64 weight percent to about 67 weight percent fluorine and a Mooney viscosity of from about 50 to about 100 ML₁₊₁₀ at 121 degrees Celsius (commercially available, for example, from DuPont under the Viton® GLT series or the Viton® GFLT series);
(iii) tetrafluoroethylene/propylene/vinylidene fluoride terpolymer fluoroelastomer having from about 59 weight percent to about 63 weight percent fluorine and a Mooney viscosity of from about 25 to about 45 ML₁₊₁₀ at 121 degrees Celsius (commercially available, for example, from Ashai under the Aflas® trade name in the Aflas® 200 series or from 3M in the Dyneon® BRE series);
(iv) tetrafluoroethylene/ethylene/perfluorovinylether terpolymer fluoroelastomer having at least one cure site monomer and from about 60 weight percent to about 65 weight percent fluorine and a Mooney viscosity of from about 40 to about 80 ML₁₊₁₀ at 121 degrees Celsius (commercially available, for example, from DuPont under the Viton® ETP 900 series or the Viton® ETP 600 series);
(v) vinylidene fluoride/hexafluoropropylene/tetrafluoroethylene terpolymer fluoroelastomer having at least one cure site monomer and from about 66 weight percent to about 72.5 weight percent fluorine and a Mooney viscosity of from about 15 to about 90 ML₁₊₁₀ at 121 degrees Celsius (commercially available, for example, from Solvay under the Technoflon® trade name in the Technoflon® series or from from DuPont under the Viton® B series);
(vi) tetrafluoroethylene/propylene copolymer fluoroelastomer having about 57 weight percent fluorine and a Mooney viscosity of from about 25 to about 115 ML₁₊₁₀ at 121 degrees Celsius (commercially available, for example, from Asahi under the in the Aflas® 100 series or from DuPont under the Viton® TBR series);
(vii) tetrafluoroethylene/hexafluoropropylene/perfluorovinylether/vinylidene fluoride tetrapolymer fluoroelastomer having at least one cure site monomer and from about 59 weight percent to about 64 weight percent fluorine and a Mooney viscosity of from about 30 to about 70 ML₁₊₁₀ at 121 degrees Celsius (commercially available, for example, from 3M under the in the Dyneon® LTFE series);
(viii) tetrafluoroethylene/perfluorovinylether copolymer fluoroelastomer having at least one cure site monomer and from about 69 weight percent to about 71 weight percent fluorine and a Mooney viscosity of from about 60 to about 120 ML₁₊₁₀ at 121 degrees Celsius(commercially available, for example, from DuPont in the Viton® Kalrez series); and
(ix) fluoroelastomer corresponding to the formula
   [-TFE_{q}-HFPᵣ-VdFₛ-]_{d}
where TFE is essentially tetrafluoroethyl, HFP is essentially hexfluoropropyl, VdF is essentially vinylidyl fluoride , and products qd and rd and sd collectively provide proportions of TFE, HFP, and VdF whose values are within element 101 of FIG. 1.

In a preferred embodiment, the thermoplastic polymer material of the multiphase composition of the pervious fluoropolymeric layer is selected from the group consisting of a polymer of vinylidene fluoride (PVDF), a copolymer of vinylidene fluoride—hexafluoropropylene (VdF-HFP copolymer), a copolymer of vinylidene fluoride—chlorotrifluoroethylene (VdF-CTFE copolymer), a copolymer of ethylene—tetrafluoroethylene (ETFE), a copolymer of ethylene—chlorotrifluoroethylene (ECTFE), a terpolymer of tetrafluoroethylene—hexafluoropropylene—vinylidene-fluoride (THV), a copolymer of tetrafluoroethylene (TFE) and hexafluoropropylene (HFP), a copolymer of tetrafluoroethylene (TFE) and perfluoromethylvinylether (PMVE), a copolymer of perfluoroalkoxy (PFA) and tetrafluoroethylene (TFE), and a copolymer of perfluorovinylether (PFVE) and tetrafluoroethylene (TFE); and the fluoroelastomer is selected from the group consisting of a copolymer elastomer of hexafluoropropylene (HFP)—vinylidene fluoride (VdF), a terpolymer elastomer of tetrafluoroethylene (TFE)—hexafluoropropylene (HFP)—vinylidene fluoride (VdF), a copolymer elastomer of tetrafluoroethylene (TFE)—C₂₋₄ olefin, and a terpolymer elastomer of tetrafluoroethylene (TFE)—C₂₋₄ olefin—vinylidene fluoride (VdF). Most preferably the continuous thermoplastic phase comprises fluoroplastic selected from the group consisting of polyvinylidene fluoride having a melt flow index from about 5 to about 40, and ethylene-tetrafluoroethylene copolymer having a having a melt flow index from about 5 to about 40.

In one embodiment, a multiphase composition for the pervious fluoropolymeric layer in this description is made by dynamic vulcanization where curable fluoroelastomer vulcanizate is cured, or vulcanized, in the presence of the thermoplastic under conditions of high shear at a temperature above the melting point of the thermoplastic component. In an exemplary process, an appropriate curative or curative system is added to a blend of thermoplastic material and fluoroelastomeric material (such as uncured fluoroelastomer), and the mixture is heated at a temperature and for a time sufficient to effect vulcanization of the uncured fluoroelastomeric material in the presence of the thermoplastic material. Mechanical energy is applied to the mixture of fluoroelastomeric material, curative agent and thermoplastic material during the heating step. Thus dynamic vulcanization provides for mixing the fluoroelastomer and thermoplastic components in the presence of a curative agent and heating during the mixing to effect cure (cross-linking; vulcanization) of the fluoroelastomeric component. Alternatively, the uncured fluoroelastomeric material and thermoplastic material may be mixed for a time and at a shear rate sufficient to form a dispersion of the fluoroelastomeric material in a continuous thermoplastic phase. Thereafter, a curative agent may be added to the dispersion of uncured fluoroelastomeric material and thermoplastic material while continuing the mixing. Finally, the dispersion is heated while continuing to mix to produce the processable multiphase composition for the pervious fluoropolymeric layer of this description.

Fluoroelastomer is thus simultaneously crosslinked and dispersed as particles or portions within the thermoplastic matrix in making the material for the pervious fluoropolymeric layer. In various embodiments, dynamic vulcanization is effected by mixing the fluoroelastomeric and thermoplastic components at elevated temperature in the presence of a curative in conventional mixing equipment such as roll mills, Moriyama mixers, Banbury mixers, Brabender mixers, continuous mixers, mixing extruders such as single and twin-screw extruders, and the like. An advantageous characteristic of dynamically cured compositions is that, notwithstanding the fact that the fluoroelastomeric component is fully cured, the compositions can be processed and reprocessed into the pervious fluoropolymeric layer by conventional plastic processing techniques such as extrusion, injection molding and compression molding. Scrap or flashing can be salvaged and reprocessed.

Heating and mixing or mastication at vulcanization temperatures are generally adequate to complete the vulcanization reaction in a few minutes or less, but if shorter vulcanization times are desired, higher temperatures and/or higher shear may be used. A suitable range of vulcanization temperature is from about the melting temperature of the thermoplastic material (typically 120° C.) to about 300° C. or more. Typically, the range is from about 150° C. to about 250° C. A preferred range of vulcanization temperatures is from about 180° C. to about 220° C. It is preferred that mixing continues without interruption until vulcanization occurs or is complete.

If appreciable curing is allowed after mixing has stopped, an unprocessable thermoplastic vulcanizate may be obtained. In this case, a kind of post curing step may be carried out to complete the curing process. In some embodiments, the post curing takes the form of continuing to mix the fluoroelastomer and thermoplastic during a cool-down period.

Curing systems for fluorocarbon elastomers are well known. In a radical system, a free radical on the fluorocarbon elastomer is induced by reaction with a radical agent such as an organic peroxide compound. Then the fluorocarbon elastomer is cross-linked by the reaction of a crosslinking co-agent with the induced free radical. Alternatively, the fluorocarbon elastomer is dynamically vulcanized with a phenolic curing agent blended into the initial blend of thermoplastic and uncured fluoroelastomer, with a peroxide curing agent blended into the initial blend of thermoplastic and uncured fluoroelastomer, or with both a phenolic agent and a peroxide agent multi-curing process.

As previously noted, uncured fluoroelastomer copolymers prepared for dynamic vulcanization preferably contain relatively minor amounts of cure site monomers (CSM), discussed further below. The presence of cure site monomers in an elastomer tends to increase the rate at which the elastomer can be cured by peroxides. Preferred copolymer fluorocarbon elastomers include VdF/HFP, VdF/HFP/CSM, VdF/HFP/TFE, VdF/HFP/TFE/CSM, VdF/PFVE/TFE/CSM, TFE/Pr, TFE/Pr/VdF, TFE/Et/PFVE/VdF/CSM, TFE/Et/PFVE/CSM and TFE/PFVE/CSM. The elastomer designation gives the monomers from which the elastomer gums are synthesized. In various embodiments, the elastomer gums have viscosities that give a Mooney viscosity in the range generally of 15-160 (ML1+10, large rotor at 121° C.), which can be selected for a combination of flow and physical properties. Elastomer suppliers include Dyneon (3M), Asahi Glass Fluoropolymers, Solvay/Ausimont, Dupont, and Daikin.

The cure site monomers are preferably selected from the group consisting of brominated, chlorinated, and iodinated olefins; brominated, chlorinated, and iodinated unsaturated ethers; and non-conjugated dienes. Halogenated cure sites may be copolymerized cure site monomers or halogen atoms that are present at terminal positions of the fluoroelastomer polymer chain. The cure site monomers, reactive double bonds or halogenated end groups are capable of reacting to form crosslinks, especially under conditions of catalysis or initiation by the action of peroxides.

Other cure monomers may be used that introduce low levels, preferably less than or equal about 5 mole %, more preferably less than or equal about 3 mole %, of functional groups such as epoxy, carboxylic acid, carboxylic acid halide, carboxylic ester, carboxylate salts, sulfonic acid groups, sulfonic acid alkyl esters, and sulfonic acid salts. Such monomers and cure are described for example in Kamiya et al., U.S. Pat. No. 5,354,811.

Fluorocarbon elastomers based on cure site monomers are commercially available. Non-limiting examples include Viton GF, GLT-305, GLT-505, GBL-200, and GBL-900 grades from DuPont. Others include the G-900 and LT series from Daikin, the FX series and the RE series from NOK, and Tecnoflon P457 and P757 from Solvay.

A wide variety of fluorocarbon elastomers may be crosslinked or cured by a combination of a peroxide curative agent and a crosslinking co-agent. Generally, elastomers are subject to peroxide crosslinking if they contain bonds, either in the side chain or in the main chain, other than carbon fluorine bonds. For example, the peroxide curative agent may react with a carbon hydrogen bond to produce a free radical that can be further crosslinked by reaction with the crosslinking co-agent. In a preferred embodiment, peroxide curable elastomers are those that contain cure site monomers described above. The cure site monomers introduce functional groups—such as carbon bromine bonds, carbon iodine bonds, or double bonds—that serve as a site of attack by the peroxide curative agent. The kinetics of the peroxide cure are affected by the presence and nature of any cure site monomers present in the fluorocarbon elastomers. As a rule, the curing of an elastomer containing a cure site monomer is significantly faster than that of elastomers without cure site monomers.

Preferred peroxide curative agents are organic peroxides, for example, dialkyl peroxides. In general, an organic peroxide compound may be selected to function as a curing agent for the composition in the presence of the other ingredients and under the temperatures to be used in the curing operation without causing any harmful amount of curing during mixing or other operations which are to precede the curing operation. A dialkyl peroxide which decomposes at a temperature above 49° C. is especially preferred when the composition is to be subjected to processing at elevated temperatures before it is cured. In many cases one will prefer to use a di-tertiarybutyl peroxide having a tertiary carbon atom attached to a peroxy oxygen. Non-limiting examples include 2,5-dimethyl-2,5-di(tert-butylperoxy)-3-hexyne; 2,5-dimethyl-2,5-di(tert-butylperoxy) hexane; and 1,3-bis-(t-butylperoxyisopropyl)benzene. Other non-limiting examples of peroxide curative agent include dicumyl peroxide, dibenzoyl peroxide, tertiary butyl perbenzoate, di[1,3-dimethyl-3-(t-butylperoxy)butyl]carbonate, and the like.

One or more crosslinking co-agents may be combined with the peroxide. Examples include triallyl cyanurate; triallyl isocyanurate; tri(methallyl)-isocyanurate; tris(diallylamine)-s-triazine, triallyl phosphite; N,N-diallyl acrylamide; hexaallyl phosphoramide; N,N,N′,N′-tetraallyl terephthalamide; N,N,N′,N′-tetraallyl malonamide; trivinyl isocyanurate; 2,4,6-trivinyl methyltrisiloxane; and tri(5-norbornene-2-methylene) cyanurate.

Another group of fluorocarbon elastomers is curable by the action of various polyols. Curing with the polyol crosslinking agents is also referred to as phenol cure (phenolic cure) because phenols are commonly used polyols for the purpose. Many of the fluorocarbon elastomers that can be cured with polyols can also be cured with peroxides. The curability with either of the curing systems, and the relative rates of cure, depend on conditions during the dynamic vulcanization described below.

Phenol or polyol curative systems for fluorocarbon elastomers contain onium salts and one or more polyol crosslinking agents. In addition, crosslinking by phenol and polyol agents is accelerated by the presence in mixtures of phenol curing accelerators or curing stabilizers. Commonly used curing accelerators include acid acceptor compounds such as oxides and hydroxides of divalent metals. Non-limiting examples include calcium hydroxide, magnesium oxide, calcium oxide, and zinc oxide. In many embodiments, the rate of cure by phenol curing agents is significantly reduced when the acid acceptor compounds are not present in mixtures being dynamically vulcanized. In other words, even though a commercial embodiment may contain a phenol curable elastomer and a phenol and onium curing agent incorporated into the elastomer, the rate of phenol cure will nevertheless be very slow or nonexistent if the mixture contains no added acid acceptor compounds.

After dynamic vulcanization, a highly uniform mixture is obtained, wherein the cured fluoroelastomer is in the form of small dispersed portions (particles) having independent diameters of from about 0.1 microns to about 100 microns. In this regard, the portions preferably essentially have an average particle (or portion) size smaller than about 50 microns, preferably of an average particle size smaller than about 25 microns, more preferably of an average size smaller than about 10 microns or less, and still more preferably of an average particle size of 5 microns or less.

The progress of the vulcanization may be monitored through periodic measurement of the mixing torque or the mixing energy required by the mixing process. The mixing torque or mixing energy curve generally goes through a maximum after which mixing can be continued somewhat longer to improve the fabricability of the blend. If desired, one can add additional ingredients, such as the stabilizer package, after the dynamic vulcanization is complete. The stabilizer package is preferably added to the thermoplastic vulcanizate after vulcanization has been essentially completed, i.e., the curative has been essentially consumed.

The processable multiphase compositions for use in the pervious fluoropolymer layer of this description may be manufactured in a batch process or a continuous process.

In a batch process, predetermined charges of fluoroelastomeric material, thermoplastic material and curative agents are added to a mixing apparatus. In a typical batch procedure, the fluoroelastomeric material and thermoplastic material are first mixed, blended, masticated or otherwise physically combined until a desired particle size of fluoroelastomeric material is provided in a continuous phase of thermoplastic material. When the structure of the fluoroelastomeric material is as desired, a curative agent may be added while continuing to apply mechanical energy to mix the fluoroelastomeric material and thermoplastic material. Curing is effected by heating or continuing to heat the mixing combination of thermoplastic and fluoroelastomeric material in the presence of the curative agent. When cure is complete, the processable multiphase composition may be removed from the reaction vessel (mixing chamber) for further processing.

It is preferred to mix the fluoroelastomeric material and thermoplastic material at a temperature where the thermoplastic material softens and flows. If such a temperature is below that at which the curative agent is activated, the curative agent may be a part of the mixture during the initial particle dispersion step of the batch process. In some embodiments, a curative is combined with the fluoroelastomeric and thermoplastic polymeric material at a temperature below the curing temperature. When the desired dispersion is achieved, the temperature may be increased to effect cure. In one embodiment, commercially available fluoroelastomeric materials are used that contain a curative pre-formulated into the fluoroelastomer. However, if the curative agent is activated at the temperature of initial mixing, it is preferred to leave out the curative until the desired particle size distribution of the fluoroelastomeric material in the thermoplastic matrix is achieved. In another embodiment, curative is added after the fluoroelastomeric and thermoplastic materials are mixed. Thereafter, in a preferred embodiment, the curative agent is added to a mixture of fluoroelastomeric particles in thermoplastic material while the entire mixture continues to be mechanically stirred, agitated or otherwise mixed.

Continuous processes may also be used to prepare fluoroelastomer-containing multiphase pervious fluoropolymer layer materials of this description. In a preferred embodiment, a twin screw extruder apparatus, either co-rotation or counter-rotation screw type is provided with ports for material addition and reaction chambers made up of modular components of the twin screw apparatus. In a typical continuous procedure, thermoplastic material and fluoroelastomeric material are combined together by inserting them into the screw extruder together in a first hopper using a feeder (loss-in-weight or volumetric feeder). Temperature and screw parameters may be adjusted to provide a proper temperature and shear to effect desired mixing and to achieve particle size distribution of an uncured fluoroelastomeric component in a thermoplastic polymer material matrix. Mixing duration may be controlled either by adjusting the length of the extrusion apparatus and/or by controlling the speed of screw rotation for the mixture of fluoroelastomeric material and thermoplastic material during the mixing phase. The degree of mixing may also be controlled by the mixing screw element configuration in the screw shaft, such as intensive, medium or mild screw designs. Then, at a downstream port, by using a side feeder (loss-in-weight or volumetric feeder), the curative agent may be added continuously to the mixture of thermoplastic material and fluoroelastomeric material as it continues to travel down the twin screw extrusion pathway. Downstream of the curative additive port, the mixing parameters and transit time may be varied as described above. By adjusting the shear rate, temperature, duration of mixing, mixing screw element configuration, as well as the time of adding the curative agent, processable multiphase composition compositions of this description may be made in a continuous process. As in the batch process, the fluoroelastomeric material may be commercially formulated to contain a curative agent, generally a phenol or phenol resin curative.

Fluoroelastomer-containing pervious fluoropolymer compositions and layers of this description will contain a sufficient amount of vulcanized fluoroelastomeric material (“rubber”) to form a rubbery composition of matter; that is, they will exhibit a desirable combination of flexibility, softness, and compression set. Preferably, the pervious fluoropolymer compositions should comprise from about 30 to about 85 weight percent of the fluoroelastomeric amorphous phase, preferably at least about 35 parts by weight fluoroelastomer, even more preferably at least about 45 parts by weight fluoroelastomer, and still more preferably at least about 50 parts by weight fluoroelastomer vulcanizate per 100 parts by weight of the fluoroelastomer vulcanizate and thermoplastic polymer combined. More specifically, the amount of cured fluoroelastomer vulcanizate within the thermoplastic vulcanizate is generally from about 30 to about 95 percent by weight, preferably from about 35 to about 85 percent by weight, and more preferably from about 50 to about 80 percent by weight of the total weight of the fluoroelastomer vulcanizate and the thermoplastic polymer combined.

The amount of thermoplastic polymer within fluoroelastomer-containing multiphase pervious fluoropolymer layer materials is generally from about 15 to about 70 percent by weight, preferably from about 15 to about 65 percent by weight and more preferably from about 20 to about 50 percent by weight of the total weight of the fluoroelastomer vulcanizate and the thermoplastic combined.

As noted above, one embodiment of a composite has a pervious fluoropolymeric layer derived from a processable multiphase composition including a cured fluoroelastomer vulcanizate and a thermoplastic polymer. Preferably, the thermoplastic vulcanizate itself is a homogeneous mixture wherein the fluoroelastomer vulcanizate is in the form of finely divided and well-dispersed fluoroelastomer vulcanizate particles of less than 10 microns within a non-vulcanized matrix. It should be understood, however, that the thermoplastic vulcanizates of the this description are not limited to those containing discrete phases inasmuch as pervious fluoropolymer layer compositions may also include other morphologies such as co-continuous morphologies.

The term vulcanized or cured fluoroelastomer vulcanizate refers to a synthetic fluoroelastomer vulcanizate that has undergone at least a partial cure. The degree of cure can be measured in one method by determining the amount of fluoroelastomer vulcanizate that is extractable from the thermoplastic vulcanizate by using boiling xylene or cyclohexane as an extractant. This method is disclosed in U.S. Pat. No. 4,311,628. By using this method as a basis, the cured fluoroelastomer vulcanizate of this description will have a degree of cure where not more than 15 percent of the fluoroelastomer vulcanizate is extractable, preferably not more than 10 percent of the fluoroelastomer vulcanizate is extractable, and more preferably not more than 5 percent of the fluoroelastomer vulcanizate is extractable. In an especially preferred embodiment, the fluoroelastomer is technologically fully vulcanized. The term fully vulcanized refers to a state of cure such that the fluoroelastomer crosslink density is at least 7×10⁻⁵ moles per ml or such that the fluoroelastomer is less than about three percent extractable by cyclohexane at 23° C.

The degree of cure can be determined by the cross-link density of the rubber. This, however, must be determined indirectly because the presence of the thermoplastic polymer interferes with the determination. Accordingly, the same fluoroelastomer vulcanizate as present in the blend is treated under conditions with respect to time, temperature, and amount of curative that result in a fully cured product as demonstrated by its cross-link density. This cross-link density is then assigned to the blend similarly treated. In general, a cross-link density of about 7×10⁻⁵ or more moles per milliliter of fluoroelastomer vulcanizate is representative of the values reported for fully cured fluoroelastomeric copolymers. Accordingly, it is preferred that the pervious fluoropolymer layer is vulcanized to an extent that corresponds to vulcanizing the same fluoroelastomer vulcanizate as in the blend statically cured under pressure in a mold with such amounts of the same curative as in the blend and under such conditions of time and temperature to give a cross-link density greater than about 7×10⁻⁵ moles per milliliter of fluoroelastomer vulcanizate and preferably greater than about 1×10⁻⁴ moles per milliliter of rubber.

A previously described fluoroelastomer gum and thermoplastic mixture is used for the pervious fluoropolymeric layer in some embodiments as formulated, without further curing. In alternative embodiments, a derived material in the pervious fluoropolymer layer is achieved by curing a previously described fluoroelastomer gum and thermoplastic mixture to modify the fluoroelastomer gum phase into vulcanized fluoroelastomer and provide thereby the amorphous phase of the multiphase composition in the pervious fluoropolymeric layer. In some embodiments, the curing is achieved by mixing a curing agent into the fluoroelastomer gum and thermoplastic mixture just prior to molding the fluoroelastomer gum mixture into the pervious fluoropolymeric layer of a desired article. In this regard, a curing agent of any of a bisphenol, peroxide, polyol, phenol, amine, or combinations thereof is mixed into the uncured fluoroelastomer (fluoroelastomer gum).

In a multi-curing process, the uncured fluoroelastomer is prepared with appropriate cure site monomers for both phenol curing and peroxide curing. In one embodiment, phenolic curing agent is added to the initial blend of thermoplastic and uncured fluoroelastomer and the blend is dynamically vulcanized until a first stage of curing has been achieved. Peroxide curing agent is then added to the initial blend of thermoplastic and uncured fluoroelastomer and the blend is further dynamically vulcanized until full curing has been achieved. When a curing agent combination or curative system (such as, without limitation, a phenol and a peroxide curing agent) for multi-curing the uncured fluoroelastomer into vulcanized fluoroelastomer is used, the curing agent combination is introduced into the thermoplastic and uncured fluoroelastomer in one embodiment as a blend of the differentiated curing agents; in an alternative embodiment, the curing agent combination is introduced into the thermoplastic and uncured fluoroelastomer in a plurality of stages.

In embodiments with uncured fluoroelastomer, one method for making the multiphase composition of the pervious fluoropolymeric layer is to mix the uncured (gum) fluoroelastomer component and the thermoplastic polymer with a conventional mixing system such as a batch polymer mixer, a roll mill, a continuous mixer, a single-screw mixing extruder, a twin-screw extruder mixing extruder, and the like until the uncured fluoroelastomer has been fully mixed and the uncured fluoroelastomeric amorphous phase portions (particles) have independent diameters (or independent maximum cross sectional diameters) of from about 0.1 microns to about 100 microns in the thermoplastic phase. In one embodiment, the multiphase composition is derived from mixing uncured fluoroelastomer into the thermoplastic to provide from about 30 to about 95 weight percent of fluoroelastomer in the multiphase composition, and the uncured fluoroelastomer is mixed to provide a co-continuous polymer matrix multiphase composition having independent uncured fluoroelastomer portion cross-sectional maximum diameters (phase cross-sectional thickness dimensions as measured at various locations in the co-continuous polymer matrix multiphase composition) of from about 0.1 microns to about 100 microns.

Mixing of different polymeric phases is controlled by relative viscosity between two initial polymeric fluids (where the first polymeric fluid has a first viscosity and the second polymeric fluid has a second viscosity). The phases are differentiated during admixing of the admixture from the two initial polymeric fluids. In this regard, the phase having the lower viscosity of the two phases will generally encapsulate the phase having the higher viscosity. The lower viscosity phase will therefore usually become the continuous phase in the admixture, and the higher viscosity phase will become the dispersed phase. When the viscosities are essentially equal, the two phases will form a co-continuous phase matrix or polymer system (also denoted as an interpenetrated structure) of polymer chains and/or minutely dimensioned polymeric portions. Accordingly, in general dependence upon the relative viscosities of the mixed fluoroelastomer and thermoplastic, several embodiments of mixed compositions derive from the general mixing approach. Preferably, each of the vulcanized, partially vulcanized, or gum elastomeric dispersed portions in a polymeric admixture has a cross-sectional diameter from about 0.1 microns to about 100 microns. For essentially spherical particles, this corresponds to the diameter of the spheres, while for filamentary particles it is the diameter of the cross sectional area of the filament. In another embodiment, the fluoroelastomeric and thermoplastic components are intermixed at elevated temperature in the presence of an additive package in conventional mixing equipment as noted above. Electrically conductive particulate and/or filler (including, for example, heat conductive filler), if used and as further discussed herein, are then mixed into the polymeric blend until fully dispersed to yield an electrically conductive material and/or filler-enhanced multiphase composition for the pervious fluoropolymeric layer. In one embodiment, the uncured fluoroelastomer component and the thermoplastic polymer and the optional conductive (and optional filler) particulate are simultaneously mixed with a conventional mixing system such as a roll mill, continuous mixer, a single-screw mixing extruder, a twin-screw extruder mixing extruder, and the like until the filler and/or conductive material has been fully mixed.

In a preferred embodiment, plasticizers, extender oils, synthetic processing oils, or combinations thereof may be also used in any of the polymers used for composite layers in this description. Respective to the multiphase composition of the pervious fluoropolymeric layer, the type of processing oil selected will typically be consistent with that ordinarily used in conjunction with the specific fluoroelastomer vulcanizate present in the multiphase composition. The extender oils may include, but are not limited to, aromatic, naphthenic, and paraffinic extender oils. Preferred synthetic processing oils include polylinear-olefins. The extender oils may also include organic esters, alkyl ethers, or combinations thereof. As disclosed in U.S. Pat. No. 5,397,832, it has been found that the addition of certain low to medium molecular weight organic esters and alkyl ether esters to the pervious fluoropolymeric layer compositions of this description lowers the T_{g} in polyolefin and fluoroelastomer vulcanizate components, and improves the low temperatures properties of the overall pervious fluoropolymeric layer, particularly flexibility and strength. These organic esters and alkyl ether esters generally have a molecular weight that is generally less than about 10,000. Particularly suitable esters include monomeric and oligomeric materials having an average molecular weight below about 2000, and preferably below about 600. In one embodiment, the esters may be either aliphatic mono- or diesters or alternatively oligomeric aliphatic esters or alkyl ether esters.

In addition to the fluoroelastomeric material, the thermoplastic polymeric material, and curative, the processable multiphase fluoropolymer for the pervious fluoropolymeric layer in composites of this description may include other additives such as stabilizers processing aids, curing accelerators, fillers, pigments, adhesives, tackifiers, and waxes. The properties of the fluoropolymer of the pervious fluoropolymer layer may be modified, either before or after vulcanization, by the addition of ingredients that are conventional in the compounding of rubber, thermoplastics, and blends thereof.

A wide variety of processing aids may be used, including plasticizers and mold release agents. Non-limiting examples of processing aids include Caranuba wax, phthalate ester plasticizers such as dioctylphthalate (DOP) and dibutylphthalate silicate (DBS), fatty acid salts such zinc stearate and sodium stearate, polyethylene wax, and keramide. In some embodiments, high temperature processing aids are preferred. Such include, without limitation, linear fatty alcohols such as blends of C₁₀-C₂₈ alcohols, organosilicones, and functionalized perfluoropolyethers. In some embodiments, the fluoropolymer for the pervious fluoropolymeric layer contains about 1 to about 15% by weight processing aids, preferably about 5 to about 10% by weight.

Acid acceptor compounds are commonly used as curing accelerators or curing stabilizers. Preferred acid acceptor compounds include oxides and hydroxides of divalent metals. Non-limiting examples include Ca (OH)₂, MgO, CaO, and ZnO.

In one embodiment, filler (particulate material contributing to the performance properties of the compounded elastomer gum mixture respective to such properties as, without limitation, bulk, weight, thermal conductivity, electrical conductivity, and/or viscosity while being essentially chemically inert or essentially reactively insignificant respective to chemical reactions within the compounded polymer) is also mixed into the formulation of the fluoropolymer for the pervious fluoropolymeric layer. The filler particulate is any material such as, without limitation, fiberglass, ceramic, or glass microspheres preferably having a mean particle size from about 5 to about 120 microns; carbon nanotubes; or other non-limiting examples of fillers including both organic and inorganic fillers such as, barium sulfate, zinc sulfide, carbon black, silica, titanium dioxide, clay, talc, fiber glass, fumed silica and discontinuous fibers such as mineral fibers, wood cellulose fibers, carbon fiber, boron fiber, and aramid fiber (Kevlar); and other ground materials such as ground rubber particulate, or polytetrafluoroethylene particulate having a mean particle size from about 5 to about 50 microns; Some non-limiting examples of processing additives include stearic acid and lauric acid. The addition of carbon black, extender oil, or both, preferably prior to dynamic vulcanization, is particularly preferred. Non-limiting examples of carbon black fillers include SAF black, HAF black, SRP black and Austin black. Carbon black improves the tensile strength, and an extender oil can improve processability, the resistance to oil swell, heat stability, hysteresis-related properties, cost, and permanent set. In a preferred embodiment, fillers such as carbon black may make up to about 40% by weight of the total weight of the fluoropolymer for the pervious fluoropolymeric layer. Preferably, the fluoropolymer for the pervious fluoropolymeric layer comprises 1-40 weight percent of filler. In other embodiments, the filler makes up 10 to 25 weight percent of the fluoropolymer for the pervious fluoropolymeric layer.

Electrically conductive filler is used in the pervious fluoropolymeric layer of some composite embodiments such as, for example and without limitation, a fuel hose composite having the pervious fluoropolymeric layer as the inside layer of the fuel hose. In this regard, thermoset plastic materials, thermoplastic plastic materials, elastomeric materials, thermoplastic elastomer materials, and thermoplastic vulcanizate materials generally are not considered to be electrically conductive. As such, electrical charge buildup on a surface of an article (such as, in non-limiting example, a fuel line) made of these materials can occur to provide a “static charge” on the surface when a hydrocarbon fuel flows through the article. When discharge of the charge buildup occurs to an electrically conductive material proximate to such a charged surface, an electrical spark manifests the essentially instantaneous current flowing between the charged surface and the electrical conductor. Such a spark can be hazardous if the article is in service in applications or environments where flammable or explosive materials are present. Rapid discharge of static electricity can also damage some items (for example, without limitation, microelectronic articles) as critical electrical insulation is subjected to an instantaneous surge of electrical energy. Grounded articles made of materials having an electrical resistivity of less than about of 1×10⁻³ Ohm-m at 20 degrees Celsius are generally desired to avoid electrical charge buildup. Accordingly, in one embodiment of a material for a fuel hose embodiment, a dispersed phase of conductive particulate is provided in a fluoropolymer material to provide an electrically conductive fluoropolymer for the pervious fluoropolymer layer having an post-cured electrical resistivity of less than about of 1×10⁻³ Ohm-m at 20 degrees Celsius. This dispersed phase is made of a plurality of conductive particles dispersed in a continuous polymeric phase of fluoropolymer. In this regard, when, in some embodiments, the continuous polymeric phase of fluoropolymer is itself a multi-polymeric-phase polymer blend and/or mixture, the dispersed phase of conductive particles are preferably dispersed throughout the various polymeric phases without specificity to any one of the polymeric phases in the multi-polymeric-phase fluoropolymer for the pervious fluoropolymeric layer. Further details in this regard are described in U.S. patent application Ser. No. 10/983,947 filed on Nov. 8, 2004 and entitled FUEL HOSE WITH A FLUOROPOLYMER INNER LAYER incorporated by reference herein.

The conductive particles used in alternative embodiments of electrically conductive polymeric materials for electrically conductive fluoropolymer for the pervious fluoropolymeric layer such as (without limitation) fuel hose embodiments include conductive carbon black, conductive carbon fiber, conductive carbon nanotubes, conductive graphite powder, conductive graphite fiber, bronze powder, bronze fiber, steel powder, steel fiber, iron powder, iron fiber, copper powder, copper fiber, silver powder, silver fiber, aluminum powder, aluminum fiber, nickel powder, nickel fiber, wolfram powder, wolfram fiber, gold powder, gold fiber, copper-manganese alloy powder, copper-manganese fiber, and combinations thereof.

In an alternative embodiment, a heat conductive particulate is dispersed in the pervious fluoropolymeric layer in the same general manner as electrically conductive particulate but at a concentration appropriate to achieve a desired heat transfer rate for an intended application. The heat conductive particles used in alternative embodiments include bronze powder, bronze fiber, steel powder, steel fiber, iron powder, iron fiber, copper powder, copper fiber, silver powder, silver fiber, aluminum powder, aluminum fiber, nickel powder, nickel fiber, wolfram powder, wolfram fiber, gold powder, gold fiber, copper-manganese alloy powder, copper-manganese fiber, and combinations thereof.

The pervious fluoropolymeric layer is cohered to a third layer with the adhesive layer (the melt-bonded layer) of homogenous fluoropolymer. In one embodiment, curing of the melt-bonded layer is augmented after composite precursor assembly and during final curing of the precursor composite into the final composite by use of irradiation. A number of considerations in this process are further described in U.S. patent application Ser. No. 10/881,677 filed on Jun. 30, 2004 (published on Jan. 5, 2006 as United States Patent Application 20060003127) and entitled ELECTRON BEAM CURING IN A COMPOSITE HAVING A FLOW RESISTANT ADHESIVE LAYER incorporated by reference herein.

In various alternative embodiments, the homogenous fluoropolymer of the melt-bonded adhesive layer comprises fluoroplastic of any of ethylene/chlorotrifluoroethylene copolymer, ethylene/tetrafluoroethylene copolymer, tetrafluoroethylene/hexafluoropropylene copolymer, tetrafluoroethylene/perfluoromethylvinylether copolymer, tetrafluoroethylene/perfluorovinylether copolymer, perfluoroalkoxy/tetrafluoroethylene copolymer, hexafluoropropylene/vinylidene-fluoride copolymer, hexafluoropropylene/chlorotrifluoroethylene copolymer, hexafluoropropylene/vinylidene fluoride copolymer, chlorotrifluoroethylene/vinylidene fluoride copolymer, tetrafluoroethylene/hexafluoropropylene/vinylidene-fluoride terpolymer, polyvinylidene-fluoride, and combinations thereof.

In various alternative embodiments, the adhesive (melt-bonded) layer comprises liquid fluoroelastomer (solution fluoroelastomer, FKM emulsion latex, or uncured fluoroelastomer that is liquid at room temperature without benefit of solvent or water) when the composite precursor (the composite prior to curing of the melt-bonded layer) is assembled. In one embodiment, the liquid fluoroelastomer can be any fluoroelastomer that is liquid at room temperature that, upon curing, will yield any previously-described fluoroelastomer of the amorphous phase of the pervious fluoropolymer. In an alternative embodiment, the liquid fluoroelastomer may comprise any fluoroelastomer latex (where the latex comprises, in one embodiment, fully cured FKM elastomer; or, in an alternative embodiment, uncured FKM elastomer) that, upon curing and/or drying, will yield any previously-described fluoroelastomer of the amorphous phase of the pervious fluoropolymer. In another embodiment, the liquid fluoroelastomer may comprise any solution fluoroelastomer (where the solution fluoroelastomer comprises, in one embodiment, fully cured FKM elastomer; or, in an alternative embodiment, uncured FKM elastomer) that, upon curing and/or drying, will yield any previously-described fluoroelastomer of the amorphous phase of the pervious fluoropolymer. In this regard, as previously discussed, the homogenous fluoropolymer has fluorinated molecules derived from at least one monomer unit stoichiometrically identical to a monomer unit from which the fluorinated molecules of the pervious fluoropolymer are derived (in other words, polymer chains in the pervious fluoropolymer and polymer chains in the homogenous fluoropolymer are derived from monomer units of identical stoichiometric formula). As also previously discussed, the homogenous fluoropolymer also comprises fluoroelastomer-curing agent (usually a peroxide, bisphenol, polyol, phenol, amine, or combinations of these) at the time of application to the fluoropolymer of the pervious fluoropolymer layer if the pervious fluoropolymer of the pervious fluoropolymer layer contains fluoroelastomer and/or if the homogenous fluoropolymer contains fluoroelastomer. Preferably, the fluoroelastomer-curing agent is appropriate for curing fluoroelastomer in both the pervious fluoropolymer and the homogenous fluoropolymer when both of these layers contain fluoroelastomer. Further in this regard, the fluoroelastomer-curing agent is optimal for reacting with cure site monomers of both the pervious fluoropolymer and the homogenous fluoropolymer.

As noted above, for irradiated composite embodiments where radiation is used to etch polytetrafluoroethylene pervious fluoropolymer as previously described or where radiation is used as a part of the final curing of the precursor composite into the cured composite, radiation is provided from several alternative radiation sources: any of ultraviolet radiation, infrared radiation, ionizing radiation, electron beam radiation, x-ray radiation, an irradiating plasma, a discharging corona, and combinations of these. A preferred approach is to use electron beam radiation (preferably of from about 0.1 MeRAD to about 40 MeRAD and, more preferably, from about 5 MeRAD to about 20 MeRAD). Electron beam processing is usually effected with an electron accelerator. Individual accelerators are usefully characterized by their energy, power, and type. Low-energy accelerators provide beam energies from about 150 keV to about 2.0 MeV. Medium-energy accelerators provide beam energies from about 2.5 to about 8.0 MeV. High-energy accelerators provide beam energies greater than about 9.0 MeV. Accelerator power is a product of electron energy and beam current. Such powers range from about 5 to about 300 kW. The main types of accelerators are: electrostatic direct-current (DC), electrodynamic DC, radiofrequency (RF) linear accelerators (LINACS), magnetic-induction LINACs, and continuous-wave (CW) machines.

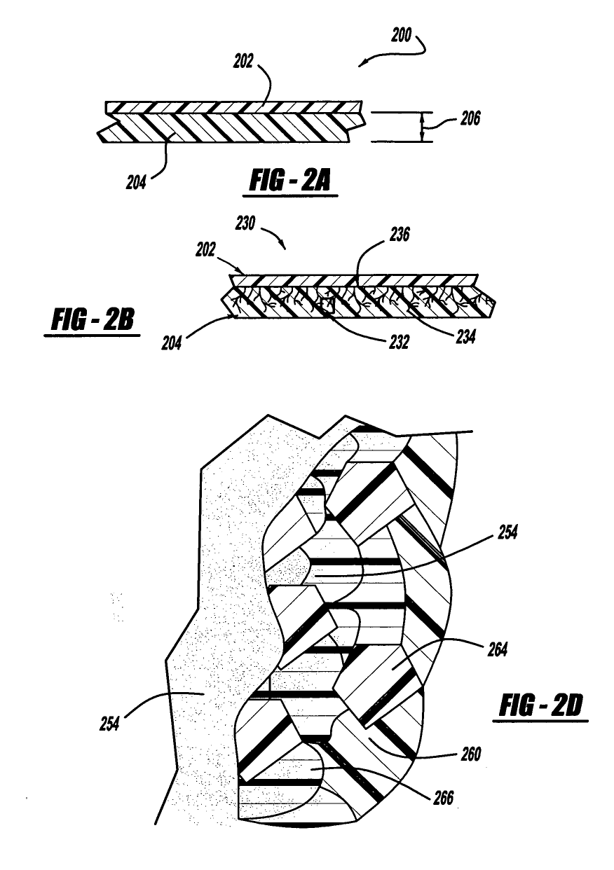

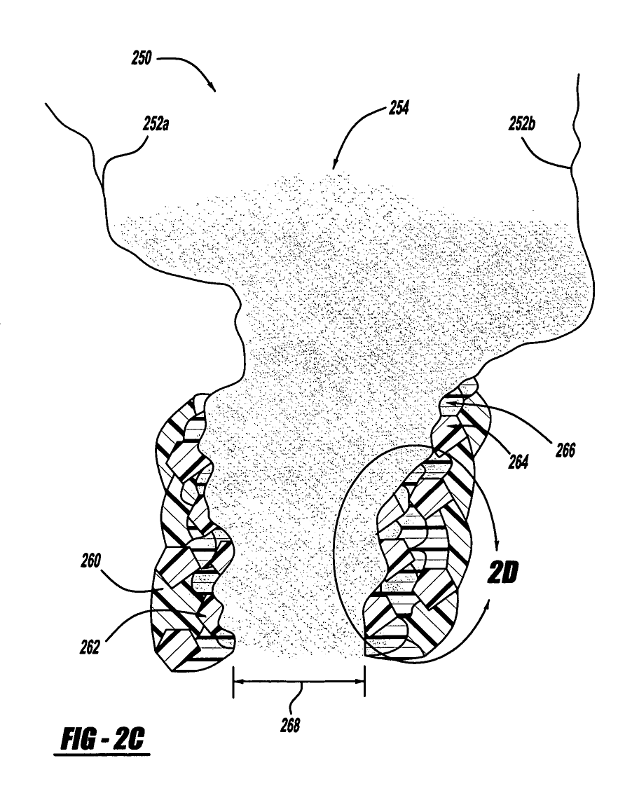

Turning now to details in composite embodiments, FIG. 2A shows a basic two layer multilayer composite 200 in cross-section. Pervious fluoropolymeric layer 204 (comprising a multiphase composition of a thermoplastic continuous phase and a fluoroelastomeric amorphous phase as previously described) is cohered to melt-bonded layer 202. FIG. 2B shows composite 230 in cross-section as a detail view showing filled pores (such as pore 234) in pervious fluoropolymeric layer 204. As shown, the pores provide a distributed set of continuous passages and pathways in a random arrangement throughout layer 204, with some of the voids of the unfilled pores (the pores prior to being filled via capillary flow with homogenous fluoropolymer from layer 202) extending to “terminate” at an open cross-sectional area (or hole) in the surface of layer 204 at interface 236. While the open cross-sectional area (or hole) at interface 236 is open with respect to layer 204, the opening is not open with respect to the composite 230. In this regard, the opening is filled with homogenous fluoropolymer that is in fluid continuum with the homogenous fluoropolymer of layer 202. The cross-sectional area across each of the pores (such as pore 234) is about 15 microns or less. Mechanical inter-linkage is achieved between melt-bonded layer 202 and pervious fluoropolymer layer 204 when liquid homogenous fluoropolymer of melt-bonded layer 202 (prior to curing) is imbibed (via capillary flow) into the pores of pervious fluoropolymer layer 204. A homogenous fluoropolymer fluid continuum of imbibed uncured homogenous fluoropolymer (homogenous fluoropolymer in pores of pervious fluoropolymer layer 204 below interface 236, and homogenous fluoropolymer in amorphous fluoropolymer micro-regions proximate to the walls of the pores of pervious fluoropolymer layer 204 below interface 236) and uncured homogenous fluoropolymer in the “main” portion of the melt-bonded layer 202 (homogenous polymer of layer 202 above interface 236) is therefore provided prior to curing. After curing of all liquid homogenous fluoropolymer in the multilayer composite (all homogenous fluoropolymer of layer 202 and in the pores of layer 204), “fingers” or “tendrils” of cured homogenous fluoropolymer (such as cured homogenous fluoropolymer of pore 234) extend into the pores of the pervious fluoropolymer of layer 204 below interface 236 from cured homogenous fluoropolymer in melt-bonded layer 202 above interface 236. Layer 202 is thereby mechanically bound to layer 204.

Details in the bonding of layer 202 to layer 204 are further appreciated by a consideration of detail in section 232. FIG. 2C provides further detail in this regard in a cross-sectional view 250 of a portion of a pore in section 232 filled with homogenous fluoropolymer 254. The pore of view 250 has one reference cross-sectional diameter 268 of about 1 micron. Pore “walls” or “defining surfaces” 252a and 252b show pore cross-sections progressing up to about 4 microns in diameter in view 250. Chemical inter-linkage between homogenous fluoropolymer 254 and amorphous micro-regions 260 and 266 is achieved as liquid homogenous fluoropolymer 254 fluidly diffuses and interblends into amorphous regions 260 and 266. Amorphous micro-region 260 is a micro-region of fluoropolymer sufficiently proximate to its glass transition temperature to have a “slush-like” consistency. Amorphous micro-region 266 is a micro-region of fluoropolymer sufficiently below its glass transition temperature to have a “gel-like” consistency. Liquid homogenous fluoropolymer 254 interblends via diffusion into amorphous regions 260 and 266 to provide an essentially continuous compositional presence of uncured homogenous fluoropolymer across a fluid continuum of (a) amorphous polymer of amorphous regions 260 and 266 in pervious fluoropolymer layer 204, (b) uncured homogenous fluoropolymer 254 in the pore (of layer 204) defined between surfaces 252a and 252b, and (c) uncured homogenous fluoropolymer in melt-bonded layer 202. When the homogenous fluoropolymer in the multilayer composite is cured (all homogenous fluoropolymer in amorphous regions 260 and 266, homogenous polymer 254, and also homogenous polymer in layer 202), closely-bonded molecular chains of cured homogenous fluoropolymer extend into amorphous regions 260 and 266 from the homogenous fluoropolymer in the pore defined between surfaces 252a and 252b and also from the cured homogenous fluoropolymer in layer 202. Therefore, after curing, cured homogenous fluoropolymer is effectively intermixed into some amorphous micro-portions (such as in amorphous regions 260 and 266 of pervious fluoropolymer layer 204). Note that homogenous fluoropolymer 254 does not intermix into crystal regions such as crystal region 262 and crystal region 264.

This intermixing is further shown in the zoomed detail view of FIG. 2D showing polymer micro-region detail in the vicinity of pore wall 252b of FIG. 2C. Homogenous flurorpolymer 254 is shown in the pore and also effectively intermixed, as a result of diffusion intermixing from the pore into the pervious fluoropolymer, into some amorphous micro-portions proximate to wall 252b. However, homogenous fluoropolymer 254 in FIG. 2D is not intermixed into crystal mirco-regions such as crystal region 264.

In various embodiments of this description, pervious fluoropolymer layer 204 in composites of this description is a relatively thin layer, especially when considered as a fraction of the total composite thickness. For clarity, this relation is illustrated in the composite of FIG. 2A; it is to be understood that it is a general feature of other embodiments as well.

In one embodiment, illustrated in FIG. 2A, pervious fluoropolymeric layer 204 has thickness 206 of from about 0.5 of a mil to about 10 mils. It should be noted that the relative thicknesses indicated in the composites of FIGS. 2A, 2B, 3, 4, 5A, 5B, 5C, and 10A to 10F are not necessarily to scale and are intended to readily indicate the order of layers in the multilayer structures rather than to rigorously show thicknesses in relative scale.

As noted, in one embodiment, pervious fluoropolymeric layer 204 has thickness 206 of from about 0.5 of a mil to about 10 mils. Therefore, pervious fluoropolymeric layer 204 has thickness 206 of from about 12.5 microns to about 250 microns. With respect to amorphous portions having independent diameters of from about 0.1 microns to about 100 microns in the thermoplastic phase, a layer of 12.5 microns can therefore be formed, in some embodiments, from a multiphase composition having individual amorphous phase particles whose diameter in one dimension prior to forming is 100 microns. In such an embodiment, the larger amorphous portions of the multiphase composition (prior to forming) extend during forming of pervious fluoropolymeric layer 202 to provide non-spherical elongated portions in formed pervious fluoropolymeric layer 202.

FIG. 3 shows composite 300 having 3 layers. Pervious fluoropolymeric layer 306 (comprising a multiphase composition of a thermoplastic continuous phase and a fluoroelastomeric amorphous phase as previously described) is a first layer cohered to third layer 302 with adhesive layer 304. Adhesive layer 304 is a melt-bonded layer (the second layer of the composite 300) respective to pervious fluoropolymeric layer 306. The homogenous fluoropolymer of adhesive layer 304 also comprises a third-layer bonding ingredient for cohering layer 302 to layer 304; this third-layer bonding ingredient is any of an epoxy compound, a phenoxy compound, a heat polymerizable thermoplastic oligomer, or combinations thereof. Third layer 302 is made of any of a thermoplastic material, a thermoset plastic material, a metal, ceramic, rubber, wood, leather, or combinations of these materials. When third layer 302 comprises metal, adhesive layer 304 also comprises silane as a bonding ingredient.

FIG. 4 shows a cross section view of an alternative multilayer composite structure 400. Composite 400 has pervious fluoropolymeric layer 402 as a first layer cohered to third layer 406 (third section 406) with adhesive layer 404. Adhesive layer 404 is the melt-bonded layer (the second layer of composite 400) respective to pervious fluoropolymeric layer 402.

In one embodiment, multilayer composite 400 is a first assembly component for an assembly of a bottle. A second assembly component of a lid (or cap) enables the bottle to be tightly closed. Pervious fluoropolymeric layer 402 provides an interface to a surface of the second component (a lid or cap) of the assembly, and third layer 406 (third section 406) is the structural body of composite 400. In another embodiment, not shown, of another non-laminar composite, the third layer is a small appliance body made of cured phenolic resin (such as cured phenol-formaldehyde resin), and the first layer is fluoroelastomeric thermoplastic vulcanizate.

As can be appreciated from a consideration of FIGS. 3 and 4, composite 300 is a multilayer composite where layers 306, 304, and 302 are laminar layers defined by essentially flat and parallel planes in composite 300, whereas composite 400 is a multilayer composite where layer 406 is not a laminar layer defined by a flat plane. However, both composite 300 and composite 400 are multilayer composites for reference as melt-bonded embodiments of this description.

In further consideration of general composite types, four different two-layer composites systems provide various useful features in the subject matter according to this description. In one two-layer composite (Composite Design Embodiment 1), the first layer comprises etched polytetrafluoroethylene, and the homogenous fluoropolymer layer material is any of tetrafluoroethylene/hexafluoropropylene copolymer, ethylene-tetrafluoroethylene copolymer, ethylene chlorotrifluoroethylene copolymer, tetrafluoroethylene/hexafluoropropylene/vinylidene fluoride terpolymer, hexafluoropropylene/vinylidene fluoride copolymer, chlorotrifluoroethylene/vinylidene fluoride copolymer, poly(vinylidene fluoride), tetrafluoroethylene/perfluoromethylvinylether copolymer, tetrafluoroethylene/perfluorovinylether copolymer, perfluoroalkoxy/tetrafluoroethylene copolymer, or combinations thereof. Relative benefits of this composite design embodiment are further presented in discussion of the subject matter of Table 1.

An alternative embodiment (Composite Design Embodiment 2) having etched polytetrafluoroethylene as a first layer has a second homogenous fluoropolymer layer material layer having an un-fluorinated ingredient blended in with the fluorinated ingredient in a weight ratio of from about 1:9 to about 9:1, preferably from about 1:2 to about 2:1. In this embodiment, the homogenous fluoropolymer layer material comprises not less than five weight percent fluorine; the un-fluorinated ingredient is any of thermoplastic, thermoplastic vulcanizate, thermoplastic elastomer, elastomer, thermoset resin, or combinations thereof; and the fluorinated ingredient is any of tetrafluoroethylene/hexafluoropropylene copolymer, ethylene-tetrafluoroethylene copolymer, ethylene chlorotrifluoroethylene copolymer, tetrafluoroethylene/hexafluoropropylene/vinylidene fluoride terpolymer, hexafluoropropylene/vinylidene fluoride copolymer, chlorotrifluoroethylene/vinylidene fluoride copolymer, poly(vinylidene fluoride), tetrafluoroethylene/perfluoromethylvinylether copolymer, tetrafluoroethylene/perfluorovinylether copolymer, perfluoroalkoxy/tetrafluoroethylene copolymer, or combinations thereof. Relative benefits of this composite design embodiment are further presented in discussion of the subject matter of Table 1.

In a two-layer composite embodiment (Composite Design Embodiment 3) having fluoroelastomeric thermoplastic vulcanizate as the first layer and a blended homogenous fluoropolymer second layer of a fluorinated ingredient and an un-fluorinated ingredient, the fluorinated ingredient and un-fluorinated ingredient are in a weight ratio of from about 1:9 to about 9:1, preferably from about 1:2 to about 2:1. The homogenous fluoropolymer layer material comprises not less than five weight percent fluorine; the un-fluorinated ingredient is any of thermoplastic, thermoplastic vulcanizate, thermoplastic elastomer, elastomer, thermoset resin, or combinations thereof; and the fluorinated ingredient is any of tetrafluoroethylene/hexafluoropropylene copolymer, ethylene-tetrafluoroethylene copolymer, ethylene chlorotrifluoroethylene copolymer, tetrafluoroethylene/hexafluoropropylene/vinylidene fluoride terpolymer, poly(vinylidene fluoride), tetrafluoroethylene/perfluoromethylvinylether copolymer, hexafluoropropylene/vinylidene fluoride copolymer, chlorotrifluoroethylene/vinylidene fluoride copolymer, tetrafluoroethylene/perfluorovinylether copolymer, perfluoroalkoxy/tetrafluoroethylene copolymer, or combinations thereof. In this embodiment, the homogenous fluoropolymer layer material contains a fluoroelastomer-curing agent (any of bisphenol, peroxide, polyol, phenol, amine, or combinations thereof). In a preferred embodiment, uncured fluoroelastomer in the composite is formulated to also have an appropriate cure site monomer for the selected fluoroelastomer-curing agent. Relative benefits of this composite design embodiment are further presented in discussion of the subject matter of Table 1.

In another less-complex two-layer composite embodiment (Composite Design Embodiment 4) having fluoroelastomeric thermoplastic vulcanizate as the first layer, the homogenous fluoropolymer layer material comprises not less than five weight percent fluorine and is any of thermoplastic, thermoplastic vulcanizate, thermoplastic elastomer, elastomer, thermoset resin, or combinations thereof. In this embodiment, the homogenous fluoropolymer layer material contains a fluoroelastomer-curing agent (any of bisphenol, peroxide, polyol, phenol, amine, or combinations thereof). As in the previous fluoroelastomer preferred embodiment, uncured fluoroelastomer in the composite is preferably formulated to have an appropriate cure site monomer for the selected fluoroelastomer-curing agent. Relative benefits of this composite design embodiment are further presented in discussion of the subject matter of Table 1.

In yet further consideration of general composite types, there are eight different three-layer composites systems of interest where the melt-bonded layer is the second layer of the composite functioning as an adhesive between the first layer and the third layer. The first four of these eight embodiments use etched polytetrafluoroethylene as the first layer of pervious fluoropolymer, and the second four of these eight embodiments use FKM-TPV as the first layer of pervious fluoropolymer.

In the first (Composite Design Embodiment 5) of these three-layer composite embodiments, the first layer comprises etched polytetrafluoroethylene and the third layer of the composite is any material of thermoplastic, thermoplastic vulcanizate, thermoplastic elastomer, elastomer, thermoset plastic, or combinations thereof. The homogenous fluoropolymer layer material comprises any of uncured fluoroelastomer, emulsion fluoroplastic, or combinations thereof; has not less than five weight percent fluorine; and comprises a third-layer bonding ingredient and a conditional third-layer curing agent. The third-layer bonding ingredient is any of an epoxy compound, a phenoxy compound, a heat polymerizable thermoplastic oligomer, or combinations thereof; and the fluoroelastomer-curing agent (if fluoroelastomer is in the composite) is any of bisphenol, peroxide, polyol, phenol, amine, or combinations thereof (uncured fluoroelastomer in the composite is preferably formulated to have an appropriate cure site monomer for the selected fluoroelastomer-curing agent). If the third layer comprises any of thermoplastic elastomer, elastomer, and thermoset plastic, the third-layer curing agent is any of amine, sulfur, or combinations thereof. Note that the third-layer curing agent in three-layer embodiments is a component of the homogenous fluoropolymer of the layer material of the second (melt-bonded) layer. In this regard, the third-layer curing agent is in the melt-bonded layer to promote conjoined curing (polymer chain bonding and growth) of the third-layer material and the homogenous fluoropolymer of the second melt-bonded layer in the region proximate to the interface between the third layer and the second layer and thereby promote cohesion between the third layer and the second (melt-bonded) layer. If curable epoxy is used in the homogenous fluoropolymer, then an appropriate amount of epoxy curing agent is intermixed in the homogenous fluoropolymer layer material. Relative benefits of this composite design embodiment are further presented in discussion of the subject matter of Table 1.

In a second three-layer composite embodiment (Composite Design Embodiment 6), the first layer again comprises etched polytetrafluoroethylene while the third layer of the composite is a metal. The homogenous fluoropolymer layer material has not less than five weight percent fluorine and comprises a fluorinated ingredient, a third-layer bonding ingredient, and silane. The fluorinated ingredient is any of uncured fluoroelastomer, emulsion fluoroplastic, or combinations thereof; the third-layer bonding ingredient is any of an epoxy compound, a phenoxy compound, a heat polymerizable thermoplastic oligomer, or combinations thereof; and the fluoroelastomer-curing agent (if fluoroelastomer is in the composite) is any of bisphenol, peroxide, polyol, phenol, amine, or combinations thereof (uncured fluoroelastomer in the composite is preferably formulated to have an appropriate cure site monomer for the selected fluoroelastomer-curing agent). If the third layer comprises any of thermoplastic elastomer, elastomer, and thermoset plastic, the third-layer curing agent is any of amine, sulfur, or combinations thereof. If curable epoxy is used, then an appropriate amount of epoxy curing agent is intermixed in the homogenous fluoropolymer layer material. Relative benefits of this composite design embodiment are further presented in discussion of the subject matter of Table 1.

In a third three-layer composite embodiment (Composite Design Embodiment 7), the first layer again comprises etched polytetrafluoroethylene, the third layer of the composite is a metal, and the homogenous fluoropolymer layer material comprises silane and has not less than five weight percent fluorine in a fluorinated ingredient of uncured fluoroelastomer, emulsion fluoroplastic, or combinations thereof. The fluoroelastomer-curing agent is any of bisphenol, peroxide, polyol, phenol, amine, or combinations thereof (uncured fluoroelastomer in the composite is preferably formulated to have an appropriate cure site monomer for the selected fluoroelastomer-curing agent). Relative benefits of this composite design embodiment are further presented in discussion of the subject matter of Table 1.

In a fourth three-layer composite embodiment (Composite Design Embodiment 8), the first layer again comprises etched polytetrafluoroethylene, the third layer of the composite is a metal, and the homogenous fluoropolymer layer material comprises silane and has not less than five weight percent fluorine in a fluorinated ingredient of tetrafluoroethylene/hexafluoropropylene copolymer, ethylene-tetrafluoroethylene copolymer, ethylene chlorotrifluoroethylene copolymer, tetrafluoroethylene/hexafluoropropylene/vinylidene fluoride terpolymer, hexafluoropropylene/vinylidene fluoride copolymer, chlorotrifluoroethylene/vinylidene fluoride copolymer, poly(vinylidene fluoride), tetrafluoroethylene/perfluoromethylvinylether copolymer, tetrafluoroethylene/perfluorovinylether copolymer, perfluoroalkoxy/tetrafluoroethylene copolymer, or combinations thereof. Note that no fluoroelastomer-curing agent is needed in this system. Relative benefits of this composite design embodiment are further presented in discussion of the subject matter of Table 1.

In a fifth three-layer composite embodiment (Composite Design Embodiment 9), the first layer is fluoroelastomeric thermoplastic vulcanizate while the third layer is any material of thermoplastic, thermoplastic vulcanizate, thermoplastic elastomer, elastomer, thermoset plastic, or combinations thereof. The homogenous fluoropolymer layer material has not less than five weight percent fluorine and comprises a fluorinated ingredient, a third-layer bonding ingredient, and a conditional third-layer curing agent. The fluorinated ingredient is any of uncured fluoroelastomer, emulsion fluoroplastic, or combinations thereof; the third-layer bonding ingredient is any of an epoxy compound, a phenoxy compound, a heat polymerizable thermoplastic oligomer, or combinations thereof; and the fluoroelastomer-curing agent is any of bisphenol, peroxide, polyol, phenol, amine, or combinations thereof (uncured fluoroelastomer in the composite is preferably formulated to have an appropriate cure site monomer for the selected fluoroelastomer-curing agent). If the third layer comprises any of thermoplastic elastomer, elastomer, and thermoset plastic, the third-layer curing agent is any of amine, sulfur, or combinations thereof. If curable epoxy is used, then an appropriate amount of epoxy curing agent is intermixed in the homogenous fluoropolymer layer material. Relative benefits of this composite design embodiment are further presented in discussion of the subject matter of Table 1.

In a sixth three-layer composite embodiment (Composite Design Embodiment 10), the first layer is fluoroelastomeric thermoplastic vulcanizate while the third layer of the composite is a metal. The homogenous fluoropolymer layer material has not less than five weight percent fluorine and comprises a fluorinated ingredient, a third-layer bonding ingredient, and silane. The fluorinated ingredient is any of uncured fluoroelastomer, emulsion fluoroplastic, or combinations thereof, the third-layer bonding ingredient is any of an epoxy compound, a phenoxy compound, a heat polymerizable thermoplastic oligomer, or combinations thereof, and the fluoroelastomer-curing agent is any of bisphenol, peroxide, polyol, phenol, amine, or combinations thereof (uncured fluoroelastomer in the composite is preferably formulated to have an appropriate cure site monomer for the selected fluoroelastomer-curing agent). If curable epoxy is used, then an appropriate amount of epoxy curing agent is intermixed in the homogenous fluoropolymer layer material. Relative benefits of this composite design embodiment are further presented in discussion of the subject matter of Table 1.

In a seventh three-layer composite embodiment (Composite Design Embodiment 11), the first layer is fluoroelastomeric thermoplastic vulcanizate while the third layer of the composite is a metal. The homogenous fluoropolymer layer material has not less than five weight percent fluorine and comprises a fluorinated ingredient and silane. The fluorinated ingredient is any of uncured fluoroelastomer, emulsion fluoroplastic, or combinations thereof, and the fluoroelastomer-curing agent is any of bisphenol, peroxide, polyol, phenol, amine, or combinations thereof (uncured fluoroelastomer in the composite is preferably formulated to have an appropriate cure site monomer for the selected fluoroelastomer-curing agent). Relative benefits of this composite design embodiment are further presented in discussion of the subject matter of Table 1.

In the eighth three-layer composite embodiment (Composite Design Embodiment 12), the first layer is fluoroelastomeric thermoplastic vulcanizate while the third layer of the composite is a metal. The homogenous fluoropolymer layer material has not less than five weight percent fluorine and comprises silane and a fluorinated ingredient selected from the group consisting of tetrafluoroethylene/hexafluoropropylene copolymer, ethylene-tetrafluoroethylene copolymer, ethylene chlorotrifluoroethylene copolymer, tetrafluoroethylene/hexafluoropropylene/vinylidene fluoride terpolymer, hexafluoropropylene/vinylidene fluoride copolymer, chlorotrifluoroethylene/vinylidene fluoride copolymer, poly(vinylidene fluoride), tetrafluoroethylene/perfluoromethylvinylether copolymer, tetrafluoroethylene/perfluorovinylether copolymer, perfluoroalkoxy/tetrafluoroethylene copolymer, or combinations thereof. Fluoroelastomer-curing agent is any of bisphenol, peroxide, polyol, phenol, amine, or combinations thereof (uncured fluoroelastomer in the composite is preferably formulated to have an appropriate cure site monomer for the selected fluoroelastomer-curing agent). Relative benefits of this composite design embodiment are further presented in discussion of the subject matter of Table 1.

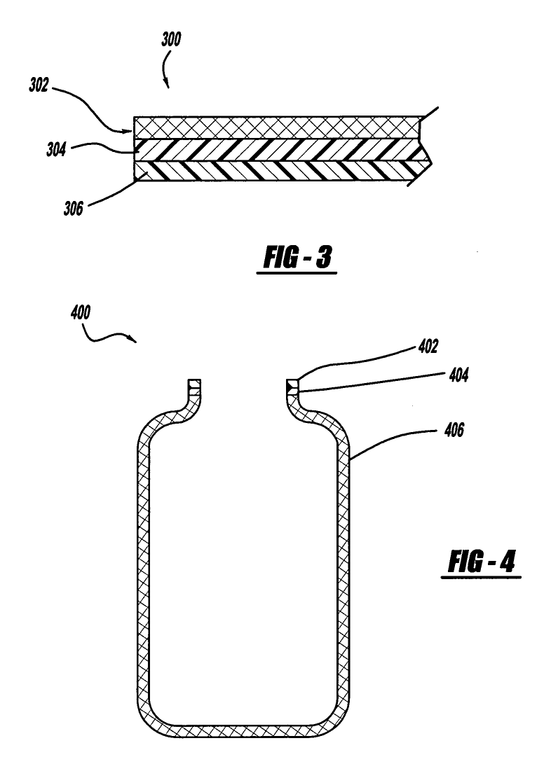

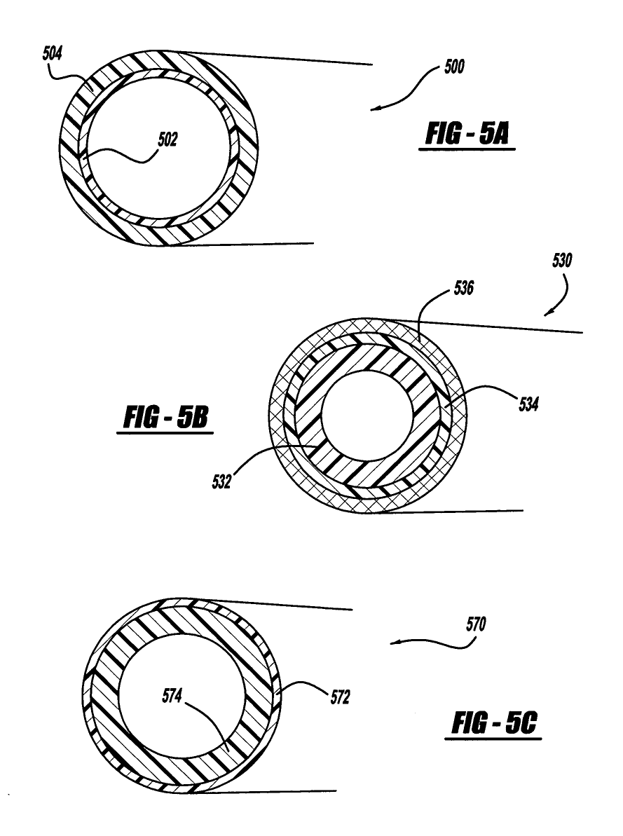

Returning to the figures and to composites shaped or adapted into particular forms and items, FIG. 5A, FIG. 5B, and FIG. 5C present, in cross-sectional view, three alternative embodiments of composite tubes or hoses incorporating a pervious fluoropolymeric layer. FIG. 5A presents tubular composite 500 (tubular conduit 500) having pervious fluoropolymeric layer 502 as an inner liner and melt-bonded layer 504 as an outer layer cohered to pervious fluoropolymeric layer 502. When composite 500 is a fuel hose, the preparation of the multiphase composition for pervious fluoropolymeric layer 502 preferably includes dispersing of conductive particulate into the multiphase composition to provide an electrical resistivity of less than about 1×10⁻³ Ohm-m at 20 degrees Celsius in pervious fluoropolymeric layer 502 (through a plurality of conductive particles dispersed in pervious fluoropolymeric layer 502) along with a formulation of the multiphase composition and a sizing of layer 502 to provide a permeation constant of not greater than 25 gms-mm/m²/day to ASTM D-814 Fuel C gasoline through the layers of the fuel hose. In a preferred embodiment of a fuel line according to the general design of composite 500, layer 502 is formulated and dimensioned to provide for a compressive sealing of composite 500 around an essentially rigid tube to which the fuel line of composite 500 is attached (preferably via a compression set value of not greater than 60 in inner layer 502). In use, the fuel hose inner lining (layer 502) is electrically grounded so that static electricity (generated by fuel flowing within the fuel hose) is readily dissipated to maintain the fuel hose at a safe static electrical potential. In an alternative embodiment of a fuel line where, in use, the flow of fuel is insufficient for creating static electrical charge buildup, layer 502 is prepared without benefit of conductive electrical particulate and is sized to provide a permeation constant of not greater than 25 gms-mm/m²/day to ASTM D-814 Fuel C gasoline through the layers of the fuel line. Another embodiment for a flexible composite with the design of composite 500 is in a peristaltic pump flexure tube.

FIG. 5B shows tubular composite 530 having pervious fluoropolymeric layer 532 cohered to outer layer 536 with melt-bonded layer 534 as an adhesive layer of homogenous fluoropolymer layer material with a third-layer bonding ingredient (for cohering layer 534 to layer 536) of any of an epoxy compound, a phenoxy compound, a heat polymerizable thermoplastic oligomer, or combinations thereof. Third layer 536 is made of any of a thermoplastic material, a thermoset plastic material, a metal, ceramic, rubber, wood, leather, or combinations thereof materials. When third layer 536 comprises metal, adhesive layer 534 comprises silane as a bonding ingredient.

Composite 530 is a design enabling a tube benefiting, for example, from the innate high strength and lightness of fluoropolymer 534 in relatively high temperature service. It should be noted, however, that such a composite design couldn't readily transfer heat at a low temperature differential from layer 532 to layer 536 or from layer 536 to layer 532 for temperature control if layer 534 has a significant thickness unless layer 534 is formulated with filler that promotes heat transfer. Such filler has a particle size of less than 10 microns to provide homogeneity in layer 534.

FIG. 5C shows tubular composite 570 with pervious fluoropolymeric layer 572 as an outside layer and melt-bonded layer 574 as an inner lining. Such a composite is essentially a structural inverse of composite 500 with respect to properties of the layers. Accordingly, composite 570 provides a polymeric tube that, in non-limiting example, finds use for a tube immersed within a fuel or a material such as an amine base.

Composites according to the general designs of any of composite 200, composite 300 composite 400, composite 500, composite 530, and composite 570 have many uses. The ability to form a finely dimensioned pervious fluoropolymeric layer having high chemo-resistive properties and also low compression set properties brings forward a preferred use of the above composite embodiments in items such as (in non-limiting example) gaskets, dynamic seals, packing (static) seals, o-rings, pump diaphragms, and peristaltic pump flexure tubes. The invention thereby enables both new composite constructions of these sealant articles as well as new assemblies incorporating such new composite sealant articles.

In one embodiment, a new assembly is derived from a traditional assembly with the straightforward replacement of a prior seal (such as an o-ring) with a new multilayer o-ring according to this description. In another embodiment, a new assembly is derived from a replacement of a prior seal (such as an o-ring) with a new multilayer seal of the same external dimensions along with further re-design (from the assembly's original design prior to the use of the composite seal according this description) to take advantage of the performance properties enabled in the seal by this description. In this regard, in non-limiting example, an improved thermal stress capability in a composite seal having a pervious fluoropolymeric layer according to this description enables one assembly to operate at a higher operating temperature after the prior seal has been replaced with a new multilayer seal according to this description. The higher operating temperature enables more efficacious heat transfer from the system to its respective heat sink, and the assembly is accordingly then beneficially redesigned to have a smaller heat transfer area (such as provided by a radiator).

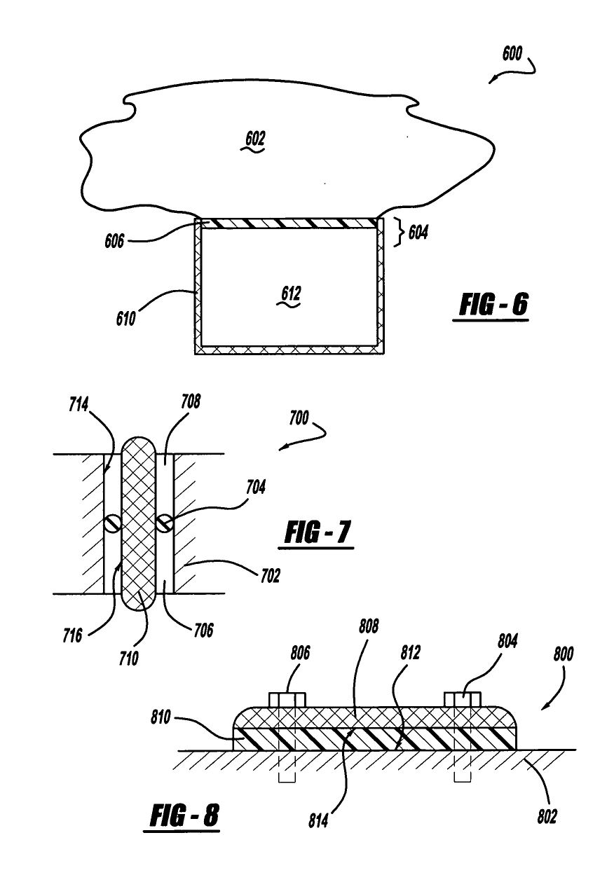

Turning now to specifics in assemblies using the multilayer seals of this description, FIG. 6 shows a general sealed assembly model 600. Object 610 has internal space 612 defined within object 610, and space 612 is essentially isolated from fluid 602 with a barrier either capable of flexing and/or capable of being periodically removed and/or opened. Seal 606 provides such a barrier in one embodiment as a multilayer seal having at least a pervious fluoropolymer layer and a melt-bonded layer as previously described.

Separate layers of seal 606 are not shown in FIG. 6. Seal 606, in one embodiment, is a 2-layer multilayer composite. In an alternative embodiment, seal 606 is a multilayer seal that is a 3-layer multilayer composite. In other embodiments, seal 606 is a multilayer seal that is a multilayer composite having more than 3 layers. In yet another embodiment, object 610 and seal 606 form a multilayer (multi-section) composite. In all composite embodiments of seal 606, seal 606 or at least one layer of seal 606 is a pervious fluoropolymeric layer as previously described herein; and the pervious fluoropolymeric layer is cohered to a melt-bonded layer of homogenous fluoropolymer layer material as previously described herein. Fluid 602 is broadly defined and includes any liquid, gas, dispersion of a gas and a liquid, dispersion of liquid vapor in a gas, dispersion of solid particulate in a liquid, and dispersion of solid particulate in a gas. In this regard, in non-limiting example, fluid 602 in one embodiment is a dispersion of solid particulate in a gas provided in the form of air with a low concentration of dust particles. In another non-limiting example embodiment, fluid 602 is a dispersion of solid particulate in a liquid provided in the form of oil with a low concentration of suspended metal particles. In yet another non-limiting example embodiment, fluid 602 is a liquid provided in the form of gasoline. In still another non-limiting example embodiment, fluid 602 is a gas provided in the form of air at a first pressure where space 612 is filled with air at a second pressure different from the first pressure.

One embodiment of a sealed assembly sealed with a packing seal is depicted in FIG. 7 in mechanical assembly cutaway 700 where first component 702 has rigid surface 714 and second component 710 has rigid surface 716. Seal 704 (a composite packing article also denoted as a static seal or as a multilayer packing seal as a multilayer composite having a pervious fluoropolymeric layer and melt-bonded homogenous fluoropolymer layer as described above where the term packing seal denotes a deformable assembly component compressed or adapted to be compressed to some degree between at least two surfaces to prevent or control leakage of fluid between surfaces that either move or are essentially capable of moving in relation to each other including, without limitation, any article from application product categories termed as gaskets, rings, seals, packing, stuff, gland packing, stuffing, stopping, wadding, padding, joining sheet, thread tapes, and winding tapes) is disposed between rigid surface 714 and rigid surface 716 to seal (essentially isolate) any fluid within space 708 from any fluid in space 706. In one embodiment of space 706 (shown in cutaway), surface 714 defines a circular bore within component 702 and component 710 is a cylindrical object fitting within the circular bore with cylindrical surface 716 being sealed against cylindrical surface 714 with (an o-ring) seal 704.

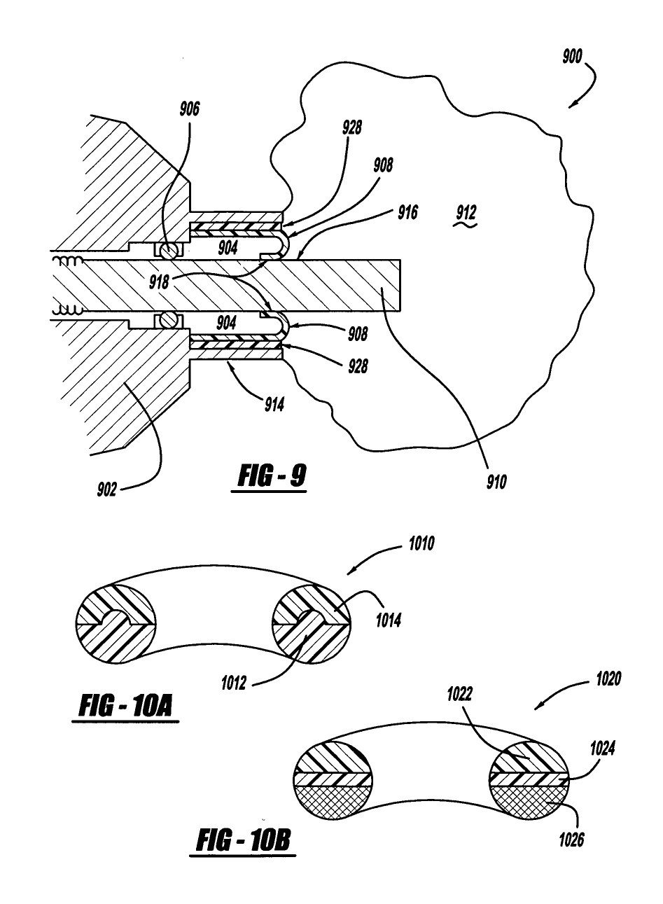

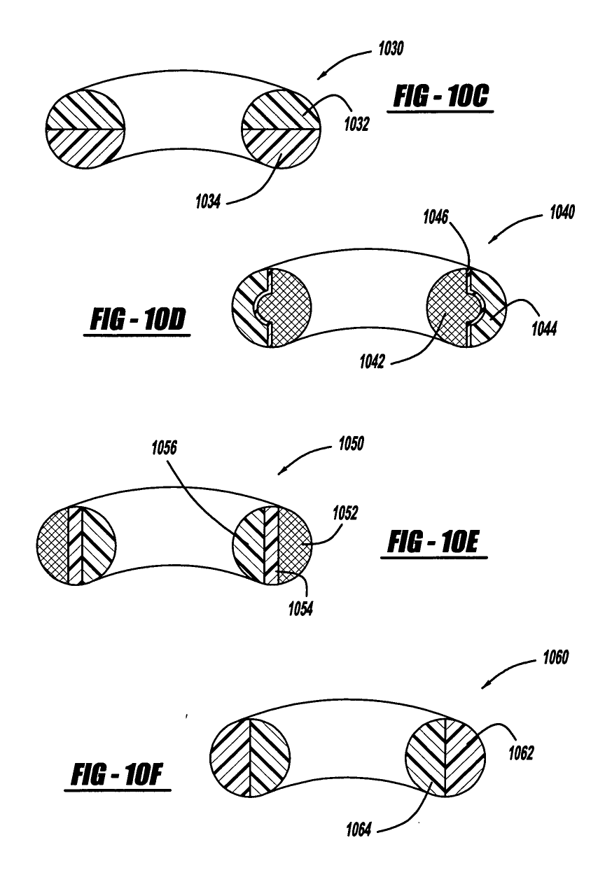

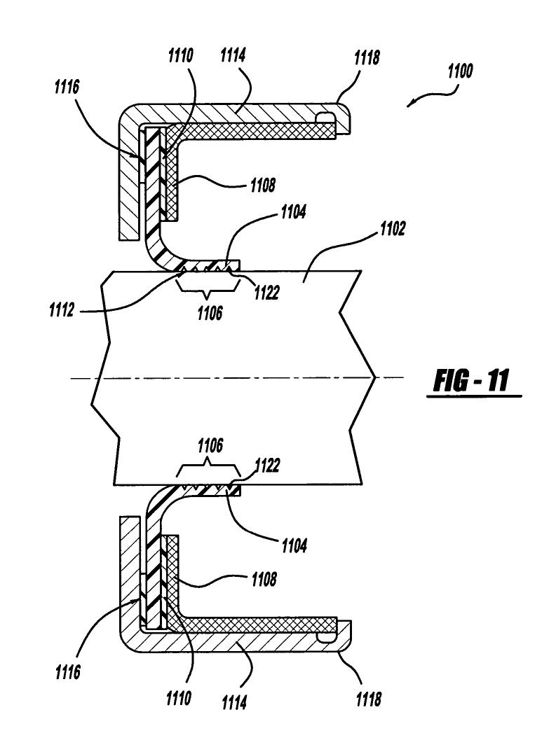

The separate layers of seal 704 are not shown in FIG. 7. Seal 704 is a multilayer seal that, in one embodiment, is a 2-layer multilayer composite. In an alternative embodiment, seal 704 is a multilayer seal that is a 3-layer multilayer composite. In yet other embodiments, seal 704 is a multilayer seal made of a multilayer composite having more than 3 layers. In all composite embodiments of seal 704, at least one layer of seal 704 is a pervious fluoropolymeric layer comprising a multiphase composition as previously described herein; and the pervious fluoropolymeric layer is cohered to a melt-bonded layer of cured homogenous fluoropolymer layer material as previously described herein. Seal 704 is a composite according to, in non-limiting example, the general layer arrangement of any of composite 200, composite 300, or composite 400, or an o-ring composite according to any of o-rings 1010, 1020, 1030, 1040, 1050, or 1060 as presented in FIGS. 10A to 10F further herein. In one embodiment, the multilayer seal bears lightly against surfaces 716 and 714 and is thereby slideably disposed between surface 714 and surface 716 so that component 710 can be moved in parallel with the axis of the bore within component 702. In an alternative embodiment, the multilayer seal bears tightly between surfaces 716 and 714 and is thereby compressively disposed between surface 714 and surface 716 so that component 710 essentially cannot be moved along the axis of the bore within component 702.

FIG. 8 shows another embodiment of a sealed assembly in mechanical assembly cutaway 800 where a first component 802 has rigid surface 812 and a second component 808 has rigid surface 814. Seal 810 (a composite packing article also denoted as a static seal or as a multilayer packing seal as a multilayer composite having a pervious fluoropolymeric layer and melt-bonded homogenous fluoropolymer layer as described above) is disposed between rigid surface 814 and rigid surface 812 to seal (essentially isolate) any fluid from passage through the space filled by seal 810 (the separate layers are not shown in seal 810).

The separate layers of seal 810 are not shown in FIG. 8. Seal 810 is a multilayer seal that, in one embodiment, is a 2-layer multilayer composite. In an alternative embodiment, seal 810 is a multilayer seal that is a 3-layer multilayer composite. In yet other embodiments, seal 810 is a multilayer seal made of a multilayer composite having more than 3 layers. In all composite embodiments of seal 810, at least one layer of seal 810 is a pervious fluoropolymeric layer comprising a multiphase composition as previously described herein; and the pervious fluoropolymeric layer is cohered to a melt-bonded layer of homogenous fluoropolymer as previously described herein. Seal 810 is a composite according to, in non-limiting example, the general designs of any of composite 200, composite 300 and composite 400. Multilayer seal 810 bears tightly between surfaces 812 and 814 and is thereby compressively disposed between surface 814 and surface 812. For example, Seal 810 is compressed through forces derived from bolt 804 and bolt 806. In one embodiment, multilayer seal 810 has a first layer of fluoroelastomeric thermoplastic vulcanizate and a polymeric third layer of any of high temperature nylon, polyester, polyphenylene sulfide, polyphthalanimide, polyetheretherketone, polyetherimide, polyamidimide, polyimide, polysulfone, liquid crystalline polymer, or combinations thereof. As should be apparent, one embodiment of composite 810 is a head gasket for an internal combustion engine. Another embodiment of composite 810 is an oil pan gasket for an internal combustion engine. Another embodiment of composite 810 is a gasket for an automatic transmission. Another embodiment of composite 810 is a gasket for a manual transmission.

FIG. 9 shows another embodiment of a sealed assembly in mechanical assembly cutaway 900 where component 910 is in one form of pivoting connection to base 902 with pivoting of component 910 augmented by roller bearing 906. In this regard, pivoting references movement by a component respective to a base to which it is mechanically adjoined or restrained and includes, without limitation, movement relative to the base termed as any of swinging, rotating, rotating about an axis, oscillating, turning, spinning, swiveling, screwing, sliding, and wheeling. Flexible multilayer seal 914 (also denoted as a dynamic seal or as a multilayer torsion seal) is effectively provided as a composite of base 902, melt-bonded layer 928 (homogenous fluoropolymer layer for a 3-layer multilayer composite as described above), and pervious fluoropolymer layer 908. Pervious fluoropolymer layer 908 is disposed in contact with fluid 912 and also with a sealing surface of component 910 (the sealing surface of component 910 is the surface 916 of component 910 in the general area of location 918). Component 910 thereby has a first portion in contact with fluid 912 (that portion of component 910 generally to the right side of location 918 in FIG. 9), a second portion isolated from contact with fluid 912 (that portion of component 910 generally to the left side of location 918 in FIG. 9), and a sealing surface (surface 916 of component 910 essentially at location 918) interfacing the first and second portions of component 910. Flexible pervious fluoropolymer layer 908 has a surface portion (a first edge) fixedly sealed to base 902 by melt-bonded layer 928.

Flexible multilayer seal 914 has a surface portion (a second edge) configured or adapted to compressively fit against the sealing surface of component 910 (surface 916 of component 910 essentially at location 918). In one embodiment, a single continuous edge is separated into the two edge portions to provide the first and second surface portions; in an alternative embodiment, not shown, the first and second surface portions are independent edges. The sealed edges (or edge surface portions) essentially enable a full sealing of layer 908 fixedly to base 902 and compressively (slideably or statically) against the sealing surface of component 910 so that fluid 912 essentially cannot fluidly flow to space 904.

In this regard, flexible multilayer seal 914 is torsionally flexed (deflected as if to initiate the first winding of a torsion spring) to (sealingly) bear its second surface portion against the sealing surface of component 910 so that the second portion of component 910 is essentially isolated from the fluid within cove space 904 (a relatively small protected and/or sheltered space or nook) defined between base 902, component 910, bearings 906, and layer 908. All surfaces of component 910, base 902, roller bearings 906, and layer 908 that define cove space 904 therefore establish a section of the mechanical assembly that is essentially isolated from fluid 912.

In one embodiment, an air or nitrogen purge (not shown) maintains a positive pressure (respective to the pressure of fluid 912) within cove space 904 so that bearing 906 and the sealing surface of component 910 are further isolated from contaminants of concern in fluid 912. In one embodiment, the second surface portion statically bears against the sealing surface of component 910, and component 910 is only occasionally pivoted; in an alternative embodiment, component 910 is frequently pivoted (rotated about its axis) respective to base 902. One embodiment of composite 914 is a dynamic seal for an automobile crankcase. Another embodiment of composite 914 is a protective boot for a removable threaded measurement probe. In one embodiment, cove space 904 contains lubricating oil.

As should be appreciated from a consideration of FIGS. 7, 8, and 9, seals in one context are usefully, but not exclusively, designated into two important types respective to application utility as either being static (frequently as packing) type seals or as dynamic (frequently as flexible or torsion) type seals. In this regard, a “static seal” designation generally references a seal that, in use, packs between two surfaces to fill and essentially seal the intervening space between the two surfaces where the seal is under some degree of compression from the two surfaces.

In a static seal, most spring functionality derives from the compression set properties of the seal, so a static seal is usually mechanically modeled as a compression spring (or, if extended, as an extension spring). While one surface sealed by the seal may move respective to the other surface sealed by the seal, such movement usually tends to be either occasional or relatively minor in degree so that the amount of linear travel of either surface against the static seal does not generate appreciable friction or attendant heat for the static seal to transmit and/or absorb.

In one embodiment, a method of sealing an assembly (having a first component having a first rigid surface, and a second component having a second rigid surface) is provided of (a) cohering a melt-bonded layer of homogenous fluoropolymer to a pervious fluoropolymeric layer to make a multilayer packing seal according the above composite design and (b) disposing the multilayer packing seal between the first rigid surface and the second rigid surface to establish a seal between the two components in the assembly. The composite is further irradiated in one embodiment alternative. In one assembly embodiment, the seal is slidably disposed between the two surfaces under gentle compression, and in another assembly embodiment, the seal is aggressively compressed between the two surfaces. In various embodiments of the methods, the cohering step uses any of compression molding, injection molding, extrusion, transfer molding, and insert molding techniques. In other embodiments, a third layer is cohered to the melt-bonded layer with the benefit of a third-layer bonding ingredient in the melt-bonded layer to provide a 3-layer composite seal. In yet other embodiments, other layers are bonded to either the pervious fluoropolymeric layer or to the third layer to provide a multilayer compression seal having more than three layers.

A “torsion seal” designation herein generally references a dynamic seal (a seal designed for sealingly interfacing to at least one moving component of an assembly) that, in use, usually closes an open space between two surfaces to essentially seal the intervening space or area between a movable surface and a non-movable surface through flexing as a torsion spring under tension to bear against the movable surface with an edge designed to manage a reasonable amount of movement of the movable surface against the seal edge interfacing to the movable surface. In this regard, the seal edge interfacing to the movable surface frequently manages appreciable friction or attendant heat either transmitted to or absorbed by the torsion seal. A flexible seal of this type achieves its torsion spring functionality primarily by use of its object tensile properties, although compression set properties may augment the overall torsion spring functionality with some compression spring aspects at the interfacing edge between the seal and the moving surface. Torsion seals provide a type of dynamic seal construction (dynamic seals traditionally generally include oil seals, hydraulic and pneumatic seals, exclusion seals, labyrinth seals, bearing isolators, piston rings, and back-up rings).

In one embodiment, a method of sealing an assembly (according to the above description) to isolate a section of the assembly from contact with a fluid is provided. The method includes
(a) cohering of a melt-bonded layer of homogenous fluoropolymer layer material to a pervious fluoropolymeric layer (comprising a continuous thermoplastic phase and a dispersed fluoroelastomeric amorphous phase as describe above) to make a flexible multilayer torsion seal having a first sealing surface portion and a second sealing surface portion where the second sealing surface portion is adapted to compressively fit against the sealing surface; and
(c) torsionally flexing the flexible multilayer torsion seal to sealingly bear the second sealing surface portion against the sealing surface such that the first component portion is essentially isolated from the fluid within a cove space defined between the rotating component, the multilayer seal composite created by the base and melt-bonded layer and flexed pervious fluoropolymeric layer, and the roller bearing.

The flexible multilayer torsion seal is further irradiated in one embodiment with radiation. In another embodiment, the method further includes incising a continuous groove into the second sealing surface portion so that a channel is provided for fluidly conveying lubricant to the cove space through viscous interaction of the lubricant with the dynamic sealing surface. In an embodiment where the base further comprises a housing and a removable flange adapted for tightly and sealingly attaching to the housing, the melt-bonded layer of homogenous fluoropolymer coheres to the pervious fluoropolymeric layer and also to the flange. In one embodiment of this, the housing has a spring-form end portion adapted for tightly clipping the flange to the housing, and the torsionally flexing is achieved in the process of clipping the flange to the housing while, at the same time, bearing the second surface portion against the sealing surface of the pivotable component. In various embodiments, the cohering is done through use of any of compression molding, injection molding, extrusion, transfer molding, and insert molding processes.

Turning now to the process of formulating the homogenous fluoropolymer layer material for the melt-bonded layer, a designed empirical process is preferred. In this regard, the homogenous fluoropolymer layer material formulation is designed in any particular composite to provide a desired bond for a multilayer composite (a) having a particular design in terms of layers, layer dimensions, and general overall shape and structure; (b) having specific materials in each of the layers to be bonded (one layer of either FKM-TPV or etched polytetrafluoroethylene; a second layer of the cured homogenous fluoropolymer layer material formulation; and an optional third layer of any of thermoplastic, thermoset plastic, metal, ceramic, rubber, wood, leather, or combinations thereof); and (c) having a designated method for manufacture (for example, any of compression molding, injection molding, extrusion, transfer molding, and insert molding processes). In this regard, all layers except the homogenous fluoropolymer layer are first defined for manufacture. A series of tests are then planned for composite article test samples according to the chemical nature of the layers to be bonded to the melt-bonded layer of the homogenous fluoropolymer. A two-level factorial model is preferred for determining a desired homogenous fluoropolymer layer material formulation. In one embodiment of a testing approach, a series of two-level factorial investigations is used to converge on an optimal homogenous fluoropolymer layer material formulation where results from a first two-level model are used to define at least one nested subsequent two-level model.

In another embodiment of a testing approach, a progressive series of two-level factorial designed test investigations is used to converge on an optimal homogenous fluoropolymer layer material formulation where factors of concern and interest are prioritized, a first two-level test model is used to simultaneously resolve the first 3-5 factors of greatest prioritized significance into a stabilized set, and subsequent models progressively simultaneously resolve subsequent sets of 3-5 factors of greatest prioritized significance (in view of the stabilized set of the stabilized factors of greatest prioritized significance) in a plurality of respective two-level models. In this regard, it is to be noted that the number of test samples needed to fully resolve a 2 level factorial investigation is 2ⁿ. If 3 factors are simultaneously resolved with a designed 2 level factorial test, then 8 samples need to be prepared and evaluated. If 4 factors are simultaneously resolved with a designed 2 level factorial test, then 16 samples need to be prepared and evaluated. If 5 factors are simultaneously resolved with a designed 2 level factorial test, then 32 samples need to be prepared and evaluated. If 10 factors are simultaneously resolved with a designed 2 level factorial test, then 1024 samples need to be prepared and evaluated. Since each test requires time and money, a progressive resolution of prioritized sets of factors is economically preferred to resolve tradeoffs in formulation alternatives for the homogenous fluoropolymer layer material and in other composite-related variables when the number of variables that need simultaneous empirical resolution are greater than 5. In defining the number of tests for each 2 level test instance in the progressive set, the smallest groups of factors which must be simultaneously resolved should be defined and then prioritized.

Each test sample is constructed as a representative composite, preferably adapted to be a particular article for the desired application. After the test composite is fully made, the composite is tested for various properties, including the property of coherence. Coherence is tested in one embodiment with a pull test. Results are quantified into an evaluation matrix for the two-level test design (such as a two-level factorial analysis of variance based on the two-level design of tests).

Many factors can be resolved or partially resolved without testing based upon the considerations set forth in Tables 1-4. The basic design of a 2-layer or 3-layer composite for most applications very probably conforms to one of the layer and composition descriptions of Composite Design Embodiments 1-12, as previously described herein. In selecting the proper Composite Design Embodiment for use in an application, Table 1 presents a qualitative comparison of factors related to the layers and homogenous fluoropolymer layer material formulations previously described for Composite Design Embodiments 1-12.

TABLE 1
Composite Outside Layer and Melt-Bonded (Adhesive) Layer Properties
For Composite Design Embodiments 1-12
(See the discussion following the Table for further definition of factors and columns)

| | Factor/Composite Design Embodiment # | | | | | | | | | | | |
|---|---|---|---|---|---|---|---|---|---|---|---|---|
| | 1 | 2 | 3 | 4 | 5 | 6 | 7 | 8 | 9 | 10 | 11 | 12 |
| Pervious | Etched | Etched | FKM- | FKM- | Etched | Etched | Etched | Etched | FKM- | FKM- | FKM- | FKM- |
| Fluoropolymer | PTFE | PTFE | TPV | TPV | PTFE | PTFE | PTFE | PTFE | TPV | TPV | TPV | TPV |
| layer | | | | | | | | | | | | |
| Third layer | NONE | NONE | NONE | NONE | Polymer | Metal | Metal | Metal | Polymer | Metal | Metal | Metal |
| Mechanical | M | H | M | H | H | H | M | H | H | H | M | H |
| Property | | | | | | | | | | | | |
| Chemical | H | M | M | L | H | H | H | H | H | H | H | H |
| Resistance | | | | | | | | | | | | |
| Service | M˜H | M˜H | M˜H | M˜H | H | H | M | H | H | H | M | H |
| Temperature | | | | | | | | | | | | |
| Bonding | H | M | H | M | H | H | M | M | H | H | M | M |
| Efficiency | | | | | | | | | | | | |
| Viscosity | H | H | H | H | L | L | L | H | L | L | L | H |
| Processing | H | H | H | H | M | M | L | H | M | M | L | H |
| Temperature | | | | | | | | | | | | |
| Cost | H | M | M | L | M | M | M | H | M | M | M | H |

In Table 1, each of the numbered columns references one of the previously described Composite Design Embodiments. For example, the column numbered with a “1” references properties for Composite Design Embodiment 1 as previously described herein. In Table 1, “H” stands for a relatively High qualitative factor, “L” stands for a relatively Low qualitative factor, and “M” stands for a relatively Median qualitative factor. The term “Polymer” means any of thermoplastic, thermoplastic vulcanizate, thermoplastic elastomer, elastomer, thermoset plastic, or combinations thereof. “Mechanical properties” generally indicate properties respective to strength and robustness under friction and/or mechanically-imposed forces such as measured through and of tensile strength (ASTM D 1708), elongation at break (ASTM D 1708), flex modulus (ASTM D 790), and/or Izod impact (ASTM D 256). “Chemical properties” generally indicate properties respective to robustness under exposure to solvents, acids, or bases.

As will be appreciated from a review of the above, Table 1 sets forth relative weightings of factors for consideration in multilayer composite design. Table 1 also sets forth individuated utility for each Composite Design Embodiment in the set of Composite Design Embodiments 1-12.

If the pervious fluoropolymer uses etched PTFE, the model should include High and Low etching levels to provide etched polytetrafluoroethylene having a carbon to fluorine weight ratios in the test within a range of from about 0.35 to about 10.

A decision for use of FKM or fluoroplastic (any of tetrafluoroethylene/hexafluoropropylene copolymer, ethylene-tetrafluoroethylene copolymer, ethylene chlorotrifluoroethylene copolymer, tetrafluoroethylene/hexafluoropropylene/vinylidene fluoride terpolymer, poly(vinylidene fluoride), tetrafluoroethylene/perfluoromethylvinylether copolymer, tetrafluoroethylene/perfluorovinylether copolymer, perfluoroalkoxy/tetrafluoroethylene copolymer, hexafluoropropylene/vinylidene fluoride copolymer, chlorotrifluoroethylene/vinylidene fluoride copolymer, or combinations thereof) in the homogenous fluoropolymer layer material can incorporate use of a Low FKM amount and a High FKM amount.

When un-fluorinated ingredients are used in the test formulations, the model should include High and Low amounts of fluorinated ingredients so that the weight ratio of fluorinated ingredients to un-fluorinated ingredients is investigated in a weight ratio range of from about 1:9 to about 9:1, preferably from about 1:2 to about 2:1.

Tables 2 and 3 set forth some considerations for both of these decisions in multilayer composite design.

TABLE 2
Ratios of FKM Elastomer and Fluoroplastic

| | | High | | |
|---|---|---|---|---|
| | | Fluoro- | High | Low |
| | High FKM | plastic | Fluorine | Fluorine |
| | Content | Content | Content | Content |
| Hardness | Low | High | — | — |
| Elasticity | High | Low | — | — |
| Service | — | — | High | Low |
| Temperature | | | | |
| Chemical | — | — | High | Low |
| Resistance | | | | |

Table 2 presents relative qualitative ratios of FKM materials, fluoroplastic materials, and relative fluorine content in those materials with respect to performance factors of Hardness, Elasticity, Service Temperature, and Chemical Resistance (as previously described). The factors of desired service temperature and chemical resistance should be considered in defining the relative fluorine content of the homogenous fluoropolymer layer material. The factors of desired hardness and elasticity should be considered in defining the relative amount of FKM and of fluoroplastic to be used in the homogenous fluoropolymer layer material. Table 2 helps resolve two issues: a first issue of relative FKM content and relative fluoroplastic content in the homogenous fluoropolymer layer material based upon desired hardness and elasticity requirements in the composite's application, and a second closely-related consideration of the relative amount of fluorine the FKM and/or fluoroplastic should contain based upon needed service temperature and chemical resistance in the application for the composite.

Table 3 presents particular polymers to achieve the desired fluoroplastic or FKM type and also the desired fluorine content determined through the use of Table 2.

TABLE 3
Fluorine Content of FKM and Fluoroplastic

| | High Fluorine Content | Low Fluorine Content |
|---|---|---|
| FKM | TFE/HFP/VdF, TFE/PFVE, | VdF/HFP, TFE/P, |
| | TFE/PFVE/VdF | TFE/P/VdF |
| Fluoroplastic | PTFE, FEP, PFA, MFA | PVDF, THV, ETFE, |
| | | ECTFE, CTFE/VdF, |
| | | HFP/VdF |

A decision for use of liquid (at room temperature) FKM in latex form, in solution fluoroelastomer non-latex form, or in pre-gum form (fluoroelastomer that is liquid at room temperature without benefit of water or solvent) in the homogenous fluoropolymer layer material can incorporate use, in one embodiment, of a Low aqueous level (i.e. FKM liquid in non latex form or non-solvent form) and a High aqueous or solvent level (i.e. FKM liquid in latex form or solution fluoroelastomer). Another embodiment for distinguishing FKM latex types is uses Low molecular weight FKM latex and High molecular weight FKM latex in the test design. A summary of criteria for selecting/evaluating the appropriate form of liquid FKM are appreciated from a consideration of Table 4.

TABLE 4
Factors For Liquid FKM Selection (see text following
table for further definition of factors)

| | liquid FKM type | | |
|---|---|---|---|
| | Room- | Solution | |
| | Temperature- | fluoro- | FKM emulsion |
| Factor* | Liquid FKM | elastomer | latex |
| Molecular Weight | Low | Medium | High |
| Viscosity | Medium | Low | Low |
| EQC | Low | High | Low |
| Residuals | None or trace | Solvent | Surfactant |
| Mechanical | Low | Medium | High |
| Properties | | | |
| Chemical Properties | Low | Medium | High |

In Table 4, “EQC” references, in a qualitatively relative context, Environmental Quality Control costs and process needs for appropriately managing environmental quality and industrial hygiene considerations in manufacture of the composite. “Residuals” indicate the type, after composite manufacture, of non-efficacious residual material impurities left in the homogenous fluoropolymer layer material of the composite from using the particular type of liquid FKM. “Mechanical properties” generally indicate properties respective to strength and robustness under friction and/or mechanically-imposed force. “Chemical properties” generally indicate properties respective to robustness under exposure to solvents, acids, or bases.

If a third layer is to be bonded to the melt-bonded layer, the test design should include a Low and High level for an epoxy compound, a phenoxy compound, and a heat polymerizable thermoplastic oligomer appropriate to the third layer. For the first test, each of these three ingredient candidates should be in a level of at least 10 weight percent of the formulation. If the third layer is metal, then High and Low levels of silane should also be formulated into the test formulations. Silane is tested in amounts from about 0.01 weight percent to about 5 weight percent (preferably, from about 0.1 weight percent to about 2 weight percent) of the homogenous fluoropolymer layer material.

Once a composite layer design and an affiliated homogenous fluoropolymer layer material formulation have been optimized for a composite through empirical testing, particular assembly and article designs using the composite can be finalized.

While designations such as “compression seal”, “torsion seal”, “static seal”, “packing seal, “dynamic seal”, and “flexible seal” are useful for discussing seal features in an application context, the designations are neither rigorously unique or exclusive to the types of surface and intervening space situations that are sealed. In some embodiments, the packing type of seal (with, for instance, the benefit of substantial lubrication) usefully interfaces to a movable surface—a packed pump is one example of such a situation where a packing seal is slideably disposed against a very dynamic surface. In other embodiments, the flexible (dynamic type) torsion seal interfaces between two surfaces that have essentially no relative movement—a protective boot on a pivotally removable measurement probe where one end of the probe protrudes through the boot is one example of such a situation where a flexible seal, except for an occasional execution of removal of the probe, is essentially statically disposed between the two surfaces defining the area being sealed.

As previously noted, a very thin (for example, 0.5 mil) pervious fluoropolymeric layer is enabled in a composite when the pervious fluoropolymeric layer comprises a multiphase composition having a continuous phase of a thermoplastic polymer material and a fluoroelastomeric amorphous phase dispersed in the continuous phase in independent portions having independent diameters of from about 0.1 microns to about 100 microns. This feature enables new geometrically complex gaskets and seals to be manufactured as shaped articles. As previously noted, in planar (or essentially flat surface) seals, this feature enables a composite to have a very thin barrier layer. In other seals, such as o-rings, the geometric flexibility provides a substantial degree of freedom for enabling new and highly functional seals. In this regard, FIGS. 10A to 10F depict a number of alternative multilayer o-ring seal configurations with each configuration having a pervious fluoropolymeric layer as previously described herein.

Turning to an o-ring embodiment profiled in cross section in FIG. 10A, o-ring 1010 has melt-bonded layer 1012 cohered to pervious fluoropolymeric layer 1014. Pervious fluoropolymeric layer 1014 has a modified fluoropolymeric semicircular cross-sectional area. The diametric chord subtending the semicircle is positioned essentially horizontal to the plane of o-ring 1010 (the plane of an o-ring being the plane containing the entire curvilinear axis of the o-ring). A further semi-circularly inscribed cross-sectional portion of melt-bonded layer 1012 is imposed inside the semicircle of pervious fluoropolymeric layer 1014. The arc length of the imposed semicircle is co-centrically radially parallel to the arc length of the fluoropolymeric semicircular cross-sectional area. The subtending diametric chord for the arc length of the imposed semicircle is also positioned essentially horizontal to the plane of o-ring 1010. The vertex and chord sides of the supplementary angle (establishing the diametric chord) for the arc length of the inscribed cross-sectional area are superimposed onto the vertex and chord sides of the supplementary angle (establishing the diametric chord) of the arc length subtending the fluoropolymeric semicircular cross-sectional area. This configuration enables melt-bonded layer 1012 to have a significantly centered presence in o-ring 1010 respective to the circular curvilinear axis of o-ring 1010 and enables pervious fluoropolymeric layer 1014 to have an essentially consistent thickness for compression in use from forces applied in essentially perpendicular orientation to the plane of o-ring 1012. o-ring 1010 therefore should provide especial benefits in bearing of heavy loads.

FIG. 10B presents a cross section profile for o-ring 1020 with melt-bonded layer 1024 independently cohered to pervious fluoropolymeric layer 1022 and to third layer 1026. Melt-bonded layer 1024 is essentially horizontally positioned respective to the plane of the o-ring as an internal layer in the o-ring. This configuration enables layers 1022 and 1026 to interface directly with surfaces above and below the plane of o-ring 1020.

FIG. 10C presents a cross section profile for o-ring 1030 with pervious fluoropolymeric layer 1034 cohered to melt-bonded layer 1032. Pervious fluoropolymeric layer 1034 has a semicircular cross-sectional area in o-ring 1030. The semicircle is subtended by a diametric chord that is essentially horizontally positioned respective to the plane of the o-ring so that pervious fluoropolymeric layer 1034 provides an elastic barrier layer for one surface compressed with a force that is essentially perpendicular to the plane of o-ring 1030 and where a barrier to chemical attack is needed on one side of o-ring 1030. An o-ring for use in a valve stem is a non-limiting example of an application use.

FIG. 10D presents a cross section profile for o-ring 1040 configured substantially according to the detail of o-ring 1010 but with melt-bonded layer 1046 bonding pervious fluoropolymeric layer 1044 to third layer 1042. The semicircular cross-sectional area in o-ring 1040 of pervious fluoropolymeric layer 1044 is repositioned to have a perpendicular orientation respective to the respective to the plane ofo-ring 1010 and to the plane of o-ring 1040. Pervious fluoropolymeric layer 1044 has a modified fluoropolymeric semicircular cross-sectional area. The diametric chord subtending the semicircle is positioned essentially perpendicular to the plane of o-ring 1040. A further semi-circularly inscribed cross-sectional portion of third layer 1042 is imposed inside the semicircle of pervious fluoropolymeric layer 1044. The arc length of the imposed semicircle is co-centrically radially parallel to the arc length of the fluoropolymeric semicircular cross-sectional area. The subtending diametric chord for the arc length of the imposed semicircle is also positioned essentially perpendicular to the plane of o-ring 1040. The vertex and chord sides of the supplementary angle (establishing the diametric chord) for the arc length of the inscribed cross-sectional area are superimposed onto the vertex and chord sides of the supplementary angle (establishing the diametric chord) of the arc length subtending the fluoropolymeric semicircular cross-sectional area. This configuration enables third layer 1042 to have a significantly centered presence in o-ring 1040 respective to the circular axis of o-ring 1040 and enables pervious fluoropolymeric layer 1044 to have an essentially consistent thickness for compression in use from forces that are essentially radially-applied outward toward the center of o-ring 1040 in horizontal orientation to the plane of o-ring 1040. An example of application is for a tightly compressed seal in corrosive service, such as a seal for a measuring probe positioned on the exterior of a ship.

As should be appreciated from a consideration of FIG. 10D, a further embodiment of an o-ring with a similarly shaped pervious fluoropolymeric layer inverted by 180 degrees to be positioned on the inside diameter portion of an o-ring provides a multilayer o-ring enabling a pervious fluoropolymeric layer to have an essentially consistent thickness for compression in use from forces essentially applied away from the center of the o-ring in horizontal orientation to the plane of the o-ring. A seal on the upper rim of a liquid cell battery where pressurization might occur is one example of an application.

FIG. 10E presents a cross section profile for o-ring 1050 configured substantially according to the detail of o-ring 1020 of FIG. 10B but with pervious fluoropolymeric layer 1056 repositioned to be cohered to third layer 1052 with melt-bonded layer 1054. Pervious fluoropolymeric layer 1056 is positioned essentially perpendicular to the plane of o-ring 1050 as an internal layer in the o-ring composite. This configuration enables pervious fluoropolymeric layer 1056 to provide mechanical compression spring functionality within o-ring 1050 for essentially radially applied forces that are horizontal to the plane of o-ring 1050. An o-ring for sealing a radially compressed can lid to the upper side of a jar is an example of an application.

FIG. 10F presents a cross section profile for o-ring 1060 configured substantially according to the detail of o-ring 1030 in FIG. 10C but with pervious fluoropolymeric layer 1064 repositioned to be cohered to melt-bonded layer 1062 with a semicircular cross-sectional area in o-ring 1060. The diametric chord that subtends the semicircle is positioned essentially perpendicular to the plane of the o-ring. In this configuration, pervious fluoropolymeric layer 1064 provides an elastic barrier layer for one surface compressed from an essentially radially-applied force applied horizontally to the plane of o-ring 1060 outwardly from within the inner diameter of o-ring 1060.

As should be appreciated from a consideration of FIG. 10F, a further embodiment of an o-ring with a similarly shaped pervious fluoropolymeric layer inverted by 180 degrees to be positioned on the outside diameter portion of an o-ring provides a multilayer o-ring enabling a pervious fluoropolymeric layer to have an essentially consistent thickness for compression in use from forces essentially applied toward the center of the o-ring in horizontal orientation to the plane of the o-ring.

Turning now to FIG. 11, seal detail for a dynamic seal for an automobile crankshaft is presented in sealed assembly 1100 benefiting from a flexible seal similar to seal 914 in FIG. 9. Shaft 1102 is sealed with flexible seal 1104 at a sealing surface portion of shaft 1102 indicated at location 1106. Flexible seal 1104 of pervious fluoropolymer is cohered to melt-bonded layer 1110. Melt-bonded layer 1110 is also cohered to flange 1108. Flexible seal 1104, melt-bonded layer 1110, and flange 1108 (preferably a metal flange of a material such as steel) thereby form a three-layer composite where pervious fluoropolymer layer (layer 1104) is cohered to melt-bonded layer 1110 of homogenous fluoropolymer layer material, and where melt-bonded layer 1110 is further cohered to third layer 1108 (flange 1108) with the benefit of a third-layer bonding ingredient (as described above) in the formulation of homogenous fluoropolymer of melt-bonded layer 1110.

Surface portion 1112 is shaped to seal against shaft 1102 at location 1106 by slideably bearing against shaft 1102. Housing 1114 has a spring-form end portion 1118 (establishing a torsion spring) for tightly clipping the multilayer seal assembly (of flange 1108, melt-bonded layer 1110, and seal 1104) against sealing washer 1116 to compress sealing washer 1116 between seal 1104 and housing 1114 with opposing spring forces from sealing washer 1116 and spring-form end portion 1118 sustaining flange 1108 in connection to housing 1114. In this regard, seal 1104 and flange 1108 are therefore, in one embodiment, initially constructed as an independent assembly and clipped into position within assembly 1100. Flexible seal 1104 is torsionally flexed to (sealingly) bear surface portion 1112 against the sealing surface (location 1106) of shaft 1102. Groove cross-sections 1122 are cut into seal 1104 to retain micro-reservoirs of lubricant. In this regard, groove cross-sections 1122 in one embodiment show cross-sectional profiles from a continuous unified groove or channel incised into seal 1104 either as a spiral groove around a circular interfacing surface portion or, in an alternative embodiment, as a switchback pattern to provide thereby a channel for fluidly conveying lubricant in the channel from momentum conveyed into the lubricant through viscous interaction with pivoting shaft 1102.

Methods of mixing and/or dynamic vulcanization to disperse a fluoroelastomeric amorphous phase into a thermoplastic continuous phase to provide a multiphase composition have been previously described herein. The multiphase composition is then used in the embodiments to make a pervious fluoropolymeric layer in a composite. In this regard, the composite is made by a method of generating the pervious fluoropolymeric layer, and then by melt-bonding a homogenous fluoropolymer layer to the pervious fluoropolymer layer to form the composite, where the pervious fluoropolymeric layer comprises the multiphase composition. A third layer is optionally also bonded to the melt-bonded homogenous fluoropolymer layer with the benefit of a third-layer bonding ingredient in the homogenous fluoropolymer layer material formulation as described above. A further optional step in making a composite is that, after a composite has been formed, the composite can be treated with radiation to achieve any of cross-linking between thermoplastic molecules, cross-binding of thermoplastic molecules to fluoroelastomer molecules, or further adhesion between layers in the composite. In this regard, exposure of the composite to electron beam radiation of from about 0.1 MeRAD to about 40 MeRAD is a preferable method of such irradiative treatment. Such treatment can therefore enhance a number of properties in the composite layers, including molecular network structure, cross-linking within and between phases and/or layers, bonding, tensile properties, wear properties, compression set, service temperature, heat deflection temperature, dynamic fatigue resistance, fluid and chemical resistance (chemo-resistivity), creep resistance, dimensional stability, and toughness.

In various embodiments, blending of the homogenous fluoropolymer layer material is effected by mixing the previously discussed components and ingredients at room temperature in in conventional mixing equipment such as roll mills, Moriyama mixers, Banbury mixers, Brabender mixers, continuous mixers, mixing extruders such as single and twin-screw extruders, and the like the compositions can be processed and reprocessed by conventional plastic processing techniques such as extrusion, injection molding and compression molding. It is preferred that mixing continues without interruption until a homogenous blend occurs or is complete.

When fluoroelastomer latex and fluoroplastic emulsion are used as the liquid fluoropolymer ingredient, the fluoroplastic emulsion is first gently mixed with a stirrer and any fillers and acid acceptors are gradually added and gently mixed until fully dispersed. The FKM latex is then added to the fluoroplastic emulsion blend and the resulting blend is gently stirred until all components are blended. The mixture is then transferred (poured) into a ball mill which is then rotated to break any agglomerates until a homogeneously dispersed mixture is obtained. Curatives are then added to the ball mill as agitation continues. Two specific blending cases are further described in the Examples.

The generating of the third layer in some method embodiments is preliminary to the generation of the pervious fluoropolymeric layer. In one embodiment, the third layer is generated by conventional means, and then the pervious fluoropolymeric layer and melt-bonded layers are pultruded onto the third layer. In another embodiment, the third layer is molded of polymer by conventional means, the melt-bonded layer and pervious fluoropolymeric layer are added before the third layer has hardened, and then all three layers harden simultaneously. In yet another embodiment of a five layer composite, a third layer is generated by conventional means, a pervious fluoropolymeric layer is cohered to the third layer with the benefit of one melt-bonded layer of homogenous fluoropolymer, and yet another layer is further cohered to the pervious fluoropolymer layer with the benefit of a second melt-bonded layer of homogenous fluoropolymer.

After assembly of a composite precursor, many embodiments of composite manufacture proceed to a curing step where the temperature of the composite is maintained for a period of time at a level that promotes any of curing, oligomer linking, and/or polymer/oligomer crosslinking in the homogenous fluoropolymer layer material of elastomer, epoxy, phenoxy, and oligomer components/ingredients in the composite. The temperature(s) are selected in some embodiments with consideration of optimal reaction temperatures for curing agents in the homogenous fluoropolymer blend. In some embodiments, cured composites then are subjected to a post-cure step, where temperature of the composite is maintained for a period of time at a level that promotes removal and/or breakdown of residual curing agents and/or solvents in the composite.

In one embodiment, a mandrel is made, the pervious fluoropolymeric layer and the melt-bonded layer of homogenous fluoropolymer layer material are pultruded onto the mandrel, and the mandrel is removed to leave a tubular composite as a residual item.

In further detail of this, a mandrel is extruded and cooled in a water bath in a vacuum sizing system to define the inner dimension of a desired tube. An ETFE thermoplastic formulation is prepared as homogenous fluoropolymer layer material for bonding to a pervious fluoropolymer layer and also to a third layer. A (first) pultrusion is then performed using the mandrel as a pultrusion core component. In the pultrusion, a multiphase fluoroelastomer gum and thermoplastic blend are fed from an extruder as a first feed stream and the ETFE homogenous thermoplastic formulation is fed from a second extruder as a second feed stream into a pultrusion die. The pultrusion die and extruders are configured and operated to provide output from the pultrusion die of a 3-layer tube having the mandrel as an inner layer, a thin pervious fluoropolymeric layer of the multiphase blend as a pervious fluoropolymeric layer cohered to the outside surface of the inner layer, and an outer layer of the homogenous ETFE thermoplastic formulation melt-bonded to the outside surface of the pervious fluoropolymeric layer. The resultant 3-layer pultruded tube is air cooled to solidify the two layers pultruded onto the mandrel. The cooled 3-layer tube is then irradiated on the outer surface with a corona discharge to activate the surface of the outside ETFE layer. The surface treated 3-layer multilayer tube is then input as a pultrusion core component to a second pultrusion die. A third extruder feeds a structural polymer into the second pultrusion die that will ultimately provide a third layer in the three layer tube that is intended as the final product of the process. The pultrusion die and third extruder are configured and operated to provide output from the pultrusion die of a 4-layer pultruded tube that is cooled after exit from the die to decrease the temperature of the outer layer to room temperature. The mandrel is then removed from the 4-layer tube to provide a residual 3-layer tube having the pervious fluoropolymeric layer as the inside layer. The 3-layer tube is then optionally treated with an electron beam to cure (crosslink) the fluoroelastomer in the pervious fluoropolymeric layer, to crosslink thermoplastic material in the pervious fluoropolymeric layer, to promote adhesion between the layers at the layer interfaces, and/or to crosslink polymer chains in other layers of the composite tube.

Some composite embodiments are made through the process of transfer molding. In a first step of this, a quantity of polymer or uncured rubber is placed into an entry chamber of a mold. The mold is closed and the quantity of polymer or uncured rubber is forced by hydraulic pressure (usually through use of a plunger) into the mold cavity. The molded polymer or uncured rubber is then solidified in the mold cavity under pressure so that the shape of the molded part is stabilized. The plunger is then released, the mold is opened, and the part can be removed. In one method embodiment, applicable for any of o-rings 1010, 1020, 1030, 1040, 1050, and 1060, a first transfer molding of a first pervious fluoropolymer layer of the multilayer o-ring is made and cooled in a mold having a first cavity plate and a second cavity plate. The second cavity plate is removed and a third cavity plate then positioned on the first cavity plate (containing the first layer of the o-ring) to provide a cavity for a second transfer molding of homogenous fluoropolymer layer material. The second layer of the multilayer o-ring is then transfer molded onto the first layer. The process is repeated with cavity plates providing additionally sized cavities until the composite has been fully formed. The formed composite is then optionally treated with electron beam radiation to provide the finished composite o-ring.

Insert molding is used for making composites having an encapsulated layer. The layer to be encapsulated (pervious fluoropolymer according to this description) is first made, for example, by injection molding. The layer to be encapsulated is then placed as an insert core into a mold cavity for the insert molding procedure. Homogenous fluoropolymer layer material according to this description) is then injected into the mold cavity around the insert core. The resulting composite has an encapsulated core layer of the pervious fluoropolymer.

The composites are therefore made by a number of established processes including any of pultrusion, compression molding, multi-layer extrusion, injection molding, transfer molding, and insert molding. In one embodiment, the generating and cohering take place in a mold designed to encapsulate the pervious fluoropolymeric layer within the polymeric structural layer. In another embodiment, the generating and cohering take place in a mold designed to encapsulate a third layer within both the pervious fluoropolymeric layer and the homogenous fluoropolymer layer.

FKM-TPV materials may be formed into very thin layers of less than about 3 mils in composites using established processes of compression molding, injection molding, transfer molding, and insert molding. For extrusions, a preferred method embodiment for providing a very thin layer of less than 3 mils of multiphase cured fluoroelastomeric (as an amorphous phase) and thermoplastic (as a continuous phase) in a composite is to first extrude a thin layer of a multiphase fluoroelastomer gum and thermoplastic blend (such as in the above-described multi-pultrusion approach) into a formed composite, and then to cure the composite after it has been formed in order to cure the fluoroelastomer gum into cured fluoroelastomer.

Once a packing seal or torsion seal according to the previous description has been made for sealing use in a mechanical assembly, it can then be deployed to complete the machine for which it was designed. In summary of this, one method for sealing an assembly having a first component having a first rigid surface and a second component having a second rigid surface is achieved through disposing a multilayer packing seal according to the composite design for a packing seal of this description between the first rigid surface and the second rigid surface. Another method seals an assembly with a base and a connected pivoting component by isolating a section of the assembly containing a portion of the pivoting component from contact with a fluid by disposing a flexible multilayer torsion seal according to the composite design for a torsion seal of this description into the assembly to help to define a cove space around the component portion. In addition to the portion to be isolated from the fluid, the component is designed to have a second component portion exposed to the fluid and a sealing surface interfacing the first component portion (the portion to be isolated) and the second component portion. The torsion seal has a first sealing surface portion adapted for fixedly sealing the flexible torsion seal to the base with a homogenous fluoropolymer melt-bonded layer, and a second sealing surface portion adapted to compressively fit against the sealing surface. When the seal is disposed into the assembly, the first sealing surface portion is fixedly sealed to the base, and the torsion seal is torsionally flexed to sealingly bear the second sealing surface portion against the sealing surface so that the cove space is defined between the base, the first component portion, and the flexed torsion seal. In one form of this, as described with respect to FIG. 11, the base of a mechanical assembly is enabled with a housing and a flange having complimentary designs for clipping together in a fastening joint; and the flange and torsion seal are provided as a pre-assembled seal assembly for clip-in disposition into the housing of the mechanical assembly being sealed.

### EXAMPLES

As discussed previously, each homogenous fluoropolymer layer material embodiment for the melt-bonded layer may be blended in part from at least one of any of, without limitation, fluoroplastic emulsion, fluoroelastomer latex, liquid fluoroelastomer, epoxy, phenoxy, thermoplastic oligomer, curatives, and/or silane. Commercially available candidates for some of these ingredients for homogenous fluoropolymer layer material embodiment formulation include:

fluoroplastic emulsion in the form of THV™ 220D, THV™ 340C, THV™ 340D, THV™ 510D, and FEP 6400, all available from Dyneon (3M) of Aston, Pa.;

fluoroelastomer latex in the form of Tecnoflon™ TN Latex, available from Solvay-Solexis of Brussels, Belgium;

liquid fluoroelastomer in the form of Viton™LM from DuPont (Wilmington, Del.), G101 from Daikin of Japan, and either LV 2000 or LV 2014 available from Unimatec Co., Ltd. (NOK) of Japan;
epoxy in the form of ECN (epoxy cresol novolac) from Vantico of Basel, Switzerland, or any of ECN 1273, ECN 1280, ECN 1285, ECN 1299, ECN 9511, or ECN 1400 (water base epoxies) from Araldite of Everberg, Belgium;

phenoxy in the form of PKHW-34, PKHW-35, or PKHW-36 (waterborn colloidal dispersions) from InChem of Rock Hill, S.C.;

thermoplastic oligomer in the form of CBT (cyclic butylene terephthalate) from Cyclics Corp of Schenectady, N.Y., or PCT (poly cyclohexylene dimethylene terephthalate) from Eastman Chemical Company of Kingsport, Tenn.; and

silane in the form of KBM-303, KBM-402, KBM-403, KBM-575, KBM-603, or KBM-903 from Shin-Etsu of Tokyo, Japan.

### Example 1

Dyneon THV340C fluoroplastic emulsion is gently agitated at room temperature. Using 100 parts of the emulsion as a basis, 20 parts carbon black filler, 1 part sodium laurylsulphate (accelerator), 10 parts zinc oxide (acid acceptor), and 2 parts 3-glycidoxypropyltriethoxysilane (Shin-Etsu KBM-403) are added to the fluoroplastic emulsion under continuing gentle agitation until all ingredients are dispersed. While continuing gentle agitation, 145 parts of FKM elastomer emulsion (TN Latex) is added, and the blend is agitated gently until all ingredients are dispersed. The blend is transferred to a ball mill container, and the ball mill container is rotated until a homogeneously dispersed mixture is obtained. Triethylenetetramine (curative package) is added under continuing ball mill rotation at a rate modulated to preclude curing onset in the homogenous fluoropolymer layer material blend.

A substrate of polytetrafluoroethylene is etched, and a coating of the blended homogenous fluoropolymer layer material is applied to the etched polytetrafluoroethylene. A steel substrate is then gently pressed against the coating, and the composite precursor is transferred to an oven for 2 hours at 90 degrees Celsius to cure the homogenous fluoropolymer layer material blend and complete the composite.

### Example 2

FEP 6400 fluoroplastic emulsion is gently agitated at room temperature. Using 100 parts of the emulsion as a basis, 30 parts carbon black filler, 0.1 part 1,8-Diazabicyclo[5,4,0]undecene (accelerator), 10 parts magnesium oxide (acid acceptor), and 2 parts 3-glycidoxypropyltriethoxysilane (Shin-Etsu KBM-403) are added to the fluoroplastic emulsion under continuing gentle agitation until all ingredients are dispersed. While continuing gentle agitation, 145 parts of FKM elastomer emulsion (TN Latex) is added, and the blend is agitated gently until all ingredients are dispersed. The blend is transferred to a ball mill container, and the ball mill container is rotated until a homogeneously dispersed mixture is obtained. Three parts Varox™ DBPH 50 peroxide curing agent, 4 parts Diak No. 3 (amine), and 3 parts Diak No. 7 (TAIC triallylisocyanurate co-agent) are added under continuing ball mill rotation at a rate modulated to preclude curing onset in the homogenous fluoropolymer layer material blend.

A coating of the blended homogenous fluoropolymer layer material is applied to a steel substrate, an FKM-TPV substrate is also applied against the coating, and the resulting composite precursor is transferred to an oven and cured for 1 hour at 90 degrees Celsius so that the homogenous fluoropolymer layer material blend is cured. The composite is then post-cured for 1 hour at 230 degrees Celsius to complete the composite.

### Example 3

Dyneon THV340C fluoroplastic emulsion is gently agitated at room temperature. Using 100 parts of the emulsion as a basis, 30 parts carbon black filler, 0.1 part 1,8-Diazabicyclo[5,4,0]undecene (accelerator), 10 parts magnesium oxide (acid acceptor) are added to the fluoroplastic emulsion under continuing gentle agitation until all ingredients are dispersed. While continuing gentle agitation, 145 parts of FKM elastomer emulsion (TN Latex) is added, and the blend is agitated gently until all ingredients are dispersed. The blend is transferred to a ball mill container, and the ball mill container is rotated until a homogeneously dispersed mixture is obtained. Ten parts epoxy ECN, 10 parts of phenoxy dispersion, 4 parts Diak No. 3 (amine), three parts Varox™ DBPH 50 peroxide curing agent, and 3 parts Diak No. 7 (TAIC) are added under continuing ball mill rotation at a rate modulated to preclude curing onset in the homogenous fluoropolymer layer material blend.

A substrate of polytetrafluoroethylene is etched, and a coating of the blended homogenous fluoropolymer layer material is applied to the etched polytetrafluoroethylene. A rubber substrate is gently compressed against the coating. The resulting precursor composite is transferred to an oven for 2 hours at 90 degrees Celsius to cure the homogenous fluoropolymer layer material blend into the completed composite.

### Example 4

FEP 6400 fluoroplastic emulsion is gently agitated at room temperature. Using 100 parts of the emulsion as a basis, 30 parts carbon black filler, 0.1 part 1,8-Diazabicyclo[5,4,0]undecene (accelerator), and 10 parts magnesium oxide (acid acceptor) are added to the fluoroplastic emulsion under continuing gentle agitation until all ingredients are dispersed. While continuing gentle agitation, 145 parts of FKM elastomer emulsion (TN Latex) is added, and the blend is agitated gently until all ingredients are dispersed. The blend is transferred to a ball mill container, and the ball mill container is rotated until a homogeneously dispersed mixture is obtained. Twenty parts of cyclic butylene terephthalate oligomer, 4 parts Diak No. 3 (amine), 3 parts Varox™ DBPH 50 peroxide curing agent, and 3 parts Diak No. 7 (TAIC) are added under continuing ball mill rotation at a rate modulated to preclude curing onset in the homogenous fluoropolymer layer material blend.

A substrate of polytetrafluoroethylene is etched, and a coating of the blended homogenous fluoropolymer is applied to the etched polytetrafluoroethylene. A butylene terephthalate thermoplastic substrate is gently compressed against the coating, and the composite precursor is transferred to an oven for 2 hours at 90 degrees Celsius to cure the homogenous fluoropolymer blend and complete the composite.

### Example 5

Liquid Unimatec LV 2014 liquid FKM fluoropolymer is gently agitated at room temperature. Using 100 parts of the fluoropolymer as a basis, 2 parts of 3-glycidoxypropyltriethoxysilane (Shin-Etsu KBM-403) is added under continuing gentle agitation until all ingredients are dispersed into a homogenous fluoropolymer layer material blend. The blend is transferred to a ball mill container, and the ball mill container is rotated until a homogeneously dispersed mixture is obtained. Three parts zinc oxide (acid acceptor), 3 parts Varox™ DBPH 50 peroxide curing agent, and 3 parts Diak No. 7 (TAIC triallylisocyanurate co-agent) are added to the FKM fluoropolymer blend under continuing ball mill rotation at a rate modulated to preclude curing onset in the homogenous fluoropolymer layer material blend.

A coating of the blended homogenous fluoropolymer layer material is applied to a steel substrate, an FKM-TPV substrate is also applied against the coating, and the resulting composite precursor is transferred to an oven and cured for 1 hour at 90 degrees Celsius so that the homogenous fluoropolymer layer material blend is cured. The composite is then post-cured for 1 hour at 230 degrees Celsius to complete the composite.

### Example 6

FEP 6400 fluoroplastic emulsion is gently agitated at room temperature. Using 100 parts of the emulsion as a basis 10 parts of zinc oxide, 2 parts of TETA (amine), 20 parts of carbon black, and 1 part sodium laurylsulphate (accelerator) are added to the fluoroplastic emulsion under continuing gentle agitation until all ingredients are dispersed. While continuing gentle agitation, 145 parts of FKM elastomer emulsion (TN Latex) is added, and the blend is agitated gently until all ingredients are dispersed. The blend is transferred to a ball mill container, and the ball mill container is rotated until a homogeneously dispersed mixture is obtained. 10 parts epoxy FCN, 10 parts of phenoxy dispersion, 3 parts Varox™ DBPH 50 peroxide curing agent, 4 parts of Cheminox AF50, 3 parts of Cheminox N35, 3 parts of magnesium oxide, 8 parts calcium hydroxide, and 3 parts Diak No. 7 (TAIC triallylisocyanurate co-agent) are added under continuing ball mill rotation at a rate modulated to preclude curing onset in the homogenous fluoropolymer layer material blend.

A coating of the blended homogenous fluoropolymer layer material is applied to a substrate of polyphenylene sulfide. An FKM-TPV substrate is gently compressed against the coating, and the composite precursor is transferred to an oven for 10 minutes at 180 degrees Celsius to cure the homogenous fluoropolymer layer material blend and complete the composite. The composite is then post-cured for 22 hours at 230 degrees Celsius to complete the composite.

The examples and other embodiments described herein are exemplary and not intended to be limiting in describing the full scope of compositions and methods of this description. Equivalent changes, modifications and variations of specific embodiments, materials, compositions and methods may be made within the scope of the present disclosure, with substantially similar results.

What is claimed is:

1. A layer material for a melt-bonded layer in a multilayer composite, the multilayer composite having, in contact with the melt-bonded layer, a first layer comprising pervious fluoropolymer selected from the group consisting of fluoroelastomeric thermoplastic, polytetrafluoroethylene etched such that etched polytetrafluoroethylene in the first layer has a carbon to fluorine weight ratio from about 0.35 to about 10, and combinations thereof, the layer material comprising:
a.) homogenous fluoropolymer selected from the group consisting of fluoroplastic, uncured fluoroelastomer, and combinations thereof;
b.) wherein the uncured fluoroelastomer is liquid at room temperature and the homogenous fluoropolymer has
i.) fluorinated molecules derived from at least one monomer unit stoichiometrically identical to a monomer unit from which fluorinated molecules of the pervious fluoropolymer are derived,
ii.) a liquefaction range supra-point temperature not greater than the liquefaction range supra-point temperature of the pervious fluoropolymer, p2 iii.) a liquefaction range supra-point temperature not less than the liquefaction range sub-point temperature of the pervious fluoropolymer, and
iv.) a viscosity at the liquefaction range supra-point temperature of the homogenous fluoropolymer that is less than the viscosity of the pervious fluoropolymer at the liquefaction range supra-point temperature of the pervious fluoropolymer.

2. The layer material of claim 1, wherein the homogenous fluoropolymer comprises uncured fluoroelastomer, and the homogenous fluoropolymer additionally comprises fluoroelastomer-curing agent.

3. The layer material of claim 1, wherein the first layer comprises fluoroelastomeric thermoplastic, and the homogenous fluoropolymer additionally comprises fluoroelastomer-curing agent.

4. The layer material of claim 1, wherein
a.) the melt-bonded layer is a second layer of the multilayer composite;
b.) the multilayer composite has a third layer cohered to the melt-bonded layer;
c.) the third layer is made of material selected from the group consisting of thermoplastic, thermoset plastic, a metal, ceramic, rubber, wood, leather, and combinations thereof; and
d.) the homogenous fluoropolymer of the layer material further comprises a third-layer bonding ingredient selected from the group consisting of an epoxy compound, a phenoxy compound, a heat polymerizable thermoplastic oligomer, and combinations thereof.

5. The layer material of claim 4, wherein the third layer comprises a metal, and the homogenous fluoropolymer of the layer material further comprises a silane.

6. The layer material of claim 1, wherein
a.) the multilayer composite is a two-layer multilayer composite;
b.) the melt-bonded layer is the second layer of the multilayer composite;
c.) the first layer of the multilayer composite comprises etched polytetrafluoroethylene; and
d.) the homogenous fluoropolymer is selected from the group consisting of tetrafluoroethylene/hexafluoropropylene copolymer, ethylene-tetrafluoroethylene copolymer, ethylene chlorotrifluoroethylene copolymer, tetrafluoroethylene/hexafluoropropylene/vinylidene fluoride terpolymer, poly(vinylidene fluoride), tetrafluoroethylene/perfluoromethylvinylether copolymer, tetrafluoroethylene/perfluorovinylether copolymer, perfluoroalkoxy/tetrafluoroethylene copolymer, hexafluoropropylene/vinylidene fluoride copolymer, chlorotrifluoroethylene/vinylidene fluoride copolymer, and combinations thereof.

7. The layer material of claim 1, wherein
a.) the multilayer composite is a two-layer multilayer composite;
b.) the melt-bonded layer is the second layer of the multilayer composite;
c.) the first layer of the multilayer composite comprises etched polytetrafluoroethylene;
d.) the homogenous fluoropolymer comprises a fluorinated ingredient and an un-fluorinated ingredient in a relative weight ratio of from about 1:9 to about 9:1;
e.) the homogenous fluoropolymer comprises not less than five weight percent fluorine;
f.) the un-fluorinated ingredient is selected from the group consisting of thermoplastic, thermoplastic vulcanizate, thermoplastic elastomer, elastomer, thermoset resin, and combinations thereof; and
g.) the fluorinated ingredient is selected from the group consisting of tetrafluoroethylene/hexafluoropropylene copolymer, ethylene-tetrafluoroethylene copolymer, ethylene chlorotrifluoroethylene copolymer, tetrafluoroethylene/hexafluoropropylene/vinylidene fluoride terpolymer, poly(vinylidene fluoride), tetrafluoroethylene/perfluoromethylvinylether copolymer, tetrafluoroethylene/perfluorovinylether copolymer, perfluoroalkoxy/tetrafluoroethylene copolymer, hexafluoropropylene/vinylidene fluoride copolymer, chlorotrifluoroethylene/vinylidene fluoride copolymer, and combinations thereof.

8. The layer material of claim 1, wherein
a.) the multilayer composite is a two-layer multilayer composite;
b.) the melt-bonded layer is the second layer of the multilayer composite;
c.) the first layer of the multilayer composite comprises fluoroelastomeric thermoplastic vulcanizate;
d.) the homogenous fluoropolymer comprises a fluorinated ingredient and an un-fluorinated ingredient in a relative weight ratio of from about 1:9 to about 9:1;
e.) the homogenous fluoropolymer comprises not less than five weight percent fluorine;
f.) the homogenous fluoropolymer comprises fluoroelastomer-curing agent selected from the group consisting of bisphenol, peroxide, polyol, phenol, amine, and combinations thereof;
g.) the un-fluorinated ingredient is selected from the group consisting of thermoplastic, thermoplastic vulcanizate, thermoplastic elastomer, elastomer, thermoset resin, and combinations thereof; and
h.) the fluorinated ingredient is selected from the group consisting of tetrafluoroethylene/hexafluoropropylene copolymer, ethylene-tetrafluoroethylene copolymer, ethylene chlorotrifluoroethylene copolymer, tetrafluoroethylene/hexafluoropropylene/vinylidene fluoride terpolymer, poly(vinylidene fluoride), tetrafluoroethylene/perfluoromethylvinylether copolymer, tetrafluoroethylene/perfluorovinylether copolymer, perfluoroalkoxy/tetrafluoroethylene copolymer, hexafluoropropylene/vinylidene fluoride copolymer, chlorotrifluoroethylene/vinylidene fluoride copolymer, and combinations thereof.

9. The layer material of claim 1, wherein
a.) the multilayer composite is a two-layer multilayer composite;
b.) the melt-bonded layer is the second layer of the multilayer composite;
c.) the first layer of the multilayer composite comprises fluoroelastomeric thermoplastic vulcanizate;
d.) the homogenous fluoropolymer comprises fluoroelastomer-curing agent selected from the group consisting of bisphenol, peroxide, polyol, phenol, amine, and combinations thereof;
e.) the homogenous fluoropolymer comprises not less than five weight percent fluorine; and
f.) the homogenous fluoropolymer is selected from the group consisting of thermoplastic, thermoplastic vulcanizate, thermoplastic elastomer, elastomer, thermoset resin, and combinations thereof.

10. The layer material of claim 1, wherein
a.) the multilayer composite is a three-layer multilayer composite;
b.) the melt-bonded layer is the second layer of the multilayer composite;
c.) the first layer of the multilayer composite comprises etched polytetrafluoroethylene;
d.) the third layer of the multilayer composite comprises material selected from the group consisting of thermoplastic, thermoplastic vulcanizate, thermoplastic elastomer, elastomer, thermoset plastic, and combinations thereof;
e.) the homogenous fluoropolymer comprises a fluorinated ingredient selected from the group consisting of uncured fluoroelastomer, emulsion fluoroplastic, and combinations thereof;
f.) the homogenous fluoropolymer comprises not less than five weight percent fluorine; and
g.) the homogenous fluoropolymer comprises a third-layer bonding ingredient selected from the group consisting of an epoxy compound, a phenoxy compound, a heat polymerizable thermoplastic oligomer, and combinations thereof.

11. The layer material of claim 10, wherein the third layer comprises any of thermoplastic elastomer, elastomer, and thermoset plastic, and the homogenous fluoropolymer of the second layer additionally comprises a third-layer curing agent selected from the group consisting of amine, sulfur, and combinations thereof.

12. The layer material of claim 10, wherein the homogenous fluoropolymer comprises uncured fluoroelastomer, and the homogenous fluoropolymer additionally comprises fluoroelastomer-curing agent selected from the group consisting of bisphenol, peroxide, polyol, phenol, amine, and a combination thereof.

13. The layer material of claim 1, wherein
a.) the multilayer composite is a three-layer multilayer composite;
b.) the melt-bonded layer is the second layer of the multilayer composite;
c.) the first layer of the multilayer composite comprises etched polytetrafluoroethylene;
d.) the third layer of the multilayer composite comprises a metal;
e.) the homogenous fluoropolymer comprises a fluorinated ingredient, a third-layer bonding ingredient, and a silane;
f.) the homogenous fluoropolymer comprises not less than five weight percent fluorine;
g.) the fluorinated ingredient is selected from the group consisting of uncured fluoroelastomer, emulsion fluoroplastic, and combinations thereof; and
h.) the third-layer bonding ingredient is selected from the group consisting of an epoxy compound, a phenoxy compound, a heat polymerizable thermoplastic oligomer, and combinations thereof.

14. The layer material of claim 13, wherein the homogenous fluoropolymer comprises uncured fluoroelastomer, and the homogenous fluoropolymer additionally comprises fluoroelastomer-curing agent selected from the group consisting of bisphenol, peroxide, polyol, phenol, amine, and a combination thereof.

15. The layer material of claim 1, wherein
a.) the multilayer composite is a three-layer multilayer composite;
b.) the melt-bonded layer is the second layer of the multilayer composite;
c.) the first layer of the multilayer composite comprises etched polytetrafluoroethylene;
d.) the third layer of the multilayer composite comprises a metal;
e.) the homogenous fluoropolymer comprises a silane and a fluorinated ingredient selected from the group consisting of uncured fluoroelastomer, emulsion fluoroplastic, and combinations thereof; and
f.) the homogenous fluoropolymer comprises not less than five weight percent fluorine.

16. The layer material of claim 1, wherein
a.) the multilayer composite is a three-layer multilayer composite;
b.) the melt-bonded layer is the second layer of the multilayer composite;
c.) the first layer of the multilayer composite comprises etched polytetrafluoroethylene;
d.) the third layer of the multilayer composite comprises a metal;
e.) the homogenous fluoropolymer comprises a silane and a fluorinated ingredient selected from the group consisting of tetrafluoroethylene/hexafluoropropylene copolymer, ethylene-tetrafluoroethylene copolymer, ethylene chlorotrifluoroethylene copolymer, tetrafluoroethylene/hexafluoropropylene/vinylidene fluoride terpolymer, poly(vinylidene fluoride), tetrafluoroethylene/perfluoromethylvinylether copolymer, tetrafluoroethylene/perfluorovinylether copolymer, perfluoroalkoxy/tetrafluoroethylene copolymer, hexafluoropropylene/vinylidene fluoride copolymer, chlorotrifluoroethylene/vinylidene fluoride copolymer, and combinations thereof; and
f.) the homogenous fluoropolymer comprises not less than five weight percent fluorine.

17. The layer material of claim 1, wherein
a.) the multilayer composite is a three-layer multilayer composite;
b.) the first layer of the multilayer composite comprises fluoroelastomeric thermoplastic vulcanizate;
c.) the melt-bonded layer is the second layer of the multilayer composite;
d.) the third layer of the multilayer composite comprises material selected from the group consisting of thermoplastic, thermoplastic vulcanizate, thermoplastic elastomer, elastomer, thermoset plastic, and combinations thereof;
e.) the homogenous fluoropolymer comprises a fluorinated ingredient selected from the group consisting of uncured fluoroelastomer, emulsion fluoroplastic, and combinations thereof;
f.) the homogenous fluoropolymer comprises fluoroelastomer-curing agent selected from the group consisting of bisphenol, peroxide, polyol, phenol, amine, and combinations thereof;
g.) the homogenous fluoropolymer comprises not less than five weight percent fluorine; and
h.) the homogenous fluoropolymer comprises a third-layer bonding ingredient selected from the group consisting of an epoxy compound, a phenoxy compound, a heat polymerizable thermoplastic oligomer, and combinations thereof.

18. The layer material of claim 17, wherein the third layer of the multilayer composite comprises any of thermoplastic elastomer, elastomer, and thermoset plastic, and the homogenous fluoropolymer of the second layer additionally comprises third-layer curing agent selected from the group consisting of amine, sulfur, and combinations thereof.

19. The layer material of claim 1, wherein
a.) the multilayer composite is a three-layer multilayer composite;
b.) the first layer of the multilayer composite comprises fluoroelastomeric thermoplastic vulcanizate;
c.) the melt-bonded layer is the second layer of the multilayer composite;
d.) the third layer of the multilayer composite comprises a metal;
e.) the homogenous fluoropolymer comprises a fluorinated ingredient, a third-layer bonding ingredient, and a silane;
f.) the homogenous fluoropolymer comprises not less than five weight percent fluorine;
g.) the homogenous fluoropolymer comprises fluoroelastomer-curing agent selected from the group consisting of bisphenol, peroxide, polyol, phenol, amine, and combinations thereof;
h.) the fluorinated ingredient is selected from the group consisting of uncured fluoroelastomer, emulsion fluoroplastic, and combinations thereof; and
i.) the third-layer bonding ingredient is selected from the group consisting of an epoxy compound, a phenoxy compound, a heat polymerizable thermoplastic oligomer, and combinations thereof.

20. The layer material of claim 1, wherein
a.) the multilayer composite is a three-layer multilayer composite;
b.) the first layer of the multilayer composite comprises fluoroelastomeric thermoplastic vulcanizate;
c.) the melt-bonded layer is the second layer of the multilayer composite;
d.) the third layer of the multilayer composite comprises a metal;
e.) the homogenous fluoropolymer comprises a fluorinated ingredient and a silane;
f.) the homogenous fluoropolymer comprises fluoroelastomer-curing agent selected from the group consisting of bisphenol, peroxide, polyol, phenol, amine, and combinations thereof;
g.) the homogenous fluoropolymer comprises not less than five weight percent fluorine; and
h.) the fluorinated ingredient is selected from the group consisting of uncured fluoroelastomer, emulsion fluoroplastic, and combinations thereof.

21. The layer material of claim 1, wherein
a.) the multilayer composite is a three-layer multilayer composite;
b.) the first layer of the multilayer composite comprises fluoroelastomeric thermoplastic vulcanizate;
c.) the melt-bonded layer is the second layer of the multilayer composite;
d.) the third layer of the multilayer composite comprises a metal;
e.) the homogenous fluoropolymer comprises fluoroelastomer-curing agent selected from the group consisting of bisphenol, peroxide, polyol, phenol, amine, and combinations thereof;
f.) the homogenous fluoropolymer comprises a silane and a fluorinated ingredient selected from the group consisting of tetrafluoroethylene/hexafluoropropylene copolymer, ethylene-tetrafluoroethylene copolymer, ethylene chlorotrifluoroethylene copolymer, tetrafluoroethylene/hexafluoropropylene/vinylidene fluoride terpolymer, poly(vinylidene fluoride), tetrafluoroethylene/perfluoromethylvinylether copolymer, tetrafluoroethylene/perfluorovinylether copolymer, perfluoroalkoxy/tetrafluoroethylene copolymer, hexafluoropropylene/vinylidene fluoride copolymer, chlorotrifluoroethylene/vinylidene fluoride copolymer, and combinations thereof; and
g.) the homogenous fluoropolymer comprises not less than five weight percent fluorine.

22. A multilayer composite, comprising:
a.) a first layer comprising pervious fluoropolymer selected from the group consisting of fluoroelastomeric thermoplastic vulcanizate, etched polytetrafluoroethylene, and combinations thereof; and
b.) a second layer melt-bonded to the first layer, the second layer comprising homogenous fluoropolymer selected from the group consisting of fluoroelastomer, fluoroplastic, and combinations thereof;
c.) wherein the homogenous fluoropolymer of the second layer is compositionally different from the pervious fluoropolymer of the first layer; and
d.) the etched polytetrafluoroethylene of the first layer is derived from polytetrafluoroethylene in a first layer precursor component etched such that etched polytetrafluoroethylene in the precursor component has a carbon to fluorine weight ratio from about 0.35 to about 10.

23. The multilayer composite of claim 22, further comprising:
a.) a third layer cohered to the second layer, the third layer made of material selected from the group consisting of thermoplastic, thermoset plastic, a metal, ceramic, rubber, wood, leather, and combinations thereof;
b.) wherein the second layer material further comprises a bonding component for the third layer selected from the group consisting of a cured epoxy compound, a cured phenoxy compound, a thermoplastic other than the fluoroplastic, and combinations thereof.

24. The multilayer composite of claim 23, wherein the third layer of the multilayer composite comprises a metal, and the second layer material further comprises a silane.

25. A multilayer composite compression seal according to the multilayer composite of claim 22.

26. A multilayer composite gasket according to the compression seal of claim 25.

27. A two-layer gasket according to the multilayer composite gasket of claim 26, wherein the first layer of the multilayer composite comprises etched polytetrafluoroethylene and the second layer comprises fluoroelastomeric thermoplastic vulcanizate.

28. A multilayer composite o-ring according to the compression seal of claim 25.

29. A multilayer composite torsion seal according to the multilayer composite of claim 22.

30. A two layer multilayer torsion seal according to the multilayer composite torsion seal of claim 29, wherein
a.) the first layer of the multilayer composite comprises etched polytetrafluoroethylene;
b.) the second layer comprises fluoroelastomeric thermoplastic vulcanizate;
c.) the two layer multilayer torsion seal is adapted for sealing use in isolating a section of an assembly from contact with a fluid;
d.) the assembly has a base and a component pivotably connected to the base;
e.) the component has a first component portion isolated from contact with the fluid;
f.) the component has a second component portion in contact with the fluid;
g.) the component has a sealing surface interfacing the first component portion and the second component portion;
h.) the two layer multilayer torsion seal comprises a first sealing surface portion and a second sealing surface portion;
i.) the first sealing surface portion is fixed to the base;
j.) the second sealing surface portion is adapted to compressively fit against the sealing surface; and
k.) the torsion seal is adapted to torsionally flex to sealingly bear the second sealing surface portion against the sealing surface such that the first component portion is essentially isolated from the fluid within a cove space defined between the base, the first component portion, and the first layer of the flexed torsion seal.

31. A multilayer composite compression seal according to the multilayer composite of claim 23.

32. A multilayer composite gasket according to the compression seal of claim 31.

33. A three-layer gasket according to the multilayer composite gasket of claim 32, wherein the first layer of the gasket comprises fluoroelastomeric thermoplastic vulcanizate and the third layer of the gasket comprises a metal.

34. A three-layer gasket according to the multilayer composite gasket of claim 32, wherein the first layer of the gasket comprises fluoroelastomeric thermoplastic vulcanizate and the third layer of the gasket comprises polymer selected from the group consisting of high temperature nylon, polyester, polyphenylene sulfide, polyphthalanimide, polyetheretherketone, polyetherimide, polyamidimide, polyimide, polysulfone, liquid crystalline polymer, and combinations thereof.

35. A multilayer composite o-ring according to the compression seal of claim 31.

36. A three-layer clip-in flexible multilayer torsion seal assembly adapted for sealing use in isolating a section of a machine assembly from contact with a fluid according to the multilayer composite torsion seal of claim 23, wherein
a.) the first layer of the multilayer composite comprises fluoroelastomeric thermoplastic vulcanizate;
b.) the third layer of the multilayer composite comprises steel;
c.) the machine assembly has a housing and a component in pivoting connection to the housing;
d.) the component has a first component portion that is to be isolated from contact with the fluid;
e.) the component has a second component portion that is to be in contact with the fluid;
f.) the component has a sealing surface interfacing the first component portion and the second component portion;
g.) the third layer provides a flange having a spring-form end portion adapted for tightly and sealingly clipping the flange to the housing; and
h.) the first layer is adapted to provide a flexible multilayer torsion seal having
i.) a first sealing surface portion fixedly sealed to the flange, and
ii.) a second sealing surface portion adapted to compressively fit against the sealing surface when the flexible multilayer torsion seal assembly is clipped to the housing and when the flexible multilayer torsion seal is torsionally flexed thereby to sealingly bear the second sealing surface portion against the sealing surface so that that the first component portion is essentially isolated from the fluid within a cove space defined between the housing, the first component portion, and the flexible multilayer torsion seal assembly.

37. An assembly component according to the multilayer composite of claim 23, wherein the first layer provides an interface to a surface of a second component of the assembly and the third layer is the structural body of the assembly component.

38. A three-layer component according to claim 23, wherein the first layer of the multilayer composite comprises fluoroelastomeric thermoplastic vulcanizate and the third layer of the multilayer composite comprises cured phenolic resin.

39. The three-layer component according to claim 38, wherein the third layer of the multilayer composite comprises cured phenol-formaldehyde resin.

40. A precured multilayer composite, comprising:
a.) a first layer comprising pervious fluoropolymer selected from the group consisting of fluoroelastomeric thermoplastic, polytetrafluoroethylene etched such that etched polytetrafluoroethylene in the first layer has a carbon to fluorine weight ratio from about 0.35 to about 10, and combinations thereof; and
b.) a second layer comprising a homogenous fluoropolymer selected from the group consisting of fluoroplastic, uncured fluoroelastomer, and combinations thereof;
c.) wherein the uncured fluoroelastomer is liquid at room temperature and the homogenous fluoropolymer has
i.) fluorinated molecules derived from at least one monomer unit stoichiometrically identical to a monomer unit of the fluorinated molecules of the pervious fluoropolymer,
ii.) a liquefaction range supra-point temperature not greater than the liquefaction range supra-point temperature of the pervious fluoropolymer,
iii.) a liquefaction range supra-point temperature not less than the liquefaction range sub-point temperature of the pervious fluoropolymer, and
iv.) a viscosity at the liquefaction range supra-point temperature of the homogenous fluoropolymer that is less than the viscosity of the pervious fluoropolymer at the liquefaction range supra-point temperature of the pervious fluoropolymer.

41. The precured multilayer composite of claim 40, wherein the homogenous fluoropolymer comprises uncured fluoroelastomer, and the homogenous fluoropolymer additionally comprises fluoroelastomer-curing agent.

42. The precured multilayer composite of claim 40, wherein the first layer of the multilayer composite comprises fluoroelastomeric thermoplastic, and the homogenous fluoropolymer additionally comprises fluoroelastomer-curing agent.

43. The precured multilayer composite of claim 40, further comprising:
a.) a third layer in contact with the second layer, the third layer made of material selected from the group consisting of thermoplastic, thermoset plastic, a metal, ceramic, rubber, wood, leather, and combinations thereof;
b.) wherein the second layer further comprises a third-layer bonding ingredient selected from the group consisting of an epoxy compound, a phenoxy compound, a heat polymerizable thermoplastic oligomer, and combinations thereof.

44. The precured multilayer composite of claim 43, wherein the third layer comprises a metal, and the second layer further comprises a silane.
